(19) United States
(12) Patent Application Publication
(10) Pub. No.: US 2018/0277852 A1
(43) Pub. Date: Sep. 27, 2018

(54) NONAQUEOUS ELECTROLYTE SECONDARY BATTERY

(71) Applicant: THE UNIVERSITY OF TOKYO, Tokyo (JP)

(72) Inventors: Atsuo YAMADA, Tokyo (JP); Yuki YAMADA, Tokyo (JP); Yoshihiro NAKAGAKI, Kariya-shi (JP); Tomoyuki KAWAI, Kariya-shi (JP); Kohei MASE, Kariya-shi (JP); Yuki HASEGAWA, Kariya-shi (JP); Manabu MIYOSHI, Kariya-shi (JP); Nobuhiro GODA, Kariya-shi (JP); Hiroyuki SASAKI, Kariya-shi (JP); Takefumi FUKUMOTO, Kariya-shi (JP)

(73) Assignee: THE UNIVERSITY OF TOKYO, Tokyo (JP)

(21) Appl. No.: 15/993,729

(22) Filed: May 31, 2018

Related U.S. Application Data
(62) Division of application No. 15/024,654, filed on Mar. 24, 2016.

(30) Foreign Application Priority Data
Sep. 25, 2013 (JP) 2013-198281
Sep. 25, 2013 (JP) 2013-198286
Mar. 27, 2014 (JP) 2014-065804
May 23, 2014 (JP) 2014-106727
Sep. 12, 2014 (JP) 2014-186351
Sep. 12, 2014 (JP) 2014-186352

(51) Int. Cl. H01M 4/62; H01M 4/587; H01M 4/66; H01M 10/0568; H01M 10/0569; H01M 10/0525; H01M 4/485; H01M 10/42; H01M 10/0567

(52) U.S. Cl. CPC H01M 4/628; H01M 4/587; H01M 4/622; H01M 4/661; H01M 10/0568; H01M 10/0567; H01M 10/0525; H01M 4/485; H01M 10/4235; H01M 2300/0025; H01M 10/0569

(57) ABSTRACT

An object is to provide a nonaqueous electrolyte secondary battery that has an SEI coating with a special structure and has excellent battery characteristics. As an electrolytic solution of the nonaqueous electrolyte secondary battery, an electrolytic solution containing: a salt whose cation is an alkali metal, an alkaline earth metal, or aluminum and whose cation is an alkali metal, an alkaline earth metal, or aluminum; and an organic solvent having a heteroelement is used, wherein, Is>Io is satisfied, and an S,O-containing coating having an S═O structure is formed on the surface of a positive electrode and/or a negative electrode. Alternatively, the above described electrolytic solution is used, and, as a binding agent for negative electrodes, a binding agent formed of a polymer having a hydrophilic group is used.

### CROSS REFERENCE TO RELATED APPLICATIONS

The present application is a divisional of U.S. Ser. No. 15/024,654, filed Mar. 24, 2016, which is the National Stage of PCT/JP2014/004917, filed Sep. 25, 2014, which claims the benefit of priority under 35 U.S.C. § 119 to JP 2013-198281, filed Sep. 25, 2013, JP 2013-198286, filed Sep. 25, 2013, JP 2014-065804, filed Mar. 27, 2014, JP 2014-106727, filed May 23, 2014, JP 2014-186351, filed Sep. 12, 2014, and JP 2014-186352 filed Sep. 12, 2014, the contents of all of which are hereby incorporated by reference in their entirety.

### TECHNICAL FIELD

The present invention relates to a nonaqueous electrolyte secondary battery.

### BACKGROUND ART

A coating has been known to form on the surfaces of a negative electrode and a positive electrode in a nonaqueous electrolyte secondary battery. This coating is also referred to as Solid Electrolyte Interphase (SEI), and is formed from reductive degradation products, etc., of an electrolytic solution (see for example Patent Literature 1). Hereinafter, this coating is abbreviated as an SEI coating in some cases.

The SEI coating on the surfaces of the negative electrode and the positive electrode allows a charge carrier such as lithium ions to pass therethrough. In addition, for example, the SEI coating on the surface of the negative electrode is considered to exist between an electrolytic solution and the surface of the negative electrode, and contribute in suppressing further reductive degradation of the electrolytic solution. The SEI coating is considered essential particularly for a low potential negative electrode using a graphite- or Si-based negative electrode active material.

Suppressing continuous degradation of the electrolytic solution by having the SEI coating is considered to improve discharge characteristics (hereinafter, referred to as cycle characteristics) of a battery after cycles. On the other hand, in a conventional nonaqueous electrolyte secondary battery, the SEI coating on the surfaces of the negative electrode and the positive electrode has not necessarily been considered to contribute in improving battery characteristics. Thus, development of a nonaqueous electrolyte secondary battery having an SEI coating enabling further improvement of battery characteristics has been desired.

On the other hand, for example, lithium ion secondary batteries are secondary batteries capable of having a high charge/discharge capacity and achieving high output. Currently, lithium ion secondary batteries are mainly used as power supplies for portable electronic equipment, notebook personal computers and electric vehicles. A secondary battery that is smaller and lighter has been demanded. In particular, since charging and discharging lithium ion secondary batteries with large current are required when the batteries are used in automobiles, the development of a lithium ion secondary battery having high input-output characteristics is demanded.

Lithium ion secondary batteries have, on both a positive electrode and a negative electrode, an active material capable of occluding and releasing lithium (Li). The batteries operate when lithium ions move within an electrolytic solution sealed between the two electrodes. In order to improve battery characteristics of lithium ion secondary batteries such as input-output characteristics, improvement of binding agents and/or active materials used in the positive electrode and/or the negative electrode and improvement in the electrolytic solution are necessary.

As a negative electrode active material for lithium ion secondary batteries, carbon materials such as graphite are widely used in order to avoid problems regarding dendrite deposition. In order to reversibly insert and eliminate lithium ions with respect to the negative electrode active material, nonaqueous carbonate based solvents such as cyclic esters and linear esters are used in a general electrolytic solution. However, in a conventional electrolytic solution using a carbonate based solvent, significant improvement in rate characteristic, which is one type of input-output characteristics of a lithium ion secondary battery, has been considered difficult. More specifically, as described in Non-Patent Literature 1 to 3, reaction resistance is large in a lithium ion secondary battery using a carbonate based solvent such as ethylene carbonate and propylene carbonate. Thus, a fundamental review of the composition of the solvent of the electrolytic solution has been considered necessary for improving rate capacity characteristic.

### CITATION LIST

### Patent Literature

Patent Literature 1: JP2007019027 (A)
Patent Literature 2: JP2007115671 (A)
Patent Literature 3: JP2003268053 (A)
Patent Literature 4: JP2006513554 (A)

### Non-Patent Literature

Non-Patent Literature 1: T. Abe et al., J. Electrochem. Soc., 151, A1120-A1123 (2004).
Non-Patent Literature 2: T. Abe et al., J. Electrochem. Soc., 152, A2151-A2154 (2005).
Non-Patent Literature 3: Y Yamada et al., Langmuir, 25, 12766-12770 (2009).

### SUMMARY OF INVENTION

### Technical Problem

The present invention has been made in view of the above described circumstances, and a problem to be solved is to obtain a nonaqueous electrolyte secondary battery having excellent battery characteristics.

### Solution to Problem

A coating has been known to form on the surfaces of a negative electrode and a positive electrode in a nonaqueous electrolyte secondary battery. This coating is also referred to as a Solid Electrolyte Interphase (SEI), and is formed from reductive degradation products, etc., of an electrolytic solution. This coating is also described in, for example, JP2007019027 (A). Hereinafter, this coating is abbreviated as an SEI coating in some cases.

The SEI coating on the surfaces of the negative electrode and the positive electrode allows a charge carrier such as lithium ions to pass therethrough. In addition, for example, the SEI coating on the surface of the negative electrode is considered to exist between an electrolytic solution and the surface of the negative electrode and contribute to suppress further reductive degradation of the electrolytic solution. The SEI coating is considered essential particularly for a low potential negative electrode using a graphite- or Si-based negative electrode active material.

Suppressing continuous degradation of the electrolytic solution by having the SEI coating is considered to improve discharge characteristics (hereinafter, referred to as cycle characteristics) of a battery after cycles. On the other hand, in a conventional nonaqueous electrolyte secondary battery, the SEI coating on the surfaces of the negative electrode and the positive electrode has not necessarily been considered to contribute in improving battery characteristics. Thus, development of a nonaqueous electrolyte secondary battery having an SEI coating enabling further improvement of battery characteristics has been desired.

As a result of thorough research, the inventors of the present invention discovered that, in a conventional nonaqueous electrolyte secondary battery, permeability of a charge carrier such as lithium ion is not sufficient depending on the composition, structure, or thickness of the SEI coating, and the SEI coating may cause an increase in reaction resistance (e.g., deterioration in input-output characteristics) of the nonaqueous electrolyte secondary battery. The inventors further advanced their research with a goal of developing a nonaqueous electrolyte secondary battery having an SEI coating capable of suppressing continuous degradation of an electrolytic solution and having excellent charge carrier transmissivity. As a result, the inventors discovered that, in a nonaqueous electrolyte secondary battery using a special electrolytic solution, an SEI coating having a special structure derived from the electrolytic solution forms on the surface of the negative electrode. Furthermore, the inventors also discovered that an SEI coating having a special structure derived from the electrolytic solution also forms on the surface of the positive electrode. In addition, the inventors discovered that the nonaqueous electrolyte secondary battery having the electrolytic solution and the SEI coating with the special structure derived from the electrolytic solution has excellent battery characteristics such as lifespan and input-output characteristics.

A nonaqueous electrolyte secondary battery (1) of the present invention solving the above described problem includes

a positive electrode, an electrolytic solution, and a negative electrode, wherein

the electrolytic solution contains: a salt whose cation is an alkali metal, an alkaline earth metal, or aluminum and whose anion includes a sulfur element and an oxygen element in a chemical structure thereof; and an organic solvent having a heteroelement,

regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is, and an S,O-containing coating having an S═O structure is formed on a surface of the negative electrode.

In addition, a nonaqueous electrolyte secondary battery (1) of the present invention solving the above described problem includes

a positive electrode, an electrolytic solution, and a negative electrode, wherein

the electrolytic solution contains: a salt whose cation is an alkali metal, an alkaline earth metal, or aluminum and whose anion includes a sulfur element and an oxygen element in a chemical structure thereof; and an organic solvent having a heteroelement,

regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is, and

an S,O-containing coating having an S═O structure is formed on, among a surface of the negative electrode and a surface of the positive electrode, at least the surface of the positive electrode.

Such a nonaqueous electrolyte secondary battery (1) has, on the surface of the negative electrode and/or the surface of the positive electrode, an SEI coating having a special structure, i.e., an S,O-containing coating, and has excellent battery characteristics.

On the other hand, a general negative electrode is produced by applying, on a current collector, a slurry containing a negative electrode active material and a binding agent, and drying the slurry. The binding agent serves a role of binding negative electrode active material together, and binding the active material and the current collector, and a role of covering and protecting the negative electrode active material.

Examples of negative electrode binding agents that have been conventionally used include fluorine-containing polymers such as polyvinylidene fluoride (PVdF), water soluble cellulose derivatives such as carboxymethyl cellulose (CMC), and polyacrylic acid. For example, Patent Literature 2 described above discloses a negative electrode for lithium ion secondary batteries, including a polymer that is selected from the group consisting of polyacrylic acid and polymethacrylic acid and that includes an acid anhydride group. In addition, Patent Literature 3 described above discloses using, as a negative electrode binding agent or a positive electrode binding agent, a polymer obtained through copolymerization of acrylic acid and methacrylic acid. Furthermore, Patent Literature 4 described above discloses using, as a negative electrode binding agent or a positive electrode binding agent, a polymer obtained through copolymerization of acrylamide, acrylic acid, and itaconic acid.

A feature of a nonaqueous electrolyte secondary battery (2) of the present invention solving the above described problem is including: an electrolytic solution containing a salt whose cation is an alkali metal, an alkaline earth metal, or aluminum, and an organic solvent having a heteroelement, wherein, regarding an intensity of an original peak of the organic solvent in a vibrational spectroscopy spectrum, Is>Io is satisfied when an intensity of an original peak of the organic solvent is represented as Io and an intensity of a peak resulting from shifting of the original peak is represented as Is; and a negative electrode having a negative electrode active material layer including a binding agent formed of a polymer having a hydrophilic group.

In the nonaqueous electrolyte secondary battery (2) of the present invention, a polymer having a hydrophilic group is used as a binding agent for negative electrodes, and, as an electrolytic solution, the electrolytic solution of the present invention is used. When a polymer such as polyvinylidene fluoride is used as the binding agent for negative electrodes, improving both rate characteristics and cycle characteristics has been difficult even when the same electrolytic solution of the present invention is used. However, by using, as the negative electrode binding agent, a binding agent formed of a polymer having a hydrophilic group, both rate characteristics and cycle characteristics are improved. A conceivable reason thereof is, for example, when the nonaqueous electrolyte secondary battery is a lithium ion secondary battery, improvement in load characteristics on a high rate side where concentration overpotential becomes dominant, due to lithium ions being drawn by polar groups such as carboxyl group included in the binding agent. In addition, cycle characteristics are thought to improve due to protective action against the active material by the binding agent.

Thus, with such a nonaqueous electrolyte secondary battery (2), rate capacity characteristics are improved and cycle characteristics are also improved by an optimum combination of the electrolytic solution and the binding agent.

Hereinafter, if necessary, “an electrolytic solution containing a salt whose cation is an alkali metal, an alkaline earth metal, or aluminum, and an organic solvent having a heteroelement, wherein, regarding an intensity of an original peak of the organic solvent in a vibrational spectroscopy spectrum, Is>Io is satisfied when an intensity of an original peak of the organic solvent is represented as Io and an intensity of a peak resulting from shifting of the original peak is represented as Is” is sometimes referred to as “an electrolytic solution of the present invention.”

Further, of the electrolytic solution of the present invention described above, one that contains a salt whose anion includes a sulfur element and an oxygen element in a chemical structure thereof is sometimes particularly referred to as “an electrolytic solution (1)” or “an electrolytic solution (1) of the present invention.” The electrolytic solution (1) of the present invention is one type of the electrolytic solution of the present invention, and is included in the nonaqueous electrolyte secondary battery (1). Needless to say, the nonaqueous electrolyte secondary battery (2) may include the electrolytic solution (1) of the present invention.

Furthermore, if necessary, the nonaqueous electrolyte secondary batteries (1) and (2) are collectively referred to as the nonaqueous electrolyte secondary battery of the present invention.

### Advantageous Effects of Invention

The nonaqueous electrolyte secondary battery of the present invention has excellent battery characteristics.

### BRIEF DESCRIPTION OF DRAWINGS

FIG. 1 is an IR spectrum of electrolytic solution E3;

FIG. 2 is an IR spectrum of electrolytic solution E4;

FIG. 3 is an IR spectrum of electrolytic solution E7;

FIG. 4 is an IR spectrum of electrolytic solution E8;

FIG. 5 is an IR spectrum of electrolytic solution E10;

FIG. 6 is an IR spectrum of electrolytic solution C2;

FIG. 7 is an IR spectrum of electrolytic solution C4;

FIG. 8 is an IR spectrum of acetonitrile;

FIG. 9 is an IR spectrum of (CF₃SO₂)₂NLi;

FIG. 10 is an IR spectrum of (FSO₂)₂NLi;

FIG. 11 is an IR spectrum of electrolytic solution E11;

FIG. 12 is an IR spectrum of electrolytic solution E12;

FIG. 13 is an IR spectrum of electrolytic solution E13;

FIG. 14 is an IR spectrum of electrolytic solution E14;

FIG. 15 is an IR spectrum of electrolytic solution E15;

FIG. 16 is an IR spectrum of electrolytic solution C6;

FIG. 17 is an IR spectrum of dimethyl carbonate;

FIG. 18 is an IR spectrum of electrolytic solution E16;

FIG. 19 is an IR spectrum of electrolytic solution E17;

FIG. 20 is an IR spectrum of electrolytic solution E18;

FIG. 21 is an IR spectrum of electrolytic solution C7;

FIG. 22 is an IR spectrum of ethyl methyl carbonate;

FIG. 23 is an IR spectrum of electrolytic solution E19;

FIG. 24 is an IR spectrum of electrolytic solution E20;

FIG. 25 is an IR spectrum of electrolytic solution E21;

FIG. 26 is an IR spectrum of electrolytic solution C8;

FIG. 27 is an IR spectrum of diethyl carbonate;

FIG. 28 is an IR spectrum of (FSO₂)₂NLi (1900 to 1600 cm⁻¹);

FIG. 29 is a Raman spectrum of electrolytic solution E8;

FIG. 30 is a Raman spectrum of electrolytic solution E9;

FIG. 31 is a Raman spectrum of electrolytic solution C4;

FIG. 32 is a Raman spectrum of electrolytic solution E11;

FIG. 33 is a Raman spectrum of electrolytic solution E13;

FIG. 34 is a Raman spectrum of electrolytic solution E15;

FIG. 35 is a Raman spectrum of electrolytic solution C6;

FIG. 36 shows a result of responsivity against repeated rapid charging/discharging in Evaluation Example 8;

FIG. 37 shows the results of XPS analysis of carbon element in negative-electrode S,O-containing coatings of Examples 1-1 and 1-2 and Comparative Example 1-1 in Evaluation Example 12;

FIG. 38 shows the results of XPS analysis of fluorine element in the negative-electrode S,O-containing coatings of Examples 1-1 and 1-2 and Comparative Example 1-1 in Evaluation Example 12;

FIG. 39 shows the results of XPS analysis of nitrogen element in the negative-electrode S,O-containing coatings of Examples 1-1 and 1-2 and Comparative Example 1-1 in Evaluation Example 12;

FIG. 40 shows the results of XPS analysis of oxygen element in the negative-electrode S,O-containing coatings of Examples 1-1 and 1-2 and Comparative Example 1-1 in Evaluation Example 12;

FIG. 41 shows the results of XPS analysis of sulfur element in the negative-electrode S,O-containing coatings of Examples 1-1 and 1-2 and Comparative Example 1-1 in Evaluation Example 12;

FIG. 42 shows the result of XPS analysis on the negative-electrode S,O-containing coating of Example 1-1 in Evaluation Example 12;

FIG. 43 shows the result of XPS analysis on the negative-electrode S,O-containing coating of Example 1-2 in Evaluation Example 12;

FIG. 44 is a BF-STEM image of the negative-electrode S,O-containing coating of Example 1-1 in Evaluation Example 12;

FIG. 45 shows the result of STEM analysis of C in the negative-electrode S,O-containing coating of Example 1-1 in Evaluation Example 12;

FIG. 46 shows the result of STEM analysis of O in the negative-electrode S,O-containing coating of Example 1-1 in Evaluation Example 12;

FIG. 47 shows the result of STEM analysis of S in the negative-electrode S,O-containing coating of Example 1-1 in Evaluation Example 12;

FIG. 48 shows the result of XPS analysis of O in a positive-electrode S,O-containing coating of Example 1-1 in Evaluation Example 12;

FIG. 49 shows the result of XPS analysis of S in the positive-electrode S,O-containing coating of Example 1-1 in Evaluation Example 12;

FIG. 50 shows the result of XPS analysis of S in a positive-electrode S,O-containing coating of Example 1-4 in Evaluation Example 12;

FIG. 51 shows the result of XPS analysis of O in the positive-electrode S,O-containing coating of Example 1-4 in Evaluation Example 12;

FIG. 52 shows the results of XPS analysis of S in positive-electrode S,O-containing coatings of Example 1-4, Example 1-5, and Comparative Example 1-2 in Evaluation Example 12;

FIG. 53 shows the results of XPS analysis of S in positive-electrode S,O-containing coatings of Example 1-6, Example 1-7, and Comparative Example 1-3 in Evaluation Example 12;

FIG. 54 shows the results of XPS analysis of O in the positive-electrode S,O-containing coatings of Example 1-4, Example 1-5, and Comparative Example 1-2 in Evaluation Example 12;

FIG. 55 shows the results of analysis of O in the positive-electrode S,O-containing coatings of Example 1-6, Example 1-7, and Comparative Example 1-3 in Evaluation Example 12;

FIG. 56 shows the results of analysis of S in negative-electrode S,O-containing coatings of Example 1-4, Example 1-5, and Comparative Example 1-2 in Evaluation Example 12;

FIG. 57 shows the results of analysis of S in negative-electrode S,O-containing coatings of Example 1-6, Example 1-7, and Comparative Example 1-3 in Evaluation Example 12;

FIG. 58 shows the results of analysis of O in the negative-electrode S,O-containing coatings of Example 1-4, Example 1-5, and Comparative Example 1-2 in Evaluation Example 12;

FIG. 59 shows the results of analysis of O in the negative-electrode S,O-containing coatings of Example 1-6, Example 1-7, and Comparative Example 1-3 in Evaluation Example 12;

FIG. 60 is a planar plot of complex impedance of a battery in Evaluation Example 13;

FIG. 61 is a DSC chart of the nonaqueous electrolyte secondary battery of Example 1-1 in Evaluation Example 20;

FIG. 62 is a DSC chart of the nonaqueous electrolyte secondary battery of Comparative Example 1-1 in Evaluation Example 20;

FIG. 63 is a graph showing the relationship between electrode potential and current in EB4 in Evaluation Example 21;

FIG. 64 is a graph showing the relationship between potential (3.1 to 4.6 V) and response current in EB4 in Evaluation Example 22;

FIG. 65 is a graph showing the relationship between potential (3.1 to 5.1 V) and response current in EB4 in Evaluation Example 22;

FIG. 66 is a graph showing the relationship between potential (3.1 to 4.6 V) and response current in EB5 in Evaluation Example 22;

FIG. 67 is a graph showing the relationship between potential (3.1 to 5.1 V) and response current in EB5 in Evaluation Example 22;

FIG. 68 is a graph showing the relationship between potential (3.1 to 4.6 V) and response current in EB6 in Evaluation Example 22;

FIG. 69 is a graph showing the relationship between potential (3.1 to 5.1 V) and response current in EB6 in Evaluation Example 22;

FIG. 70 is a graph showing the relationship between potential (3.1 to 4.6 V) and response current in EB7 in Evaluation Example 22;

FIG. 71 is a graph showing the relationship between potential (3.1 to 5.1 V) and response current in EB7 in Evaluation Example 22;

FIG. 72 is a graph showing the relationship between potential (3.1 to 4.6 V) and response current in CB4 in Evaluation Example 22;

FIG. 73 is a graph showing the relationship between potential (3.0 to 4.5 V) and response current in EB5 in Evaluation Example 22, and is obtained by changing the scale of the vertical axis in FIG. 66;

FIG. 74 is a graph showing the relationship between potential (3.0 to 5.0 V) and response current in EB5 in Evaluation Example 22, and is obtained by changing the scale of the vertical axis in FIG. 67;

FIG. 75 is a graph showing the relationship between potential (3.0 to 4.5 V) and response current in EB8 in Evaluation Example 22;

FIG. 76 is a graph showing the relationship between potential (3.0 to 5.0 V) and response current in EB8 in Evaluation Example 22;

FIG. 77 is a graph showing the relationship between potential (3.0 to 4.5 V) and response current in CB5 in Evaluation Example 22;

FIG. 78 is a graph showing the relationship between potential (3.0 to 5.0 V) and response current in CB5 in Evaluation Example 22;

FIG. 79 shows the result of surface analysis of an aluminum foil after charging and discharging the nonaqueous electrolyte secondary battery of Example 1-1 in Evaluation Example 24;

FIG. 80 shows the result of surface analysis of an aluminum foil after charging and discharging a nonaqueous electrolyte secondary battery of Example 1-2 in Evaluation Example 24;

FIG. 81 shows charging/discharging curves of EB9;

FIG. 82 shows charging/discharging curves of EB10;

FIG. 83 shows charging/discharging curves of EB11;

FIG. 84 shows charging/discharging curves of EB12;

FIG. 85 shows charging/discharging curves of CB6;

FIG. 86 shows the results regarding low-temperature rate characteristics in Evaluation Example 29;

FIG. 87 shows the results regarding low-temperature rate characteristics in Evaluation Example 29; and

FIG. 88 is a graph showing charging/discharging characteristics of nonaqueous electrolyte secondary batteries of Examples 2-1 and 2-2 and Comparative Example 2-1.

### DESCRIPTION OF EMBODIMENTS

The following describes embodiments of the present invention. Unless mentioned otherwise in particular, a numerical value range of “a to b” described in the present application includes, in the range thereof, a lower limit “a” and an upper limit “b.” A numerical value range can be formed by arbitrarily combining such upper limit values, lower limit values, and numerical values described in Examples. In addition, numerical values arbitrarily selected within the numerical value range can be used as upper limit and lower limit numerical values.

A nonaqueous electrolyte secondary battery (1) of the present invention includes a negative electrode, a positive electrode, and the electrolytic solution (1) of the present invention, and has an S,O-containing coating formed on the surface of the positive electrode and/or negative electrode. In addition, a nonaqueous electrolyte secondary battery (2) of the present invention includes the electrolytic solution of the present invention, and a negative electrode having a negative electrode active material layer that includes a binding agent formed of a polymer having a hydrophilic group.

As described above, the nonaqueous electrolyte secondary battery (1) of the present invention seeks improvement of battery characteristics by forming an S,O-containing coating on the surface of the positive electrode and/or the negative electrode. Thus, with the nonaqueous electrolyte secondary battery (1), no particular limitation exists for battery components other than the electrolytic solution, such as, for example, a negative electrode active material, a positive electrode active material, a conductive additive, a binding agent, a current collector, and a separator. As described above, the nonaqueous electrolyte secondary battery (2) of the present invention seeks improvement of battery characteristics by an optimum combination of a negative electrode binding agent and an electrolytic solution. Thus, with the nonaqueous electrolyte secondary battery (2), no particular limitation exists for battery components other than the negative electrode binding agent and the electrolytic solution. In both cases, an S,O-containing coating, which is an SEI coating having a special structure, is formed on the surface of the negative electrode and/or the surface of the positive electrode in the nonaqueous electrolyte secondary battery of the present invention.

In addition, no particular limitation exists also for charge carriers in the nonaqueous electrolyte secondary battery of the present invention. For example, the nonaqueous electrolyte secondary battery of the present invention may be a nonaqueous electrolyte secondary battery whose charge carrier is lithium (e.g., a lithium secondary battery, a lithium ion secondary battery), or a nonaqueous electrolyte secondary battery whose charge carrier is sodium (e.g., a sodium secondary battery, a sodium ion secondary battery).

As described above, the electrolytic solution of the present invention contains a salt whose cation is an alkali metal, an alkaline earth metal, or aluminum, and an organic solvent having a heteroatom. Regarding an intensity of an original peak of the organic solvent in a vibrational spectroscopy spectrum, Is>Io is satisfied when an intensity of an original peak of the organic solvent is represented as Io and an intensity of a peak resulting from wave-number shifting of the original peak of the organic solvent is represented as Is. In particular, the electrolytic solution (1) used in the nonaqueous electrolyte secondary battery (1) uses, as the salt, a salt whose cation is an alkali metal, an alkaline earth metal, or aluminum and whose anion includes a sulfur element and an oxygen element in a chemical structure thereof. More specifically, the electrolytic solution (1) is one mode of the electrolytic solution of the present invention. Thus, the relationship between Io and Is is consistently Is>Io in the electrolytic solution of the present invention. On the other hand, the relationship between Is and Io is Is<Io in a conventional electrolytic solution. The electrolytic solution of the present invention is largely different from a conventional electrolytic solution regarding this point. Hereinafter, if necessary, the salt contained in the electrolytic solution of the present invention and/or the electrolytic solution (1), more specifically, “a salt whose cation is an alkali metal, an alkaline earth metal, or aluminum” and/or “a salt whose cation is an alkali metal, an alkaline earth metal, or aluminum and whose anion includes a sulfur element and an oxygen element in a chemical structure thereof,” is sometimes referred to as “a metal salt,” a supporting salt, a supporting electrolyte, or simply “a salt.” Since the electrolytic solution (1) is one mode of the electrolytic solution of the present invention, parts describing “the electrolytic solution of the present invention” without any particular explanation or mention describe the electrolytic solution of the present invention overall including the electrolytic solution (1).

[Metal Salt]

In the electrolytic solution of the present invention, the metal salt may be a compound used as an electrolyte, such as LiClO₄, LiAsF₆, LiPF₆, LiBF₄, and LiAlCl₄ ordinarily contained in an electrolytic solution of a battery. Examples of a cation of the metal salt include alkali metals such as lithium, sodium, and potassium, alkaline earth metals such as beryllium, magnesium, calcium, strontium, and barium, and aluminum. The cation of the metal salt is preferably a metal ion identical to a charge carrier of the battery in which the electrolytic solution is used. For example, when the electrolytic solution of the present invention is to be used as an electrolytic solution for lithium ion secondary batteries, the cation of the metal salt is preferably lithium.

In such case, the chemical structure of the anion of the salt may include at least one element selected from a halogen, boron, nitrogen, oxygen, sulfur, or carbon. Specific examples of the chemical structure of the anion including a halogen or boron include: ClO₄, PF₆, AsF₆, SbF₆, TaF₆, BF₄, SiF₆, B(C₆H₅)₄, B(oxalate)₂, Cl, Br, and I.

The chemical structure of the anion including nitrogen, oxygen, sulfur, or carbon is described specifically in the following.

The chemical structure of the anion of the salt is preferably a chemical structure represented by the following general formula (1), general formula (2), or general formula (3).

(R¹X¹)(R²X²)N General Formula (1)

(R¹ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R² is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

Furthermore, R¹ and R² optionally bind with each other to form a ring.

X¹ is selected from SO₂, C═O, C═S, R^{a}P═O, R^{b}P═S, S═O, or Si═O.

X² is selected from SO₂, C═O, C═S, R^{c}P═O, R^{d}P═S, S═O, or Si═O.

R^{a}, R^{b}, R^{c}, and R^{d} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{a}, R^{b}, R^{c}, and R^{d} each optionally bind with R¹ or R² to form a ring.)

R³X³Y General Formula (2)

(R³ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

X³ is selected from SO₂, C═O, C═S, R^{c}P═O, R^{f}P═S, S═O, or Si═O.

R^{e} and R^{f} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{e} and R^{f} each optionally bind with R³ to form a ring.

Y is selected from O or S.)

(R⁴X⁴)(R⁵X⁵)(R⁶X⁶)C General Formula (3)

(R⁴ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R⁵ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

R⁶ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.

In addition, any two or three of R⁴, R⁵, and R⁶ optionally bind with each other to form a ring.

X⁴ is selected from SO₂, C═O, C═S, R^{g}P═O, R^{h}P═S, S═O, or Si═O.

X⁵ is selected from SO₂, C═O, C═S, RⁱP═O, R^{j}P═S, S═O, or Si═O.

X⁶ is selected from SO₂, C═O, C═S, R^{k}P═O, R^{l}P═S, S═O, or Si═O.

R^{g}, R^{h}, Rⁱ, R^{k}, and R^{l} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{g}, R^{h}, Rⁱ, R^{k}, and R^{l} each optionally bind with R⁴, R⁵, or R⁶ to form a ring.)

The wording of “optionally substituted with a substituent group” in the chemical structures represented by the above described general formulae (1) to (3) is to be described. For example, “an alkyl group optionally substituted with a substituent group” refers to an alkyl group in which one or more hydrogen atoms of the alkyl group is substituted with a substituent group, or an alkyl group not including any particular substituent groups.

Examples of the substituent group in the wording of “optionally substituted with a substituent group” include alkyl groups, alkenyl groups, alkynyl groups, cycloalkyl groups, unsaturated cycloalkyl groups, aromatic groups, heterocyclic groups, halogens, OH, SH, CN, SCN, OCN, nitro group, alkoxy groups, unsaturated alkoxy groups, amino group, alkylamino groups, dialkylamino groups, aryloxy groups, acyl groups, alkoxycarbonyl groups, acyloxy groups, aryloxycarbonyl groups, acyloxy groups, acylamino groups, alkoxycarbonylamino groups, aryloxycarbonylamino groups, sulfonylamino groups, sulfamoyl groups, carbamoyl group, alkylthio groups, arylthio groups, sulfonyl group, sulfinyl group, ureido groups, phosphoric acid amide groups, sulfo group, carboxyl group, hydroxamic acid groups, sulfino group, hydrazino group, imino group, and silyl group, etc. These substituent groups may be further substituted. In addition, when two or more substituent groups exist, the substituent groups may be identical or different from each other.

The chemical structure of the anion of the salt is more preferably a chemical structure represented by the following general formula (4), general formula (5), or general formula (6).

(R⁷X⁷)(R⁸X⁸)N General Formula (4)

(R⁷ and R⁸ are each independently C—HₐF_{b}Cl_{c}Br_{d}Iₑ(CN)_{f}(SCN)_{g}(OCN)ₕ.

“n,” “a,” “b,” “c,” “d,” “e,” “f,” “g,” and “h” are each independently an integer not smaller than 0, and satisfy 2n+1=a+b+c+d+e+f+g+h.

In addition, R⁷ and R⁸ optionally bind with each other to form a ring, and, in that case, satisfy 2n=a+b+c+d+e+f+g+h.

X⁷ is selected from SO₂, C═O, C═S, R^{m}P═O, RⁿP═S, S═O, or Si═O.

X⁸ is selected from SO₂, C═O, C═S, R^{o}P═O, R^{p}P═S, S═O, or Si═O.

R^{m}, Rⁿ, R^{o}, and R^{p} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{m}, Rⁿ, R^{o}, and R^{p} each optionally bind with R⁷ or R⁸ to form a ring.)

R⁹X⁹Y General Formula (5)

(R⁹ is CₐHₐF_{b}Cl_{c}Br_{d}Iₑ(CN)_{f}(SCN)_{g}(OCN)ₕ.

“n,” “a,” “b,” “c,” “d,” “e,” “f,” “g,” and “h” are each independently an integer not smaller than 0, and satisfy 2n+1=a+b+c+d+e+f+g+h.

X⁹ is selected from SO₂, C═O, C═S, R^{q}P═O, R^{r}P═S, S═O, or Si═O.

R^{q} and R^{r} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{q} and R^{r} each optionally bind with R⁹ to form a ring.

Y is selected from O or S.)

(R¹⁰X¹⁰)(R¹¹X¹¹)(R¹²X¹²)C General Formula (6)

(R¹⁰, R¹¹, and R¹² are each independently CₙHₐF_{b}Cl_{c}Br_{d}Iₑ(CN)_{f}(SCN)_{g}(OCN)ₕ.

“n,” “a,” “b,” “c,” “d,” “e,” “f,” “g,” and “h” are each independently an integer not smaller than 0, and satisfy 2n+1=a+b+c+d+e+f+g+h.

Any two of R¹⁰, R¹¹, and R¹² optionally bind with each other to form a ring, and in that case, groups forming the ring satisfy 2n=a+b+c+d+e+f+g+h. In addition, the three of R¹⁰, R¹¹, and R¹², optionally bind with each other to form a ring, and, in that case, two groups satisfy 2n=a+b+c+d+e+f+g+h and one group satisfies 2n−1=a+b+c+d+e+f+g+h.

X¹⁰ is selected from SO₂, C═O, C═S, R^{s}P═O, R^{t}P═S, S═O, or Si═O.

X¹¹ is selected from SO₂, C═O, C═S, R^{u}P═O, R^{v}P═S, S═O, or Si═O.

X¹² is selected from SO₂, C═O, C═S, R^{w}P═O, R^{x}P═S, S═O, or Si═O.

R^{s}, R^{t}, R^{u}, R^{v}, R^{w}, and R^{x} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN.

In addition, R^{s}, R^{t}, R^{u}, R^{v}, R^{w}, and R^{x} each optionally bind with R¹⁰, R¹¹, or R¹² to form a ring.)

In the chemical structures represented by the general formulae (4) to (6), the meaning of the wording of “optionally substituted with a substituent group” is synonymous with that described for the general formulae (1) to (3).

In the chemical structures represented by the general formulae (4) to (6), “n” is preferably an integer from 0 to 6, more preferably an integer from 0 to 4, and particularly preferably an integer from 0 to 2. In the chemical structures represented by the general formulae (4) to (6), when R⁷ and R⁸ bind with each other or R¹⁰, R¹¹, and R¹² bind with each other to form a ring; “n” is preferably an integer from 1 to 8, more preferably an integer from 1 to 7, and particularly preferably an integer from 1 to 3.

The chemical structure of the anion of the salt is more preferably one that is represented by the following general formula (7), general formula (8), or general formula (9).

(R¹³SO₂)(R¹⁴SO₂)N General Formula (7)

(R¹³ and R¹⁴ are each independently CₙHₐF_{b}Cl_{c}Br_{d}Iₑ.

“n,” “a,” “b,” “c,” “d,” and “e” are each independently an integer not smaller than 0, and satisfy 2n+1=a+b+c+d+e.

In addition, R¹³ and R¹⁴ optionally bind with each other to form a ring, and, in that case, satisfy 2n=a+b+c+d+e.)

R¹⁵SO₃ General Formula (8)

(R¹⁵ is CₙHₐF_{b}Cl_{c}Br_{d}Iₑ.

“n,” “a,” “b,” “c,” “d,” and “e” are each independently an integer not smaller than 0, and satisfy 2n+1=a+b+c+d+e.)

(R¹⁶SO₂)(R¹⁷SO₂)(R¹⁸SO₂)C General Formula (9)

(R¹⁶, R¹⁷, and R¹⁸ are each independently CₙHₐF_{b}Cl_{c}Br_{d}Iₑ.

“n,” “a,” “b,” “c,” “d,” and “e” are each independently an integer not smaller than 0, and satisfy 2n+1=a+b+c+d+e.

Any two of R¹⁶, R¹⁷, and R¹⁸ optionally bind with each other to form a ring, and, in that case, groups forming the ring satisfy 2n=a+b+c+d+e. In addition, the three of R¹⁶, R¹⁷, and R¹⁸ optionally bind with each other to form a ring, and, among the three in that case, two groups satisfy 2n=a+b+c+d+e and one group satisfies 2n−1=a+b+c+d+e.)

In the chemical structures represented by the general formulae (7) to (9), “n” is preferably an integer from 0 to 6, more preferably an integer from 0 to 4, and particularly preferably an integer from 0 to 2. In the chemical structures represented by the general formulae (7) to (9), when Rⁿ and R¹⁴ bind with each other or R¹⁶, R¹⁷, and R¹⁸ bind with each other to form a ring; “n” is preferably an integer from 1 to 8, more preferably an integer from 1 to 7, and particularly preferably an integer from 1 to 3.

In addition, in the chemical structures represented by the general formulae (7) to (9), those in which “a,” “c,” “d,” and “e” are 0 are preferable.

The metal salt is particularly preferably (CF₃SO₂)₂NLi (hereinafter, sometimes referred to as “LiTFSA”), (FSO₂)₂NLi (hereinafter, sometimes referred to as “LiFSA”), (C₂F₅SO₂)₂NLi, FSO₂(CF₃SO₂)NLi, (SO₂CF₂CF₂SO₂)NLi, (SO₂CF₂CF₂CF₂SO₂)NLi, FSO₂(CH₃SO₂)NLi, FSO₂(C₂F₅SO₂)NLi, or FSO₂(C₂H₅SO₂)NLi. These metal salts are imide salts. Thus, in other words, using an imide salt as the metal salt is particularly preferable.

As the metal salt, one that is obtained by combining appropriate numbers of an anion and a cation described above may be used. Regarding the metal salt, a single type described above may be used, or a combination of multiple types may be used.

On the other hand, the metal salt in the electrolytic solution (1) is a metal salt whose anion includes a sulfur element and an oxygen element in a chemical structure thereof, and whose cation is similar to that described for the electrolytic solution of the present invention.

The chemical structure of the anion of the salt in the electrolytic solution (1) includes a sulfur element and an oxygen element. The chemical structure of this anion is described specifically in the following. In the following, only the difference between the electrolytic solution of the present invention and the electrolytic solution (1) of the present invention is described. Thus, regarding items not described in particular, the electrolytic solution (1) is similar to the electrolytic solution of the present invention.

The chemical structure of the anion of the salt is preferably a chemical structure represented by general formula (1), (2), or (3) described above. However, as described in the following, X¹ to X⁵ are further limited than the above described X¹ to X⁵.

In the electrolytic solution (1), X¹ in general formula (1) is selected from SO₂ or S═O, and X² is selected from SO₂ or S═O.

Additionally in the electrolytic solution (1), X³ in general formula (2) is selected from SO₂ or S═O.

Additionally in the electrolytic solution (1), X⁴ in general formula (3) is selected from SO₂ or S═O, X⁵ is selected from SO₂ or S═O, and X⁶ is selected from SO₂ or S═O.

The chemical structure of the anion of the salt is more preferably a chemical structure represented by general formula (4), (5), or (6) described above. However, as described in the following, X⁷ to X¹² are further limited than the above described X⁷ to X¹².

In the electrolytic solution (1), X⁷ in general formula (4) is selected from SO₂ or S═O, and X⁸ is selected from SO₂ or S═O.

Additionally in the electrolytic solution (1), X⁹ in general formula (5) is selected form SO₂ or S═O.

Additionally in the electrolytic solution (1), X¹⁰ in general formula (6) is selected from SO₂ or S═O, X¹¹ is selected from SO₂ or S═O, and X¹² is selected from SO₂ or S═O.

[Organic Solvent]

As the organic solvent having a heteroelement, an organic solvent whose heteroelement is at least one selected from nitrogen, oxygen, sulfur, or a halogen is preferable, and an organic solvent whose heteroelement is at least one selected from nitrogen or oxygen is more preferable. In addition, as the organic solvent having the heteroelement, an aprotic solvent not having a proton donor group such as NH group, NH₂ group, OH group, and SH group is preferable.

Specific examples of “the organic solvent having the heteroelement” (hereinafter, sometimes simply referred to as “organic solvent”) include nitriles such as acetonitrile, propionitrile, acrylonitrile, and malononitrile, ethers such as 1,2-dimethoxyethane, 1,2-diethoxyethane, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, and crown ethers, carbonates such as ethylene carbonate, propylene carbonate, dimethyl carbonate, diethyl carbonate, and ethyl methyl carbonate, amides such as formamide, N,N-dimethylformamide, N,N-dimethylacetamide, and N-methylpyrrolidone, isocyanates such as isopropyl isocyanate, n-propylisocyanate, and chloromethyl isocyanate, esters such as methyl acetate, ethyl acetate, propyl acetate, methyl propionate, methyl formate, ethyl formate, vinyl acetate, methyl acrylate, and methyl methacrylate, epoxies such as glycidyl methyl ether, epoxy butane, and 2-ethyloxirane, oxazoles such as oxazole, 2-ethyloxazole, oxazoline, and 2-methyl-2-oxazoline, ketones such as acetone, methyl ethyl ketone, and methyl isobutyl ketone, acid anhydrides such as acetic anhydride and propionic anhydride, sulfones such as dimethyl sulfone and sulfolane, sulfoxides such as dimethyl sulfoxide, nitros such as 1-nitropropane and 2-nitropropane, furans such as furan and furfural, cyclic esters such as γ-butyrolactone, γ-valerolactone, and δ-valerolactone, aromatic heterocycles such as thiophene and pyridine, heterocycles such as tetrahydro-4-pyrone, 1-methylpyrrolidine, and N-methylmorpholine, and phosphoric acid esters such as trimethyl phosphate and triethyl phosphate.

Furthermore, examples of the organic solvent having a heteroelement may include a linear carbonate represented by general formula (10) described below.

R¹⁹OCOOR²⁰ General Formula (10)

(R¹⁹ and R²⁰ are each independently selected from CₙHₐF_{b}Cl_{c}Br_{d}Iₑ that is a linear alkyl or CₘH_{f}F_{g}ClₕBrᵢIⱼ whose chemical structure includes a cyclic alkyl. “n,” “a,” “b,” “c,” “d,” “e,” “m,” “f,” “g,” “h,” “i,” and “j” are each independently an integer not smaller than 0, and satisfy 2n+1=a+b+c+d+e and 2m=f+g+h+i+j.)

In the linear carbonates represented by the general formula (10), “n” is preferably an integer from 1 to 6, more preferably an integer from 1 to 4, and particularly preferably an integer from 1 to 2. “m” is preferably an integer from 3 to 8, more preferably an integer from 4 to 7, and particularly preferably an integer from 5 to 6. In addition, among the linear carbonates represented by the general formula (10), dimethyl carbonate (hereinafter, sometimes referred to as “DMC”), diethyl carbonate (hereinafter, sometimes referred to as “DEC”), and ethyl methyl carbonate (hereinafter, sometimes referred to as “EMC”) are particularly preferable.

As the organic solvent having a heteroelement, a solvent whose relative permittivity is not smaller than 20 or that has ether oxygen having donor property is preferable, and examples of the organic solvent include nitriles such as acetonitrile, propionitrile, acrylonitrile, and malononitrile, ethers such as 1,2-dimethoxyethane, 1,2-diethoxyethane, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, and crown ethers, N,N-dimethylformamide, acetone, dimethyl sulfoxide, and sulfolane. Among those, acetonitrile (hereinafter, sometimes referred to as “AN”) and 1,2-dimethoxyethane (hereinafter, sometimes referred to as “DME”) are particularly preferable.

Regarding these organic solvents, a single type may be used by itself in the electrolytic solution, or a combination of two or more types may be used.

A feature of the electrolytic solution of the present invention is, in its vibrational spectroscopy spectrum and regarding an intensity of a peak derived from the organic solvent contained in the electrolytic solution, satisfying Is>Io when an intensity of an original peak of the organic solvent is represented as Io and an intensity of “a peak resulting from shifting of the original peak of the organic solvent” (hereinafter, sometimes referred to as “shift peak”) is represented as Is. More specifically, in a vibrational spectroscopy spectrum chart obtained by subjecting the electrolytic solution of the present invention to vibrational spectroscopy measurement, the relationship between the two peak intensities is Is>Io.

Here, “an original peak of the organic solvent” refers to a peak observed at a peak position (wave number) when the vibrational spectroscopy measurement is performed only on the organic solvent. The value of the intensity Io of the original peak of the organic solvent and the value of the intensity Is of the shift peak are heights or area sizes from a baseline of respective peaks in a vibrational spectroscopy spectrum.

In the vibrational spectroscopy spectrum of the electrolytic solution of the present invention, when multiple peaks resulting from shifting of the original peak of the organic solvent exist, the relationship may be determined based on a peak enabling determination of the relationship between Is and Io most easily. In addition, when multiple types of the organic solvent having the heteroelement are used in the electrolytic solution of the present invention, an organic solvent enabling determination of the relationship between Is and Io most easily (resulting in the largest difference between Is and Io) is selected, and the relationship between Is and Io may be determined based on the obtained peak intensity. In addition, when the peak shift amount is small and peaks before and after shifting overlap with each other to give an appearance like a smooth mountain, the relationship between Is and Io may be determined by performing peak resolution with known means.

In the vibrational spectroscopy spectrum of the electrolytic solution using multiple types of the organic solvent having the heteroelement, a peak of an organic solvent most easily coordinated with a cation (hereinafter, sometimes referred to as “preferential coordination solvent”) shifts preferentially from others. In the electrolytic solution using multiple types of the organic solvent having the heteroelement, the mass % of the preferential coordination solvent with respect to the whole organic solvent having the heteroelement is preferably 40% or higher, more preferably 50% or higher, further preferably 60% or higher, and particularly preferably 80% or higher. In addition, in the electrolytic solution using multiple types of the organic solvent having the heteroelement, the vol % of the preferential coordination solvent with respect to the whole organic solvent having the heteroelement is preferably 40% or higher, more preferably 50% or higher, further preferably 60% or higher, and particularly preferably 80% or higher.

The relationship between the two peak intensities in the vibrational spectroscopy spectrum of the electrolytic solution of the present invention preferably satisfies a condition of Is>2×Io, more preferably satisfies a condition of Is>3×Io, further preferably satisfies a condition of Is>5×Io, and particularly preferably satisfies a condition of Is>7×Io. A most preferable electrolytic solution is one in which the intensity Io of the original peak of the organic solvent is not observed and the intensity Is of the shift peak is observed in the vibrational spectroscopy spectrum of the electrolytic solution of the present invention. This means that, in the electrolytic solution, all molecules of the organic solvent contained in the electrolytic solution are completely solvated with the metal salt. The electrolytic solution of the present invention is most preferably in a state in which all molecules of the organic solvent contained in the electrolytic solution are completely solvated with the metal salt (a state of Io=0).

In the electrolytic solution of the present invention, the metal salt and the organic solvent having the heteroelement (or the preferential coordination solvent) are estimated to interact with each other. Specifically, the metal salt and the heteroelement in the organic solvent having the heteroelement (or the preferential coordination solvent) are estimated to form a coordinate bond and form a stable cluster formed of the metal salt and the organic solvent having the heteroelement (or the preferential coordination solvent). Based on results from later described Examples, the cluster is estimated to be formed mostly from coordination of 2 molecules of the organic solvent having the heteroelement (or the preferential coordination solvent) with respect to 1 molecule of the metal salt. When this point is taken into consideration, in the electrolytic solution of the present invention, the mol range of the organic solvent having the heteroelement (or the preferential coordination solvent) with respect to 1 mol of the metal salt is preferably not lower than 1.4 mol but lower than 3.5 mol, more preferably not lower than 1.5 mol but not higher than 3.1 mol, and further preferably not lower than 1.6 mol but not higher than 3 mol.

In the electrolytic solution of the present invention, since a cluster is estimated to be formed mostly from coordination of 2 molecules of the organic solvent having the heteroelement (or the preferential coordination solvent) with respect to 1 molecule of the metal salt, the concentration (mol/L) of the electrolytic solution of the present invention depends on respective molecular weights of the metal salt and the organic solvent, and the density in the solution. Thus, unconditionally defining the concentration of the electrolytic solution of the present invention is not appropriate.

Concentration (mol/L) of each of the electrolytic solutions of the present invention is shown in Table 1.

TABLE 1

| Metal salt | Organic solvent | Concentration (mol/L) |
|---|---|---|
| LiTFSA | DME | 2.2 to 3.4 |
| LiTFSA | AN | 3.2 to 4.9 |
| LiFSA | DME | 2.6 to 4.1 |
| LiFSA | AN | 3.9 to 6.0 |
| LiFSA | DMC | 2.3 to 4.5 |
| LiFSA | EMC | 2.0 to 3.8 |
| LiFSA | DEC | 1.8 to 3.6 |

An organic solvent forming the cluster and an organic solvent not involved in the formation of the cluster are different in terms of the environment in which the respective organic solvents exist. Thus, in the vibrational spectroscopy measurement, a peak derived from the organic solvent forming the cluster is observed to be shifted toward the high wave number side or the low wave number side with respect to the wave number observed at a peak (original peak of the organic solvent) derived from the organic solvent not involved in the formation of the cluster. Thus, the shift peak represents a peak of the organic solvent forming the cluster.

Examples of the vibrational spectroscopy spectrum include an IR spectrum or a Raman spectrum. Examples of measuring methods of IR measurement include transmission measuring methods such as Nujol mull method and liquid film method, and reflection measuring methods such as ATR method. Regarding which of the IR spectrum and the Raman spectrum is to be selected, a spectrum enabling easy determination of the relationship between Is and Io may be selected as the vibrational spectroscopy spectrum of the electrolytic solution of the present invention. The vibrational spectroscopy measurement is preferably performed in a condition where the effect of moisture in the atmosphere can be lessened or ignored. For example, performing the IR measurement under a low humidity or zero humidity condition such as in a dry room or a glovebox is preferable, or performing the Raman measurement in a state where the electrolytic solution is kept inside a sealed container is preferable.

Here, specific description is provided regarding a peak of the electrolytic solution of the present invention containing LiTFSA as the metal salt and acetonitrile as the organic solvent.

When the IR measurement is performed on acetonitrile alone, a peak derived from stretching vibration of a triple bond between C and N is ordinarily observed at around 2100 to 2400 cm⁻¹.

Here, based on conventional technical common knowledge, a case is envisioned in which an electrolytic solution is obtained by dissolving LiTFSA in an acetonitrile solvent at a concentration of 1 mol/L. Since 1 L of acetonitrile corresponds to approximately 19 mol, 1 mol of LiTFSA and 19 mol of acetonitrile exist in 1 L of a conventional electrolytic solution. Then, in the conventional electrolytic solution, at the same time when acetonitrile solvated with LiTFSA (coordinated with Li) exists, a large amount of acetonitrile not solvated with LiTFSA (not coordinated with Li) exists. Since an acetonitrile molecule solvated with LiTFSA and an acetonitrile molecule not solvated with LiTFSA are different regarding the environments in which the respective acetonitrile molecules are placed, the acetonitrile peaks of both molecules are distinctively observed in the IR spectrum. More specifically, although a peak of acetonitrile not solvated with LiTFSA is observed at the same position (wave number) as in the case with the IR measurement on acetonitrile alone, a peak of acetonitrile solvated with LiTFSA is observed such that its peak position (wave number) is shifted toward the high wave number side.

Since a large amount of acetonitrile not solvated with LiTFSA exists at the concentration of the conventional electrolytic solution, the relationship between the intensity Io of the original peak of acetonitrile and the intensity Is of the peak resulting from shift of the original peak of acetonitrile becomes Is<Io in the vibrational spectroscopy spectrum of the conventional electrolytic solution.

On the other hand, when compared to the conventional electrolytic solution, the electrolytic solution of the present invention has a high concentration of LiTFSA, and the number of acetonitrile molecules solvated (forming a cluster) with LiTFSA in the electrolytic solution is larger than the number of acetonitrile molecules not solvated with LiTFSA. As a result, the relationship between the intensity Io of the original peak of acetonitrile and the intensity Is of the peak resulting from shifting of the original peak of acetonitrile becomes Is>Io in the vibrational spectroscopy spectrum of the electrolytic solution of the present invention.

In Table 2, wave numbers and attributions thereof are exemplified for organic solvents considered to be useful when calculating Io and Is in the vibrational spectroscopy spectrum of the electrolytic solution of the present invention. Depending on measuring devices, measuring environments, and measuring conditions used for obtaining the vibrational spectroscopy spectrum, the wave number of the observed peak may be different from the following wave numbers.

TABLE 2

| | wave number | |
|---|---|---|
| Organic solvent | (cm⁻¹) | Attribution |
| ethylene carbonate | 1769 | Double bond between C and O |
| propylene carbonate | 1829 | Double bond between C and O |
| acetic anhydride | 1785, 1826 | Double bond between C and O |
| acetone | 1727 | Double bond between C and O |
| acetonitrile | 2285 | Triple bond between C and N |
| acetonitrile | 899 | C—C single bond |
| DME | 1099 | C—O single bond |
| DME | 1124 | C—O single bond |
| N,N- | 1708 | Double bond between C and O |
| dimethylformamide | | |
| γ-butyrolactone | 1800 | Double bond between C and O |
| nitropropane | 1563 | Double bond between N and O |
| pyridine | 977 | Unknown |
| dimethyl sulfoxide | 1017 | S—O bond |

Regarding a wave number of an organic solvent and an attribution thereof, well-known data may be referenced. Examples of the reference include “Raman spectrometry” Spectroscopical Society of Japan measurement method series 17, Hiroo Hamaguchi and Akiko Hirakawa, Japan Scientific Societies Press, pages 231 to 249. In addition, a wave number of an organic solvent considered to be useful for calculating Io and Is, and a shift in the wave number when the organic solvent and the metal salt coordinate with each other are predicted from a calculation using a computer. For example, the calculation may be performed by using Gaussian09 (Registered trademark, Gaussian, Inc.), and setting the density function to B3LYP and the basis function to 6-311G++ (d, p). A person skilled in the art can calculate Io and Is by referring to the description in Table 2, well-known data, and a calculation result from a computer to select a peak of an organic solvent.

Since the electrolytic solution of the present invention has the metal salt and the organic solvent exist in a different environment and has a high metal salt concentration when compared to the conventional electrolytic solution; improvement in a metal ion transportation rate in the electrolytic solution (particularly improvement of lithium transference number when the metal is lithium), improvement in reaction rate between an electrode and an electrolytic solution interface, mitigation of uneven distribution of salt concentration in the electrolytic solution caused when a battery undergoes high-rate charging and discharging, and increase in the capacity of an electrical double layer are expected. As described later, at least part of these advantageous effects is thought to be caused by the SEI coating having the special structure derived from the electrolytic solution of the present invention and formed on the surface of the negative electrode and/or the positive electrode. The various advantageous effects described above such as, for example, improvement in reaction rate between an electrode and an electrolytic solution interface, are thought to be exerted because of cooperation between the electrolytic solution of the present invention and the SEI coating having the special structure. In the electrolytic solution of the present invention, since most of the organic solvent having the heteroelement is forming a cluster with the metal salt, the vapor pressure of the organic solvent contained in the electrolytic solution becomes lower. As a result, volatilization of the organic solvent from the electrolytic solution of the present invention is reduced.

The method for producing the electrolytic solution of the present invention is described. Since the electrolytic solution of the present invention contains a large amount of the metal salt compared to the conventional electrolytic solution, a production method of adding the organic solvent to a solid (powder) metal salt results in an aggregate, and manufacturing an electrolytic solution in a solution state is difficult. Thus, in the method for producing the electrolytic solution of the present invention, the metal salt is preferably gradually added to the organic solvent while a solution state of the electrolytic solution is maintained during production.

Depending on the types of the metal salt and the organic solvent, the electrolytic solution of the present invention includes a liquid in which the metal salt is dissolved in the organic solvent in a manner exceeding a conventionally regarded saturation solubility. A method for producing the electrolytic solution of the present invention includes: a first dissolution step of preparing a first electrolytic solution by mixing the organic solvent having the heteroelement and the metal salt to dissolve the metal salt; a second dissolution step of preparing a second electrolytic solution in a supersaturation state by adding the metal salt to the first electrolytic solution under stirring and/or heating conditions to dissolve the metal salt; and a third dissolution step of preparing a third electrolytic solution by adding the metal salt to the second electrolytic solution under stirring and/or heating conditions to dissolve the metal salt.

Here, the “supersaturation state” described above refers to a state in which a metal salt crystal is deposited from the electrolytic solution when the stirring and/or heating conditions are discontinued or when crystal nucleation energy such as vibration is provided thereto. The second electrolytic solution is in the “supersaturation state,” whereas the first electrolytic solution and the third electrolytic solution are not in the “supersaturation state.”

In other words, with the method for producing the electrolytic solution of the present invention, via the first electrolytic solution encompassing a conventional metal salt concentration and being in a thermodynamically stable liquid state, and via the second electrolytic solution in a thermodynamically unstable liquid state, the third electrolytic solution, i.e., the electrolytic solution of the present invention, in a thermodynamically stable new liquid state is obtained.

Since the third electrolytic solution in the stable liquid state maintains its liquid state at an ordinary condition, in the third electrolytic solution, for example, a cluster, formed of 2 molecules of the organic solvent with respect to 1 molecule of a lithium salt and stabilized by a strong coordinate bond between these molecules, is estimated to be inhibiting crystallization of the lithium salt.

The first dissolution step is a step of preparing the first electrolytic solution by mixing the organic solvent having a heteroatom with the metal salt to dissolve the metal salt.

For the purpose of mixing the organic solvent having a heteroatom with the metal salt, the metal salt may be added with respect to the organic solvent having a heteroatom, or the organic solvent having a heteroatom may be added with respect to the metal salt.

The first dissolution step is preferably performed under stirring and/or heating conditions. The stirring speed may be set suitably. The heating condition is preferably controlled suitably using a temperature controlled bath such as a water bath or an oil bath. Since dissolution heat is generated when dissolving the metal salt, the temperature condition is preferably strictly controlled when a metal salt that is unstable against heat is to be used. In addition, the organic solvent may be cooled in advance, or the first dissolution step may be performed under a cooling condition.

The first dissolution step and the second dissolution step may be performed continuously, or the first electrolytic solution obtained from the first dissolution step may be temporarily kept (left still), and the second dissolution step may be performed after a certain period of time has elapsed.

The second dissolution step is a step of preparing the second electrolytic solution in the supersaturation state by adding the metal salt to the first electrolytic solution under stirring and/or heating conditions to dissolve the metal salt.

Performing the second dissolution step under the stirring and/or heating conditions is essential for preparing the second electrolytic solution in the thermodynamically unstable supersaturation state. The stirring condition may be obtained by performing the second dissolution step in a stirring device accompanied with a stirrer such as a mixer, or the stirring condition may be obtained by performing the second dissolution step using a stirring bar and a device (stirrer) for moving the stirring bar. The heating condition is preferably controlled suitably using a temperature controlled bath such as a water bath or an oil bath. Needless to say, performing the second dissolution step using an apparatus or a system having both a stirring function and a heating function is particularly preferable. “Heating” described here refers to warming an object to a temperature not lower than an ordinary temperature (25° C.). The heating temperature is more preferably not lower than 30° C. and further preferably not lower than 35° C. In addition, the heating temperature is preferably a temperature lower than the boiling point of the organic solvent.

In the second dissolution step, when the added metal salt does not dissolve sufficiently, increasing the stirring speed and/or further heating are performed. In this case, a small amount of the organic solvent having a heteroatom may be added to the electrolytic solution in the second dissolution step.

Since temporarily leaving still the second electrolytic solution obtained in the second dissolution step causes deposition of crystal of the metal salt, the second dissolution step and the third dissolution step are preferably performed continuously.

The third dissolution step is a step of preparing the third electrolytic solution by adding the metal salt to the second electrolytic solution under stirring and/or heating conditions to dissolve the metal salt. In the third dissolution step, since adding and dissolving the metal salt in the second electrolytic solution in the supersaturation state are necessary, performing the step under stirring and/or heating conditions similarly to the second dissolution step is essential. Specific stirring and/or heating conditions are similar to the conditions for the second dissolution step.

When the mole ratio of the organic solvent and the metal salt added throughout the first dissolution step, the second dissolution step, and the third dissolution step reaches roughly about 2:1, production of the third electrolytic solution (the electrolytic solution of the present invention) ends. A metal salt crystal is not deposited from the electrolytic solution of the present invention even when the stirring and/or heating conditions are discontinued. Based on these circumstances, in the electrolytic solution of the present invention, for example, a cluster, formed of 2 molecules of the organic solvent with respect to 1 molecule of a lithium salt and stabilized by a strong coordinate bond between these molecules, is estimated to be formed.

When producing the electrolytic solution of the present invention, even without via the supersaturation state at processing temperatures of each of the dissolution steps, the electrolytic solution of the present invention is suitably produced using the specific dissolution means described in the first to third dissolution steps depending on the types of the metal salt and the organic solvent.

In addition, the method for producing the electrolytic solution of the present invention preferably includes a vibrational spectroscopy measurement step of performing vibrational spectroscopy measurement on the electrolytic solution that is being produced. As a specific vibrational spectroscopy measurement step, for example, a method in which a portion of each of the electrolytic solutions being produced is sampled to be subjected to vibrational spectroscopy measurement may be performed, or a method in which vibrational spectroscopy measurement is conducted on each of the electrolytic solutions in situ may be performed. Examples of the method of conducting the vibrational spectroscopy measurement on the electrolytic solution in situ include a method of introducing the electrolytic solution that is being produced in a transparent flow cell and conducting the vibrational spectroscopy measurement, and a method of using a transparent production container and conducting Raman measurement from outside the container.

Since the relationship between Is and Io in an electrolytic solution that is being produced is confirmed by including the vibrational spectroscopy measurement step in the method for producing the electrolytic solution of the present invention, whether or not an electrolytic solution that is being produced has reached the electrolytic solution of the present invention is determined, and, when an electrolytic solution that is being produced has not reached the electrolytic solution of the present invention, how much more of the metal salt is to be added for reaching the electrolytic solution of the present invention is understood.

To the electrolytic solution of the present invention, other than the organic solvent having the heteroelement, a solvent that has a low polarity (low permittivity) or a low donor number and that does not display particular interaction with the metal salt, i.e., a solvent that does not affect formation and maintenance of the cluster in the electrolytic solution of the present invention, may be added. Adding such a solvent to the electrolytic solution of the present invention is expected to provide an effect of lowering the viscosity of the electrolytic solution while maintaining the formation of the cluster in the electrolytic solution of the present invention.

Specific examples of the solvent that does not display particular interaction with the metal salt include benzene, toluene, ethylbenzene, o-xylene, m-xylene, p-xylene, 1-methylnaphthalene, hexane, heptane, and cyclohexane.

In addition, to the electrolytic solution of the present invention, a fire-resistant solvent other than the organic solvent having the heteroelement may be added. By adding the fire-resistant solvent to the electrolytic solution of the present invention, safety of the electrolytic solution of the present invention is further enhanced. Examples of the fire-resistant solvent include halogen based solvents such as carbon tetrachloride, tetrachloroethane, and hydrofluoroether, and phosphoric acid derivatives such as trimethyl phosphate and triethyl phosphate.

Furthermore, when the electrolytic solution of the present invention is mixed with a polymer or an inorganic filler to form a mixture, the mixture enables containment of the electrolytic solution to provide a pseudo solid electrolyte. By using the pseudo solid electrolyte as an electrolytic solution of a battery, leakage of the electrolytic solution is suppressed in the battery.

As the polymer, a polymer used in nonaqueous electrolyte secondary batteries such as lithium ion secondary batteries and general chemically cross-linked polymer are used. In particular, a polymer capable of turning into a gel by absorbing an electrolytic solution, such as polyvinylidene fluoride and polyhexafluoropropylene, and one obtained by introducing an ion conductive group to a polymer such as polyethylene oxide are suitable.

Specific examples of the polymer include polymethyl acrylate, polymethyl methacrylate, polyethylene oxide, polypropylene oxide, polyacrylonitrile, polyvinylidene fluoride, polyethylene glycol dimethacrylate, polyethylene glycol acrylate, polyglycidol, polytetrafluoroethylene, polyhexafluoropropylene, polysiloxane, polyvinyl acetate, polyvinyl alcohol, polyacrylic acid, polymethacrylic acid, polyitaconic acid, polyfumaric acid, polycrotonic acid, polyangelic acid, polycarboxylic acid such as carboxymethyl cellulose, styrene-butadiene rubbers, nitrile-butadiene rubbers, polystyrene, polycarbonate, unsaturated polyester obtained through copolymerization of maleic anhydride and glycols, polyethylene oxide derivatives having a substituent group, and a copolymer of vinylidene fluoride and hexafluoropropylene. In addition, as the polymer, a copolymer obtained through copolymerization of two or more types of monomers forming the above described specific polymers may be selected.

Polysaccharides are also suitable as the polymer. Specific examples of the polysaccharides include glycogen, cellulose, chitin, agarose, carrageenan, heparin, hyaluronic acid, pectin, amylopectin, xyloglucan, and amylose. In addition, materials containing these polysaccharides may be used as the polymer, and examples of the materials include agar containing polysaccharides such as agarose.

As the inorganic filler, inorganic ceramics such as oxides and nitrides are preferable.

Inorganic ceramics have hydrophilic and hydrophobic functional groups on their surfaces. Thus, a conductive passage may form within the inorganic ceramics when the functional groups attract the electrolytic solution. Furthermore, the inorganic ceramics dispersed in the electrolytic solution form a network among the inorganic ceramics themselves due to the functional groups, and may serve as containment of the electrolytic solution. With such a function by the inorganic ceramics, leakage of the electrolytic solution in the battery is further suitably suppressed. In order to have the inorganic ceramics suitably exert the function described above, the inorganic ceramics having a particle shape are preferable, and those whose particle sizes are nano level are particularly preferable.

Examples of the types of the inorganic ceramics include common alumina, silica, titania, zirconia, and lithium phosphate. In addition, inorganic ceramics that have lithium conductivity themselves are preferable, and specific examples thereof include Li₃N, LiI, LiI—Li₃N—LiOH, LiI—Li₂S—P₂O₅, LiI—Li₂S—P₂S₅, LiI—Li₂S—B₂S₃, Li₂O—B₂S₃, Li₂O—V₂O₃—SiO₂, Li₂O—B₂O₃—P₂O₅, Li₂O—B₂O₃—ZnO, Li₂O—Al₂O₃—TiO₂—SiO₂—P₂O₅, LiTi₂(PO₄)₃, Li-βAl₂O₃, and LiTaO₃.

Glass ceramics may be used as the inorganic filler. Since glass ceramics enables containment of ionic liquids, the same effect is expected for the electrolytic solution of the present invention. Examples of the glass ceramics include compounds represented by xLi₂S-(1-x)P₂S₅, and those in which one portion of S in the compound is substituted with another element and those in which one portion of P in the compound is substituted with germanium.

A density d (g/cm³) of the electrolytic solution of the present invention preferably satisfies d≥1.2 or d≤2.2, and is more preferably within a range of 1.2≤d≤2.2, even more preferably within a range of 1.24≤d≤2.0, further preferably within a range of 1.26≤d≤1.8, and particularly preferably within a range of 1.27≤d≤1.6. The density d (g/cm³) of the electrolytic solution of the present invention refers to the density at 20° C. “d/c” described in the following is a value obtained by dividing “d” described above by a salt concentration c (mol/L).

In the electrolytic solution of the present invention, d/c is within a range of 0.15≤d/c≤0.71, preferably within a range of 0.15≤d/c≤0.56, more preferably within a range of 0.25≤d/c≤0.56, further preferably within a range of 0.26≤d/c≤0.50, and particularly preferably within a range of 0.27≤d/c≤0.47.

“d/c” of the electrolytic solution of the present invention is defined also when the metal salt and the organic solvent are specified. For example, when LiTFSA and DME are respectively selected as the metal salt and the organic solvent, d/c is preferably within a range of 0.42≤d/c≤0.56 and more preferably within a range of 0.44≤d/c≤0.52. When LiTFSA and AN are respectively selected as the metal salt and the organic solvent, d/c is preferably within a range of 0.35≤d/c≤0.41 and more preferably within a range of 0.36≤d/c≤0.39. When LiFSA and DME are respectively selected as the metal salt and the organic solvent, d/c is preferably within a range of 0.32≤d/c≤0.46 and more preferably within a range of 0.34≤d/c≤0.42. When LiFSA and AN are respectively selected as the metal salt and the organic solvent, d/c is preferably within a range of 0.25≤d/c≤0.48, more preferably within a range of 0.25≤d/c≤0.38, further preferably within a range of 0.25≤d/c≤0.31, and even further preferably within a range of 0.26≤d/c≤0.29. When LiFSA and DMC are respectively selected as the metal salt and the organic solvent, d/c is preferably within a range of 0.32≤d/c≤0.46 and more preferably within a range of 0.34≤d/c≤0.42. When LiFSA and EMC are respectively selected as the metal salt and the organic solvent, d/c is preferably within a range of 0.34≤d/c≤0.50 and more preferably within a range of 0.37≤d/c≤0.45. When LiFSA and DEC are respectively selected as the metal salt and the organic solvent, d/c is preferably within a range of 0.36≤d/c≤0.54 and more preferably within a range of 0.39≤d/c≤0.48.

Since the electrolytic solution of the present invention has the metal salt and the organic solvent exist in a different environment and has a high density when compared to the conventional electrolytic solution; improvement in a metal ion transportation rate in the electrolytic solution (particularly improvement of lithium transference number when the metal is lithium), improvement in reaction rate between an electrode and an electrolytic solution interface, mitigation of uneven distribution of salt concentration in the electrolytic solution caused when a battery undergoes high-rate charge and discharge, and increase in the capacity of an electrical double layer are expected. In the electrolytic solution of the present invention, since the density is high, the vapor pressure of the organic solvent contained in the electrolytic solution becomes low. As a result, volatilization of the organic solvent from the electrolytic solution of the present invention is reduced.

The viscosity of the electrolytic solution of the present invention described above is high compared to the viscosity of a conventional electrolytic solution. Thus, even if the nonaqueous electrolyte secondary battery of the present invention using the electrolytic solution of the present invention is damaged, leakage of the electrolytic solution is suppressed. Furthermore, a nonaqueous electrolyte secondary battery using the conventional electrolytic solution has displayed a significant decrease in capacity when subjected to high-speed charging/discharging cycles. One conceivable reason thereof is the inability of the electrolytic solution to supply sufficient amount of Li to a reaction interface with an electrode because of Li concentration unevenness generated in the electrolytic solution when charging and discharging are repeated rapidly, i.e., uneven distribution of Li concentration in the electrolytic solution. However, the metal concentration of the electrolytic solution of the present invention is higher than that of a conventional electrolytic solution. For example, a preferable Li concentration for the electrolytic solution of the present invention is about 2 to 5 times of the Li concentration of a general electrolytic solution. Thus, in the electrolytic solution of the present invention containing Li at a high concentration, uneven distribution of Li is thought to be reduced. As a result, decrease in capacity during high-speed charging/discharging cycles is thought to be suppressed. In addition, another conceivable reason for the suppression of decrease in capacity when undergoing high-rate charging and discharging cycles is, because of the electrolytic solution of the present invention having a high viscosity, improvement in liquid retaining property of the electrolytic solution at an electrode interface, resulting in suppression of a state of lacking the electrolytic solution at the electrode interface (i.e., liquid run-out state).

Regarding a viscosity η (mPa·s) of the electrolytic solution of the present invention, a range of 10<η<500 is preferable, a range of 12<η<400 is more preferable, a range of 15<η<300 is further preferable, a range of 18<η<150 is particularly preferable, and a range of 20<η<140 is most preferable.

In addition, ions can move within an electrolytic solution easier when an ionic conductivity σ (mS/cm) of the electrolytic solution is higher. Thus, such an electrolytic solution is an excellent electrolytic solution for batteries. The ionic conductivity σ (mS/cm) of the electrolytic solution of the present invention preferably satisfies 1≤σ. Regarding the ionic conductivity σ (mS/cm) of the electrolytic solution in the nonaqueous electrolyte secondary battery of the present invention, if a suitable range including an upper limit is to be shown, a range of 2<σ<200 is preferable, a range of 3<σ<100 is more preferable, a range of 4<σ<50 is further preferable, and a range of 5<σ<35 is particularly preferable.

An S,O-containing coating is formed on the surfaces of the negative electrode and/or the positive electrode of the nonaqueous electrolyte secondary battery (1) of the present invention. In most cases, the S,O-containing coating is also formed on the surfaces of the negative electrode and/or the positive electrode of the nonaqueous electrolyte secondary battery (2). As described later, the coating includes S and O, and at least has an S═O structure. Since having the S═O structure, the S,O-containing coating is thought to be derived from the electrolytic solution. In the electrolytic solution of the present invention, a Li cation and an anion are thought to exist closer when compared to an ordinary electrolytic solution. Thus, the anion is preferentially reduced and degraded because of being strongly subjected to the electrostatic influence of the Li cation. In a general nonaqueous electrolyte secondary battery using a general electrolytic solution, an organic solvent (e.g., EC: ethylene carbonate, etc.) contained in the electrolytic solution is reduced and degraded, and an SEI coating is formed from a degradation product of the organic solvent. However, in the nonaqueous electrolyte secondary battery of the present invention containing the electrolytic solution of the present invention, the anion is preferentially reduced and degraded. As a result, an SEI coating, i.e., S,O-containing coating, in the nonaqueous electrolyte secondary battery of the present invention is thought to contain a large degree of the S═O structure derived from the anion. In other words, in an ordinary nonaqueous electrolyte secondary battery using an ordinary electrolytic solution, an SEI coating derived from the degradation product of the organic solvent such as EC is fixed on the surface of the electrodes. On the other hand, in the nonaqueous electrolyte secondary battery of the present invention using the electrolytic solution of the present invention, an SEI coating derived mainly from the anion of the metal salt is fixed on the surface of the electrodes.

In addition, although the reason is not certain, the state of the S,O-containing coating in the nonaqueous electrolyte secondary battery of the present invention changes associated with charging and discharging. For example, as described later, the thickness of the S,O-containing coating and the proportion of elements such as S and O sometimes change depending on the state of charging and discharging. Thus, in the S,O-containing coating in the nonaqueous electrolyte secondary battery of the present invention, a portion (hereinafter, referred to as a fixed portion if necessary) that is derived from the degradation product of the anion described above and is fixed in the coating, and a portion (hereinafter, referred to as adsorption portion if necessary) that becomes larger or smaller reversibly associated with charging and discharging are thought to exist. Similarly to the fixed portion, the adsorption portion is speculated to have a structure such as S═O derived from the anion of the metal salt.

Since the S,O-containing coating is thought to be formed from the degradation product of the electrolytic solution and to include other absorbates, a large portion (or all) of the S,O-containing coating is thought to be produced during and after the first charging and discharging of the nonaqueous electrolyte secondary battery. Thus, the nonaqueous electrolyte secondary battery of the present invention has the S,O-containing coating on the surface of the negative electrode and/or the surface of the positive electrode when being used. Other components of the S,O-containing coating differ variously depending on such as the composition of the negative electrode and components other than sulfur and oxygen contained in the electrolytic solution. In addition, the content ratio of the S,O-containing coating is not particularly limited as long as the S,O-containing coating includes the S═O structure. Furthermore, components other than those of the S═O structure and the amount thereof included in the S,O-containing coating are not particularly limited. The S,O-containing coating may be formed only on the surface of the negative electrode or may be formed only on the surface of the positive electrode. However, as described above, since the S,O-containing coating is thought to be derived from the anion of the metal salt contained in the electrolytic solution of the present invention, components derived from the anion of the metal salt is preferably contained in an amount more than other components. In addition, the S,O-containing coating is preferably formed on both the surface of the negative electrode and the surface of the positive electrode. Hereinafter, if necessary, an S,O-containing coating formed on the surface of the negative electrode is referred to as a negative-electrode S,O-containing coating, and an S,O-containing coating formed on the surface of the positive electrode is referred to as a positive-electrode S,O-containing coating.

As described above, an imide salt is preferably used as the metal salt in the electrolytic solution of the present invention. A technology of adding an imide salt to an electrolytic solution has been known conventionally, and, in a nonaqueous electrolyte secondary battery using this type of electrolytic solution, a coating on the positive electrode and/or the negative electrode is known to include a compound derived from the imide salt, i.e., a compound including S, in addition to compounds derived from a degradation product of the organic solvent of the electrolytic solution. For example, in JP2013145732 (A), an imide salt derived component contained in one part of the coating is described as to be able to suppress an increase in internal resistance of the nonaqueous electrolyte secondary battery while improving durability of the nonaqueous electrolyte secondary battery.

However, in the conventional art described above, the imide salt derived component cannot be increased in concentration in the coating because of the following reasons. First, when graphite is used as the negative electrode active material, formation of the SEI coating on the surface of the negative electrode is thought to be necessary in order to enable graphite to reversibly react with a charge carrier for reversible charging and discharging of the nonaqueous electrolyte secondary battery. Conventionally, in order to form the SEI coating, a cyclic carbonate compound represented by EC has been used as an organic solvent for the electrolytic solution. The SEI coating was formed from a degradation product of the cyclic carbonate compound. In other words, a conventional electrolytic solution containing the imide salt contained the imide salt as an additive, in addition to containing a large amount of a cyclic carbonate such as EC as the organic solvent. However, in this case, the main component of the SEI coating is a component derived from the organic solvent, and increasing the contained amount of the imide salt in the SEI coating has been difficult.

Furthermore, when the imide salt is to be used not as an additive but as a metal salt (i.e., electrolyte salt, supporting salt), consideration of the combination with a current collector for the positive electrode had been necessary. More specifically, the imide salt is known to corrode an aluminum current collector that is used commonly as a current collector for the positive electrode. Thus, particularly when a positive electrode that operates at a potential of about 4 V is used, an electrolytic solution using, as an electrolyte salt, LiPF₆ or the like that forms a passive state together with aluminum needs to coexist with the aluminum current collector. In addition, in a conventional electrolytic solution, the total concentration of electrolyte salts including LiPF₆ and the imide salt, etc., is considered to be optimum at about 1 mol/L to 2 mol/L from a standpoint of ionic conductivity and viscosity (JP2013145732 (A)). Accordingly, when LiPF₆ is added at a sufficient amount, the added amount of the imide salt is inevitably reduced. Thus, a problem has existed regarding the difficultly in using the imide salt in a large amount as the metal salt for the electrolytic solution. Hereinafter, the imide salt may be sometimes abbreviated simply as a metal salt if necessary.

On the other hand, the electrolytic solution of the present invention contains the metal salt at a high concentration. As described later, in the electrolytic solution of the present invention, the metal salt is thought to exist in a state completely different from that of a conventional one. Thus, in the electrolytic solution of the present invention, unlike a conventional electrolytic solution, the problem derived from containing the metal salt at a high concentration is not likely to occur. For example, with the electrolytic solution of the present invention, deterioration in input-output performance of the nonaqueous electrolyte secondary battery due to increase in viscosity of the electrolytic solution is suppressed, and corrosion of the aluminum current collector is also suppressed. In addition, the metal salt contained in the electrolytic solution at a high concentration is preferentially reduced and degraded on the negative electrode. As a result, even without using a cyclic carbonate compound such as EC as the organic solvent, an SEI coating having a special structure derived from the metal salt, i.e., the S,O-containing coating, is formed on the negative electrode. Thus, the nonaqueous electrolyte secondary battery of the present invention undergoes reversible charging and discharging even when graphite is used as the negative electrode active material, without using a cyclic carbonate compound as the organic solvent.

Thus, the nonaqueous electrolyte secondary battery of the present invention undergoes reversible charging and discharging even when graphite is used as the negative electrode active material and the aluminum current collector is used as the positive electrode current collector, without using a cyclic carbonate compound as an organic solvent or using LiPF₆ as the metal salt. In addition, a large portion of the SEI coating on the surface of the negative electrode and/or the positive electrode is formed from components derived from the anion. As described later, the S,O-containing coating containing the components derived from the anion improves battery characteristics of the nonaqueous electrolyte secondary battery.

In a nonaqueous electrolyte secondary battery using a general electrolytic solution containing an EC solvent, the coating of the negative electrode largely includes a polymer structure resulting from polymerization of carbon derived from the EC solvent. On the other hand, in the nonaqueous electrolyte secondary battery of the present invention, the negative-electrode S,O-containing coating almost (or completely) does not include the polymer structure resulting from polymerization of carbon, and largely includes a structure derived from the anion of the metal salt. The same also applies for the positive-electrode coating.

The electrolytic solution of the present invention contains a cation of the metal salt at a high concentration. Thus, the distance between adjacent cations is extremely small within the electrolytic solution of the present invention. When a cation such as a lithium ion moves between a positive electrode and a negative electrode during charging and discharging of the nonaqueous electrolyte secondary battery, a cation located most closely to an electrode that is a movement destination is firstly supplied to the electrode. Then, to the place where the supplied cation had been located, another cation adjacent to the cation moves. Thus, in the electrolytic solution of the present invention, a domino toppling-like phenomenon is predicted to be occurring in which adjacent cations sequentially change their positions one by one toward an electrode that is a supply target. Because of that, the distance for which a cation moves during charging and discharging is thought to be short, and movement speed of the cation is thought to be high, accordingly. Because of this reason, the nonaqueous electrolyte secondary battery of the present invention having the electrolytic solution of the present invention is thought to have a high reaction rate. In addition, the nonaqueous electrolyte secondary battery of the present invention includes an S,O-containing coating on the electrode (i.e., the negative electrode and/or the positive electrode), and the S,O-containing coating is thought to largely include a cation in addition to including the S═O structure. The cation included in the S,O-containing coating is thought to be preferentially supplied to the electrode. Thus, in the nonaqueous electrolyte secondary battery of the present invention, transportation rate of the cation is thought to be further improved because of having an abundant source of cation (i.e., the S,O-containing coating) in the vicinity of the electrode. As a result, in the nonaqueous electrolyte secondary battery of the present invention, excellent battery characteristics are thought to be exerted because of a cooperation between the electrolytic solution of the present invention and the S,O-containing coating.

For reference, the SEI coating of the negative electrode is thought to be formed from deposits of the electrolytic solution generated when the electrolytic solution is reduced and degraded at a predetermined voltage or lower. Thus, in order to efficiently generate the S,O-containing coating on the surface of the negative electrode, the minimum value of the potential of the negative electrode in the nonaqueous electrolyte secondary battery of the present invention is preferably equal to or lower than the predetermined voltage. Specifically, when lithium is used as the counter electrode, the nonaqueous electrolyte secondary battery of the present invention is suitable as a battery used at a condition that causes the minimum value of the potential of the negative electrode to be equal to or lower than 1.3 V.

The negative electrode in the nonaqueous electrolyte secondary battery of the present invention is not particularly limited. As the negative electrode active material, a general negative electrode active material capable of occluding and releasing charge carriers is usable. For example, when the nonaqueous electrolyte secondary battery is a lithium ion secondary battery, a material capable of occluding and releasing lithium ions may be selected as the negative electrode active material. In more detail, an element (elemental substance) capable of forming an alloy with a charge carrier such as Li, an alloy including the element, or a compound including the element may be used. Specifically, respective elemental substances of Li, group 14 elements such as carbon, silicon, germanium, and tin, group 13 elements such as aluminum and indium, group 12 elements such as zinc and cadmium, group 15 elements such as antimony and bismuth, alkaline earth metals such as magnesium and calcium, and group 11 elements such as silver and gold may be used as the negative electrode active material. When silicon or the like is used as the negative electrode active material, a high capacity active material is obtained since a single silicon atom reacts with multiple lithium atoms. However, a fear of occurrence of a problem exists regarding a significant expansion and contraction of volume associated with occlusion and release of lithium. Thus, in order to mitigate the fear, an alloy or a compound obtained by combining an elemental substance of silicon or the like with another element such as a transition metal is also suitably used as the negative electrode active material. Specific examples of the alloy or the compound include tin based materials such as Ag—Sn alloys, Cu—Sn alloys, and Co—Sn alloys, carbon based materials such as various graphites, silicon based materials such as SiOₓ (0.3≤x≤1.6) that undergoes disproportionation into the elemental substance silicon and silicon dioxide, and a complex obtained by combining a carbon based material with elemental substance silicon or a silicon based material. In addition, as the negative electrode active material, an oxide such as Nb₂O₅, TiO₂, Li₄Ti₅O₁₂, WO₂, MoO₂, and Fe₂O₃, or a nitride represented by Li₃₋ₓMₓN (M=Co, Ni, Cu) may be used. With regard to the negative electrode active material, one or more types described above may be used.

As described above, the nonaqueous electrolyte secondary battery (1) of the present invention has an S,O-containing coating formed on the surface of the negative electrode. Thus, a low potential negative electrode is usable. Specifically, in the nonaqueous electrolyte secondary battery (1), a negative electrode active material containing a carbon element such as graphite and a Si-based negative electrode active material may be selected as the negative electrode active material. Regarding the graphite, natural and artificial graphites may be used, and its particle size is not particularly limited.

The nonaqueous electrolyte secondary battery of the present invention includes a negative electrode having a negative electrode active material capable of occluding and releasing a charge carrier such as lithium ions, a positive electrode including a positive electrode active material capable of occluding and releasing the charge carrier, and the electrolytic solution of the present invention. For example, when the nonaqueous electrolyte secondary battery of the present invention is a lithium ion secondary battery, the negative electrode active material is one that is capable of occluding and releasing lithium ions, and the positive electrode active material is one that is capable of occluding and releasing lithium ions, and the electrolytic solution uses a lithium salt as the metal salt.

The negative electrode includes a current collector, and a negative electrode active material layer bound to the surface of the current collector. The negative electrode active material has been previously described.

The current collector refers to a fine electron conductor that is chemically inert for continuously sending a flow of current to the electrode during discharging or charging of the nonaqueous electrolyte secondary battery. Examples of the current collector for negative electrodes include at least one selected from silver, copper, gold, aluminum, tungsten, cobalt, zinc, nickel, iron, platinum, tin, indium, titanium, ruthenium, tantalum, chromium, or molybdenum, and metal materials such as stainless steel. The current collector may be coated with a protective layer known in the art. One obtained by treating the surface of the current collector with a method known in the art may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, its thickness is preferably within a range of 1 μm to 100 μm.

The negative electrode active material layer includes a negative electrode active material, and, if necessary, a binding agent and/or a conductive additive. The nonaqueous electrolyte secondary battery (2) uses a specific binding agent.

The binding agent serves a role of fastening negative electrode active material particle to each other, or the negative electrode active material and the conductive additive to the surface of the current collector. The nonaqueous electrolyte secondary battery (2) contains, as the binding agent, a polymer having a hydrophilic group. Examples of the hydrophilic group of the polymer having the hydrophilic group include carboxyl group, sulfo group, silanol group, amino group, hydroxyl group, amino group, and phosphoric acid based groups such as phosphoric acid group. Among those described above, a polymer including a carboxyl group in its molecule, such as polyacrylic acid (PAA), carboxymethyl cellulose (CMC), and polymethacrylic acid, and a polymer including a sulfo group such as poly(p-styrenesulfonic acid) are preferable.

A polymer including a large number of carboxyl groups and/or sulfo groups, such as polyacrylic acid or a copolymer of acrylic acid and vinylsulfonic acid, is water soluble. Thus, the polymer having the hydrophilic group is preferably a water-soluble polymer, and is preferably a polymer including multiple carboxyl groups and/or sulfo groups in a single molecule thereof.

A polymer including a carboxyl group in a molecule thereof is produced through a method such as, for example, polymerizing an acid monomer such as polyacrylic acid, or imparting a carboxyl group to a polymer such as carboxymethyl cellulose (CMC). Examples of the acid monomer include acid monomers having one carboxyl group in respective molecules such as acrylic acid, methacrylic acid, vinylbenzoic acid, crotonic acid, pentenoic acid, angelic acid, and tiglic acid, and acid monomers having two or more carboxyl groups in respective molecules such as itaconic acid, mesaconic acid, citraconic acid, fumaric acid, maleic acid, 2-pentenedioic acid, methylenesuccinic acid, allylmalonic acid, isopropylidene succinic acid, 2,4-hexadienedioic acid, and acetylene dicarboxylic acid. A copolymer obtained through polymerization of two or more types of monomers selected from those described above may be used.

For example, as disclosed in JP2013065493 (A), a polymer that is formed of a copolymer of acrylic acid and itaconic acid and that includes, in its molecule, an acid anhydride group formed through condensation of carboxyl groups is preferably used as the binding agent. As a result of having a structure derived from a monomer with high acidity by having two or more carboxyl groups in a single molecule thereof, lithium ions and the like are thought to be easily trapped before a degradative reaction of the electrolytic solution occurs during charging. Furthermore, the acidity does not rise excessively since, as the acidity rises when more carboxyl groups exist compared to polyacrylic acid and polymethacrylic acid, a certain amount of the carboxyl groups change into acid anhydride groups. Thus, a secondary battery having a negative electrode formed using the negative electrode binding agent has improved initial efficiency and input-output characteristics.

As long as the performance is not compromised, polymers such as fluorine-containing resins such as polyvinylidene fluoride, polytetrafluoroethylene, and fluororubbers, thermoplastic resins such as polypropylene and polyethylene, imide based resins such as polyimide and polyamide-imide, and alkoxysilyl group-containing resins may be added.

The blending ratio of the binding agent in the negative electrode active material layer in mass ratio is preferably negative electrode active material:binding agent=1:0.005 to 1:0.3. The reason is that when too little of the binding agent is contained, moldability of the electrode deteriorates, whereas when too much of the binding agent is contained, energy density of the electrode becomes low.

The binding agent of the nonaqueous electrolyte secondary battery (1) may be the binding agent described above, or may be another binding agent. Examples of the binding agent include fluorine-containing resins such as polyvinylidene fluoride, polytetrafluoroethylene, and fluororubbers, thermoplastic resins such as polypropylene and polyethylene, imide based resins such as polyimide and polyamide-imide, and alkoxysilyl group-containing resins.

In any of the cases, the blending ratio of the binding agent in the negative electrode active material layer in mass ratio is preferably negative electrode active material:binding agent=1:0.005 to 1:0.3. The reason is that when too little of the binding agent is contained, moldability of the electrode deteriorates, whereas when too much of the binding agent is contained, energy density of the electrode becomes low.

The conductive additive is added for increasing conductivity of the electrode. Thus, the conductive additive is preferably added optionally when conductivity of an electrode is insufficient, and does not have to be added when conductivity of an electrode is sufficiently superior. As the conductive additive, a fine electron conductor that is chemically inert may be used, and examples thereof include carbonaceous fine particles such as carbon black, graphite, acetylene black, Ketchen black (Registered Trademark), and vapor grown carbon fiber (VGCF), and various metal particles. With regard to the conductive additive described above, a single type by itself, or a combination of two or more types may be added to the active material layer. The blending ratio of the conductive additive in the negative electrode active material layer in mass ratio is preferably negative electrode active material:conductive additive=1:0.01 to 1:0.5. The reason is that when too little of the conductive additive is contained, efficient conducting paths cannot be formed, whereas when too much of the conductive additive is contained, moldability of the negative electrode active material layer deteriorates and energy density of the electrode becomes low.

The negative electrode of the nonaqueous electrolyte secondary battery may be produced using the binding agent by: applying, on the current collector using a method such as roll coating method, dip coating method, doctor blade method, spray coating method, and curtain coating method, a slurry obtained through adding and mixing the negative electrode active material powder, the conductive additive such as a carbon powder, the binding agent, and a proper amount of a solvent; and drying or curing the binding agent. Examples of the solvent include N-methyl-2-pyrrolidone, methanol, methyl isobutyl ketone, and water. In order to increase electrode density, compression may be performed after drying.

[Positive Electrode]

The positive electrode used in the nonaqueous electrolyte secondary battery includes the positive electrode active material capable of occluding and releasing a charge carrier such as lithium ions. The positive electrode includes the current collector and the positive electrode active material layer bound to the surface of the current collector. The positive electrode active material layer includes the positive electrode active material, and, if necessary, the binding agent and/or the conductive additive. The current collector of the positive electrode is not particularly limited as long as the current collector is a metal capable of withstanding a voltage suited for the active material that is used. Examples of the current collector include at least one type selected from silver, copper, gold, aluminum, tungsten, cobalt, zinc, nickel, iron, platinum, tin, indium, titanium, ruthenium, tantalum, chromium, or molybdenum, and metallic materials such as stainless steel.

When the potential of the positive electrode is set not lower than 4 V using lithium as reference, aluminum is preferably used as the current collector.

Specifically, one formed from aluminum or an aluminum alloy is preferably used as the positive electrode current collector. Here, aluminum refers to pure aluminum, and an aluminum whose purity is equal to or higher than 99.0% is referred to as pure aluminum. An alloy obtained by adding various elements to pure aluminum is referred to as an aluminum alloy. Examples of the aluminum alloy include those that are Al—Cu based, Al—Mn based, Al—Fe based, Al—Si based, Al—Mg based, AL-Mg—Si based, and Al—Zn—Mg based.

In addition, specific examples of aluminum or the aluminum alloy include A1000 series alloys (pure aluminum based) such as JIS A1085, AlN30, etc., A3000 series alloys (Al—Mn based) such as JIS A3003, A3004, etc., and A8000 series alloys (Al—Fe based) such as JIS A8079, A8021, etc. The current collector may be coated with a protective layer known in the art. One obtained by treating the surface of the current collector with a method known in the art may be used as the current collector.

The current collector takes forms such as a foil, a sheet, a film, a line shape, a bar shape, and a mesh. Thus, as the current collector, for example, metal foils such as copper foil, nickel foil, aluminum foil, and stainless steel foil are suitably used. When the current collector is in the form of a foil, a sheet, or a film, its thickness is preferably within a range of 1 μm to 100 μm. The same applies also for the above described current collector for negative electrodes.

The binding agent and the conductive additive of the positive electrode are similar to those described in relation to the negative electrode.

Examples of the positive electrode active material include layer compounds that are LiₐNi_{b}Co_{c}Mn_{d}DₑO_{f} (0.2≤a≤1.2; b+c+d+e=1; 0≤e≤1; D is at least one element selected from Li, Fe, Cr, Cu, Zn, Ca, Mg, S, Si, Na, K, Al, Zr, Ti, P, Ga, Ge, V, Mo, Nb, W, or La; 1.7≤f≤2.1) and Li₂MnO₃. Additional examples of the positive electrode active material include spinel such as LiMn₂O₄, a solid solution formed from a mixture of spinel and a layer compound, and polyanion based compound such as LiMPO₄, LiMVO₄, or Li₂MSiO₄ (wherein, “M” is selected from at least one of Co, Ni, Mn, or Fe). Further additional examples of the positive electrode active material include tavorite based compounds represented by LiMPO₄F (“M” is a transition metal) such as LiFePO₄F and borate based compounds represented by LiMBO₃ (“M” is a transition metal) such as LiFeBO₃. Any metal oxide used as the positive electrode active material may have a basic composition of the composition formulae described above, and those in which a metal element included in the basic composition is substituted with another metal element may also be used. In addition, as the positive electrode active material, one that does not include a charge carrier (e.g., a lithium ion contributing to the charging and discharging) may also be used. For example, elemental substance sulfur (S), a compound that is a composite of sulfur and carbon, metal sulfides such as TiS₂, oxides such as V₂O₅ and MnO₂, polyaniline and anthraquinone and compounds including such aromatics in the chemical structure, conjugate based materials such as conjugate diacetic acid based organic matters, and other materials known in the art may also be used. Furthermore, a compound having a stable radical such as nitroxide, nitronyl nitroxide, galvinoxyl, and phenoxyl may be used as the positive electrode active material.

When a raw material for the positive electrode active material not containing a charge carrier such as lithium is to be used, a charge carrier has to be added in advance to the positive electrode and/or the negative electrode using a method known in the art. The charge carrier may be added in an ionic state, or may be added in a nonionic state such as a metal. For example, when the charge carrier is lithium, a lithium foil may be pasted to, and integrated with the positive electrode and/or the negative electrode. Similarly to the negative electrode, the positive electrode may also include a conductive additive, a binding agent, and the like. The conductive additive and the binding agent are not particularly limited as long as the conductive additive and the binding agent are usable in a nonaqueous electrolyte secondary battery, similarly to the negative electrode described above.

In order to form the active material layer on the surface of the current collector, the active material may be applied on the surface of the current collector using a conventional method known in the art such as roll coating method, die coating method, dip coating method, doctor blade method, spray coating method, and curtain coating method. Specifically, an active material layer forming composition (so-called negative electrode mixture material, positive electrode mixture material) including the active material and, if necessary, the binding agent and the conductive additive is prepared, and, after adding a suitable solvent to this composition to obtain a paste, the paste is applied on the surface of the current collector and then dried. Examples of the solvent include N-methyl-2-pyrrolidone, methanol, methyl isobutyl ketone, and water. In order to increase electrode density, compression may be performed after drying.

A separator is used in the nonaqueous electrolyte secondary battery, if necessary. The separator is for separating the positive electrode and the negative electrode to allow passage of lithium ions while preventing short circuiting of current due to a contact of both electrodes. Examples of the separator include porous materials, nonwoven fabrics, and woven fabrics using one or more types of materials having electrical insulation property such as: synthetic resins such as polytetrafluoroethylene, polypropylene, polyethylene, polyimide, polyamide, polyaramide (aromatic polyamide), polyester, and polyacrylonitrile; polysaccharides such as cellulose and amylose; natural polymers such as fibroin, keratin, lignin, and suberin; and ceramics. In addition, the separator may have a multilayer structure. Since the electrolytic solution of the present invention has a high polarity and a slightly high viscosity, a film easily impregnated with a polar solvent such as water is preferable. Specifically, a film in which 90% or more of gaps existing therein are impregnated with a polar solvent such as water is preferable.

An electrode assembly is formed from the positive electrode, the negative electrode, and, if necessary, the separator interposed therebetween. The electrode assembly may be a laminated type obtained by stacking the positive electrode, the separator, and the negative electrode, or a wound type obtained by winding the positive electrode, the separator, and the negative electrode. The nonaqueous electrolyte secondary battery is preferably formed by respectively connecting, using current collecting leads or the like, the positive electrode current collector to a positive electrode external connection terminal and the negative electrode current collector to a negative electrode external connection terminal, and adding the electrolytic solution of the present invention to the electrode assembly. In addition, the nonaqueous electrolyte secondary battery of the present invention preferably executes charging and discharging at a voltage range suitable for the types of active materials included in the electrodes.

The form of the nonaqueous electrolyte secondary battery of the present invention is not particularly limited, and various forms such as a cylindrical type, square type, a coin type, and a laminated type, etc., are used.

As described above, the nonaqueous electrolyte secondary battery of the present invention does not have any limits regarding the type of the charge carrier. Thus, the nonaqueous electrolyte secondary battery of the present invention may be, for example, a lithium ion secondary battery, or a lithium secondary battery. A charge carrier other than lithium (e.g., sodium) may also be used. The nonaqueous electrolyte secondary battery of the present invention may be mounted on a vehicle. The vehicle may be a vehicle that uses, as all or one portion of the source of power, electrical energy obtained from the nonaqueous electrolyte secondary battery, and examples thereof include electric vehicles and hybrid vehicles. When the nonaqueous electrolyte secondary battery is to be mounted on the vehicle, a plurality of the nonaqueous electrolyte secondary batteries may be connected in series to form an assembled battery. Other than the vehicles, examples of instruments on which the nonaqueous electrolyte secondary battery may be mounted include various home appliances, office instruments, and industrial instruments driven by a battery such as personal computers and portable communication devices. In addition, the nonaqueous electrolyte secondary battery of the present invention may be used as electrical storage devices and power smoothing devices for wind power generation, photovoltaic power generation, hydroelectric power generation, and other power systems, power supply sources for auxiliary machineries and/or power of ships, etc., power supply sources for auxiliary machineries and/or power of aircraft and spacecraft, etc., auxiliary power supply for vehicles that do not use electricity as a source of power, power supply for movable household robots, power supply for system backup, power supply for uninterruptible power supply devices, and electrical storage devices for temporarily storing power required for charging at charge stations for electric vehicles.

Although embodiments of the electrolytic solution of the present invention have been described above, the present invention is not limited to the embodiments. Without departing from the gist of the present invention, the present invention can be implemented in various modes with modifications and improvements, etc., that can be made by a person skilled in the art.

In the following, the present invention is described specifically by presenting Examples and Comparative Examples. The present invention is not limited to these Examples. Hereinafter, unless mentioned otherwise in particular, “part(s)” refers to part(s) by mass, and “%” refers to mass %.

[Electrolytic Solution]

(E1)

The electrolytic solution of the present invention was produced in the following manner.

Approximately 5 mL of 1,2-dimethoxyethane, which is an organic solvent, was placed in a flask including a stirring bar and a thermometer. Under a stirring condition, with respect to 1,2-dimethoxyethane in the flask, (CF₃SO₂)₂NLi, which is a lithium salt, was gradually added so as to maintain a solution temperature equal to or lower than 40° C. to be dissolved. Since dissolving of (CF₃SO₂)₂NLi momentarily stagnated at a time point when approximately 13 g of (CF₃SO₂)₂NLi was added, the flask was heated by placing the flask in a temperature controlled bath such that the solution temperature in the flask reaches 50° C. to dissolve (CF₃SO₂)₂NLi. Since dissolving of (CF₃SO₂)₂NLi stagnated again at a time point when approximately 15 g of (CF₃SO₂)₂NLi was added, a single drop of 1,2-dimethoxyethane was added thereto using a pipette to dissolve (CF₃SO₂)₂NLi. Furthermore, (CF₃SO₂)₂NLi was gradually added to accomplish adding an entire predetermined amount of (CF₃SO₂)₂NLi. The obtained electrolytic solution was transferred to a 20-mL measuring flask, and 1,2-dimethoxyethane was added thereto until a volume of 20 mL was obtained. This was used as electrolytic solution E1. The volume of the obtained electrolytic solution was 20 mL, and 18.38 g of (CF₃SO₂)₂NLi was contained in the electrolytic solution. The concentration of (CF₃SO₂)₂NLi in electrolytic solution E1 was 3.2 mol/L. In electrolytic solution E1, 1.6 molecules of 1,2-dimethoxyethane were contained with respect to 1 molecule of (CF₃SO₂)₂NLi.

The production was performed within a glovebox under an inert gas atmosphere.

(E2)

With a method similar to that of E1, electrolytic solution E2 whose concentration of (CF₃SO₂)₂NLi was 2.8 mol/L was produced using 16.08 g of (CF₃SO₂)₂NLi. In electrolytic solution E2, 2.1 molecules of 1,2-dimethoxyethane were contained with respect to 1 molecule of (CF₃SO₂)₂NLi.

(E3)

Approximately 5 mL of acetonitrile, which is an organic solvent, was placed in a flask including a stirring bar. Under a stirring condition, with respect to acetonitrile in the flask, (CF₃SO₂)₂NLi, which is a lithium salt, was gradually added to be dissolved. A total amount of 19.52 g of (CF₃SO₂)₂NLi was added to the flask, and stirring was performed overnight in the flask. The obtained electrolytic solution was transferred to a 20-mL measuring flask, and acetonitrile was added thereto until a volume of 20 mL was obtained. This was used as electrolytic solution E3. The production was performed within a glovebox under an inert gas atmosphere.

The concentration of (CF₃SO₂)₂NLi in electrolytic solution E3 was 3.4 mol/L. In electrolytic solution E3, 3 molecules of acetonitrile were contained with respect to 1 molecule of (CF₃SO₂)₂NLi.

(E4)

With a method similar to that of E3, electrolytic solution E4 whose concentration of (CF₃SO₂)₂NLi was 4.2 mol/L was produced using 24.11 g of (CF₃SO₂)₂NLi. In electrolytic solution E4, 1.9 molecules of acetonitrile were contained with respect to 1 molecule of (CF₃SO₂)₂NLi.

(E5)

With a method similar to that of E3 except for using 13.47 g of (FSO₂)₂NLi as the lithium salt and 1,2-dimethoxyethane as the organic solvent, electrolytic solution E5 whose concentration of (FSO₂)₂NLi was 3.6 mol/L was produced. In electrolytic solution E5, 1.9 molecules of 1,2-dimethoxyethane were contained with respect to 1 molecule of (FSO₂)₂NLi.

(E6)

With a method similar to that of E5, electrolytic solution E6 whose concentration of (FSO₂)₂NLi was 4.0 mol/L was produced using 14.97 g of (FSO₂)₂NLi. In electrolytic solution E6, 1.5 molecules of 1,2-dimethoxyethane were contained with respect to 1 molecule of (FSO₂)₂NLi.

(E7)

With a method similar to that of E3 except for using 15.72 g of (FSO₂)₂NLi as the lithium salt, electrolytic solution E7 whose concentration of (FSO₂)₂NLi was 4.2 mol/L was produced. In electrolytic solution E7, 3 molecules of acetonitrile were contained with respect to 1 molecule of (FSO₂)₂NLi.

(E8)

With a method similar to that of E7, electrolytic solution E8 whose concentration of (FSO₂)₂NLi was 4.5 mol/L was produced using 16.83 g of (FSO₂)₂NLi. In electrolytic solution E8, 2.4 molecules of acetonitrile were contained with respect to 1 molecule of (FSO₂)₂NLi.

(E9)

With a method similar to that of E7, electrolytic solution E9 whose concentration of (FSO₂)₂NLi was 5.0 mol/L was produced using 18.71 g of (FSO₂)₂NLi. In electrolytic solution E9, 2.1 molecules of acetonitrile were contained with respect to 1 molecule of (FSO₂)₂NLi.

(E10)

With a method similar to that of E7, electrolytic solution E10 whose concentration of (FSO₂)₂NLi was 5.4 mol/L was produced using 20.21 g of (FSO₂)₂NLi. In electrolytic solution E10, 2 molecules of acetonitrile were contained with respect to 1 molecule of (FSO₂)₂NLi.

(E11)

Approximately 5 mL of dimethyl carbonate, which is an organic solvent, was placed in a flask including a stirring bar. Under a stirring condition, with respect to dimethyl carbonate in the flask, (FSO₂)₂NLi, which is a lithium salt, was gradually added to be dissolved. A total amount of 14.64 g of (FSO₂)₂NLi was added to the flask, and stirring was performed overnight in the flask. The obtained electrolytic solution was transferred to a 20-mL measuring flask, and dimethyl carbonate was added thereto until a volume of 20 mL was obtained. This was used as electrolytic solution E11. The production was performed within a glovebox under an inert gas atmosphere.

The concentration of (FSO₂)₂NLi in electrolytic solution E11 was 3.9 mol/L. In electrolytic solution E11, 2 molecules of dimethyl carbonate were contained with respect to 1 molecule of (FSO₂)₂NLi.

(E12)

Electrolytic solution E12 whose concentration of (FSO₂)₂NLi was 3.4 mol/L was obtained by adding dimethyl carbonate to, and thereby diluting, electrolytic solution E11. In electrolytic solution E12, 2.5 molecules of dimethyl carbonate were contained with respect to 1 molecule of (FSO₂)₂NLi.

(E13)

Electrolytic solution E13 whose concentration of (FSO₂)₂NLi was 2.9 mol/L was obtained by adding dimethyl carbonate to, and thereby diluting, electrolytic solution E11. In electrolytic solution E13, 3 molecules of dimethyl carbonate were contained with respect to 1 molecule of (FSO₂)₂NLi.

(E14)

Electrolytic solution E14 whose concentration of (FSO₂)₂NLi was 2.6 mol/L was obtained by adding dimethyl carbonate to, and thereby diluting, electrolytic solution E11. In electrolytic solution E14, 3.5 molecules of dimethyl carbonate were contained with respect to 1 molecule of (FSO₂)₂NLi.

(E15)

Electrolytic solution E15 whose concentration of (FSO₂)₂NLi was 2.0 mol/L was obtained by adding dimethyl carbonate to, and thereby diluting, electrolytic solution E11. In electrolytic solution E15, 5 molecules of dimethyl carbonate were contained with respect to 1 molecule of (FSO₂)₂NLi.

(E16)

Approximately 5 mL of ethyl methyl carbonate, which is an organic solvent, was placed in a flask including a stirring bar. Under a stirring condition, with respect to ethyl methyl carbonate in the flask, (FSO₂)₂NLi, which is a lithium salt, was gradually added to be dissolved. A total amount of 12.81 g of (FSO₂)₂NLi was added to the flask, and stirring was performed overnight in the flask. The obtained electrolytic solution was transferred to a 20-mL measuring flask, and ethyl methyl carbonate was added thereto until a volume of 20 mL was obtained. This was used as electrolytic solution E16. The production was performed within a glovebox under an inert gas atmosphere.

The concentration of (FSO₂)₂NLi in electrolytic solution E16 was 3.4 mol/L. In electrolytic solution E16, 2 molecules of ethyl methyl carbonate were contained with respect to 1 molecule of (FSO₂)₂NLi.

(E17)

Electrolytic solution E17 whose concentration of (FSO₂)₂NLi was 2.9 mol/L was obtained by adding ethyl methyl carbonate to, and thereby diluting, electrolytic solution E16. In electrolytic solution E17, 2.5 molecules of ethyl methyl carbonate were contained with respect to 1 molecule of (FSO₂)₂NLi.

(E18)

Electrolytic solution E18 whose concentration of (FSO₂)₂NLi was 2.2 mol/L was obtained by adding ethyl methyl carbonate to, and thereby diluting, electrolytic solution E16. In electrolytic solution E18, 3.5 molecules of ethyl methyl carbonate were contained with respect to 1 molecule of (FSO₂)₂NLi.

(E19)

Approximately 5 mL of diethyl carbonate, which is an organic solvent, was placed in a flask including a stirring bar. Under a stirring condition, with respect to diethyl carbonate in the flask, (FSO₂)₂NLi, which is a lithium salt, was gradually added to be dissolved. A total amount of 11.37 g of (FSO₂)₂NLi was added to the flask, and stirring was performed overnight in the flask. The obtained electrolytic solution was transferred to a 20-mL measuring flask, and diethyl carbonate was added thereto until a volume of 20 mL was obtained. This was used as electrolytic solution E19. The production was performed within a glovebox under an inert gas atmosphere.

The concentration of (FSO₂)₂NLi in electrolytic solution E19 was 3.0 mol/L. In electrolytic solution E19, 2 molecules of diethyl carbonate were contained with respect to 1 molecule of (FSO₂)₂NLi.

(E20)

Electrolytic solution E20 whose concentration of (FSO₂)₂NLi was 2.6 mol/L was obtained by adding diethyl carbonate to, and thereby diluting, electrolytic solution E19. In electrolytic solution E20, 2.5 molecules of diethyl carbonate were contained with respect to 1 molecule of (FSO₂)₂NLi.

(E21)

Electrolytic solution E21 whose concentration of (FSO₂)₂NLi was 2.0 mol/L was obtained by adding diethyl carbonate to, and thereby diluting, electrolytic solution E19. In electrolytic solution E21, 3.5 molecules of diethyl carbonate were contained with respect to 1 molecule of (FSO₂)₂NLi.

(C1)

Electrolytic solution C1 whose concentration of (CF₃SO₂)₂NLi was 1.0 mol/L was produced with a method similar to that of E3, except for using 5.74 g of (CF₃SO₂)₂NLi and 1,2-dimethoxyethane as the organic solvent. In electrolytic solution C1, 8.3 molecules of 1,2-dimethoxyethane were contained with respect to 1 molecule of (CF₃SO₂)₂NLi.

(C2)

With a method similar to that of E3, electrolytic solution C2 whose concentration of (CF₃SO₂)₂NLi was 1.0 mol/L was produced using 5.74 g of (CF₃SO₂)₂NLi. In electrolytic solution C2, 16 molecules of acetonitrile were contained with respect to 1 molecule of (CF₃SO₂)₂NLi.

(C3)

With a method similar to that of E5, electrolytic solution C3 whose concentration of (FSO₂)₂NLi was 1.0 mol/L was produced using 3.74 g of (FSO₂)₂NLi. In electrolytic solution C3, 8.8 molecules of 1,2-dimethoxyethane were contained with respect to 1 molecule of (FSO₂)₂NLi.

(C4)

With a method similar to that of E7, electrolytic solution C4 whose concentration of (FSO₂)₂NLi was 1.0 mol/L was produced using 3.74 g of (FSO₂)₂NLi. In electrolytic solution C4, 17 molecules of acetonitrile were contained with respect to 1 molecule of (FSO₂)₂NLi.

(C5)

Electrolytic solution C5 whose concentration of LiPF₆ was 1.0 mol/L was produced with a method similar to that of E3, except for using a mixed solvent of ethylene carbonate and diethyl carbonate (volume ratio of 3:7; hereinafter, sometimes referred to as “EC/DEC”) as the organic solvent, and 3.04 g of LiPF₆ as the lithium salt.

(C6)

Electrolytic solution C6 whose concentration of (FSO₂)₂NLi was 1.1 mol/L was obtained by adding dimethyl carbonate to, and thereby diluting, electrolytic solution E11. In electrolytic solution C6, 10 molecules of dimethyl carbonate were contained with respect to 1 molecule of (FSO₂)₂NLi.

(C7)

Electrolytic solution C7 whose concentration of (FSO₂)₂NLi was 1.1 mol/L was obtained by adding ethyl methyl carbonate to, and thereby diluting, electrolytic solution E16. In electrolytic solution C7, 8 molecules of ethyl methyl carbonate were contained with respect to 1 molecule of (FSO₂)₂NLi.

(C8)

Electrolytic solution C8 whose concentration of (FSO₂)₂NLi was 1.1 mol/L was obtained by adding diethyl carbonate to, and thereby diluting, electrolytic solution E19. In electrolytic solution C8, 7 molecules of diethyl carbonate were contained with respect to 1 molecule of (FSO₂)₂NLi.

Table 3 shows a list of the electrolytic solutions.

TABLE 3

| | | | Lithium salt | Organic solvent/Lithium |
|---|---|---|---|---|
| | Lithium | Organic | concentration | salt (mol |
| | salt | solvent | (mol/L) | ratio) |
| E1 | LiTFSA | DME | 3.2 | 1.6 |
| E2 | LiTFSA | DME | 2.8 | 2.1 |
| E3 | LiTFSA | AN | 3.4 | 3 |
| E4 | LiTFSA | AN | 4.2 | 1.9 |
| E5 | LiFSA | DME | 3.6 | 1.9 |
| E6 | LiFSA | DME | 4.0 | 1.5 |
| E7 | LiFSA | AN | 4.2 | 3 |
| E8 | LiFSA | AN | 4.5 | 2.4 |
| E9 | LiFSA | AN | 5.0 | 2.1 |
| E10 | LiFSA | AN | 5.4 | 2 |
| E11 | LiFSA | DMC | 3.9 | 2 |
| E12 | LiFSA | DMC | 3.4 | 2.5 |
| E13 | LiFSA | DMC | 2.9 | 3 |
| E14 | LiFSA | DMC | 2.6 | 3.5 |
| E15 | LiFSA | DMC | 2.0 | 5 |
| E16 | LiFSA | EMC | 3.4 | 2 |
| E17 | LiFSA | EMC | 2.9 | 2.5 |
| E18 | LiFSA | EMC | 2.2 | 3.5 |
| E19 | LiFSA | DEC | 3.0 | 2 |
| E20 | LiFSA | DEC | 2.6 | 2.5 |
| E21 | LiFSA | DEC | 2.0 | 3.5 |
| C1 | LiTFSA | DME | 1.0 | 8.3 |
| C2 | LiTFSA | AN | 1.0 | 16 |
| C3 | LiFSA | DME | 1.0 | 8.8 |
| C4 | LiFSA | AN | 1.0 | 17 |
| C5 | LiPF₆ | EC/DEC | 1.0 | |
| C6 | LiFSA | DMC | 1.1 | 10 |
| C7 | LiFSA | EMC | 1.1 | 8 |
| C8 | LiFSA | DEC | 1.1 | 7 |

LiTFSA: (CF₃SO₂)₂NLi,
LiFSA: (FSO₂)₂NLi,
AN: acetonitrile,
DME: 1,2-dimethoxyethane,
EC/DEC: Mixed solvent of ethylene carbonate and diethyl carbonate (volume ratio 3:7)

### Evaluation Example 1: IR Measurement

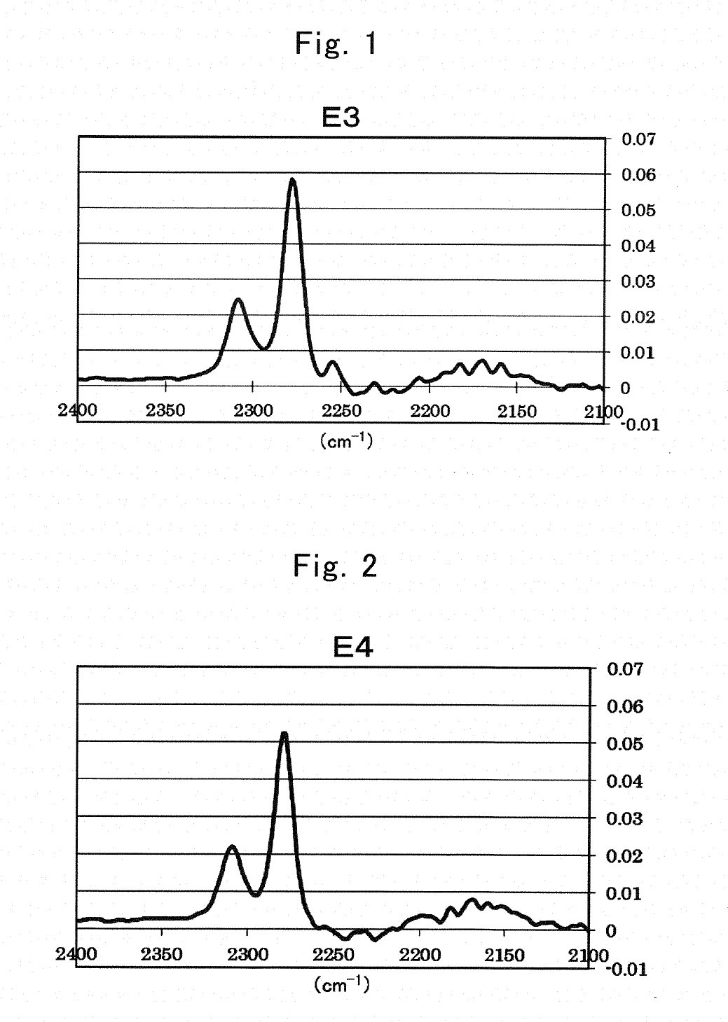

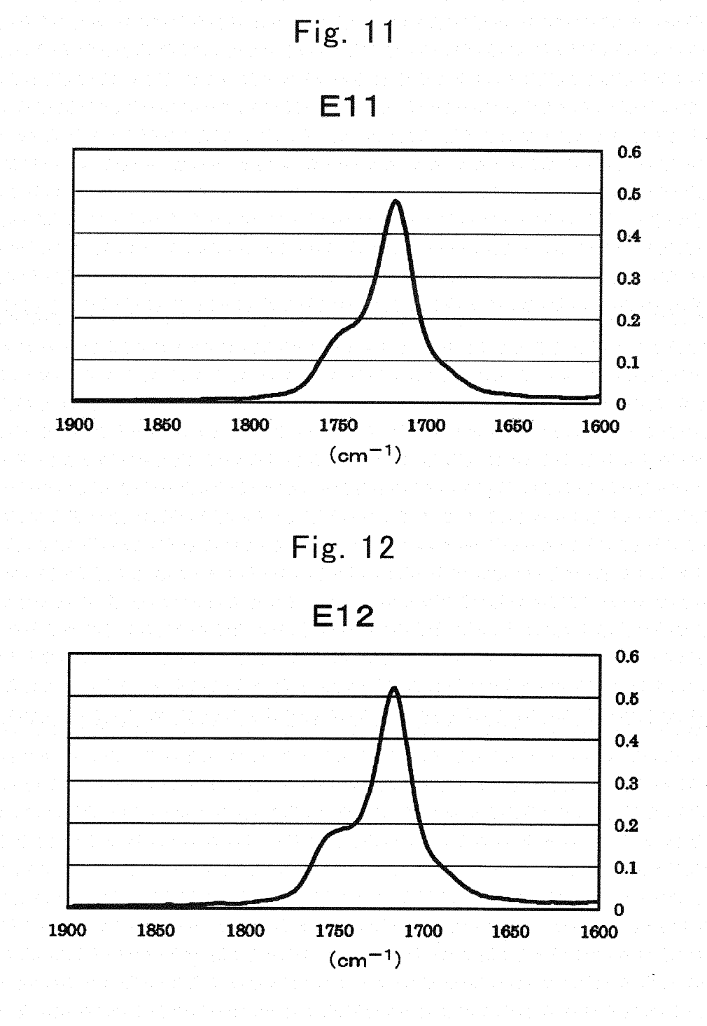

IR measurement was performed using the following conditions on electrolytic solutions E3, E4, E7, E8, E10, C2, and C4, acetonitrile, (CF₃SO₂)₂NLi, and (FSO₂)₂NLi. An IR spectrum in a range of 2100 to 2400 cm⁻¹ is shown in each of FIGS. 1 to 10. In each of the figures, the horizontal axis represents wave number (cm⁻¹) and the vertical axis represents absorbance (reflective absorbance). Furthermore, IR measurement was performed using the following conditions on electrolytic solutions E11 to E21 and C6 to C8, dimethyl carbonate, ethyl methyl carbonate, and diethyl carbonate. An IR spectrum in a range of 1900 to 1600 cm⁻¹ is shown in each of FIGS. 11 to 27. In addition, an IR spectrum of (FSO₂)₂NLi in a range of 1900 to 1600 cm⁻¹ is shown in FIG. 28. In each figure, the horizontal axis represents wave number (cm⁻¹) and the vertical axis represents absorbance (reflective absorbance).

IR Measuring Conditions

Device: FT-IR (manufactured by Bruker Optics K.K.)

Measuring condition: ATR method (diamond was used)

Measurement atmosphere: Inert gas atmosphere

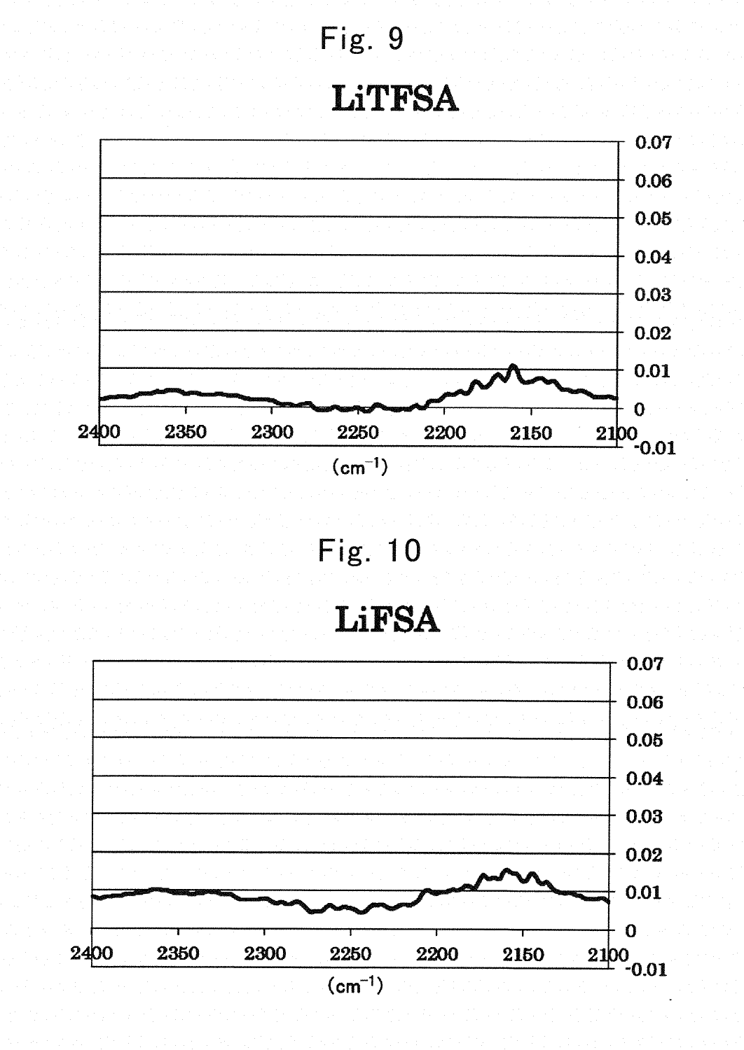

At around 2250 cm⁻¹ in the IR spectrum of acetonitrile shown in FIG. 8, a characteristic peak derived from stretching vibration of a triple bond between C and N of acetonitrile was observed. No particular peaks were observed at around 2250 cm⁻¹ in the IR spectrum of (CF₃SO₂)₂NLi shown in FIG. 9 and the IR spectrum of (FSO₂)₂NLi shown in FIG. 10.

In the IR spectrum of electrolytic solution E3 shown in FIG. 1, a characteristic peak derived from stretching vibration of a triple bond between C and N of acetonitrile was slightly (Io=0.00699) observed at around 2250 cm⁻¹. Additionally in the IR spectrum in FIG. 1, a characteristic peak derived from stretching vibration of a triple bond between C and N of acetonitrile was observed at a peak intensity of Is=0.05828 at around 2280 cm⁻¹ shifted toward the high wave number side from around 2250 cm⁻¹. The relationship between peak intensities of Is and Io was Is>Io and Is=8×Io.

In the IR spectrum of electrolytic solution E4 shown in FIG. 2, a peak derived from acetonitrile was not observed at around 2250 cm⁻¹, whereas a characteristic peak derived from stretching vibration of a triple bond between C and N of acetonitrile was observed at a peak intensity of Is=0.05234 at around 2280 cm⁻¹ shifted toward the high wave number side from around 2250 cm⁻¹. The relationship between peak intensities of Is and Io was Is>Io.

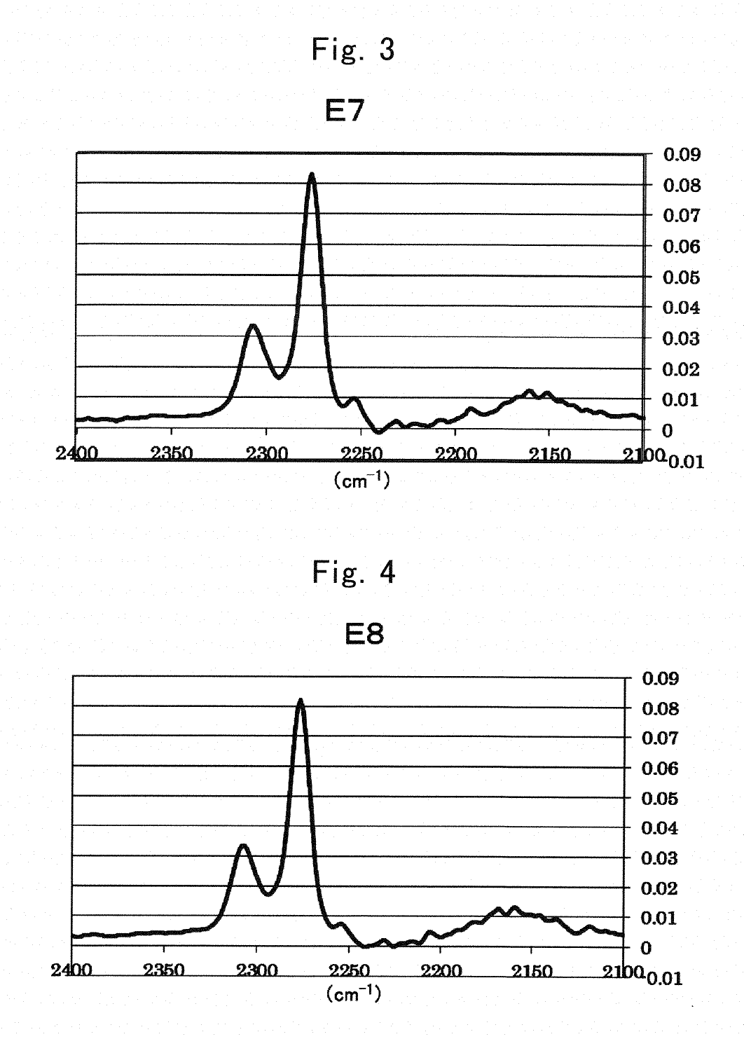

In the IR spectrum of electrolytic solution E7 shown in FIG. 3, a characteristic peak derived from stretching vibration of a triple bond between C and N of acetonitrile was slightly (Io=0.00997) observed at around 2250 cm⁻¹. Additionally in the IR spectrum in FIG. 3, a characteristic peak derived from stretching vibration of a triple bond between C and N of acetonitrile was observed at a peak intensity of Is=0.08288 at around 2280 cm⁻¹ shifted toward the high wave number side from around 2250 cm⁻¹. The relationship between peak intensities of Is and Io was Is>Io and Is=8×Io. A peak having a similar intensity and similar wave number to those in the IR chart of FIG. 3 was also observed in the IR spectrum of electrolytic solution E8 shown in FIG. 4. The relationship between peak intensities of Is and Io was Is>Io and Is=11×Io.

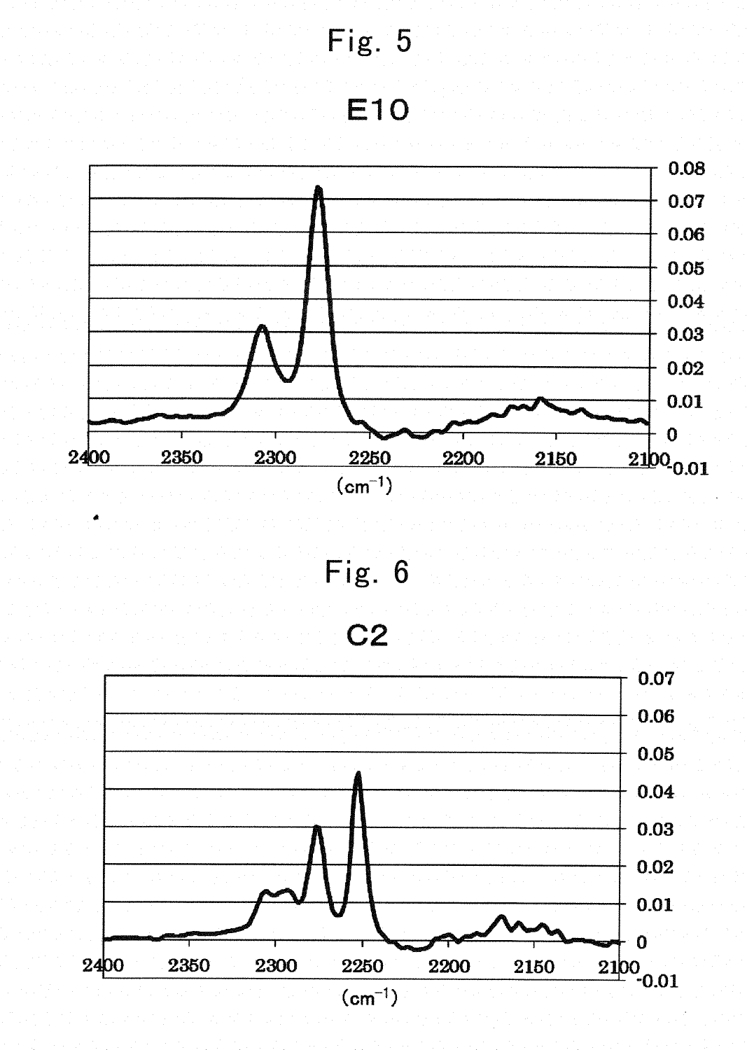

In the IR spectrum of electrolytic solution E10 shown in FIG. 5, a peak derived from acetonitrile was not observed at around 2250 cm⁻¹, whereas a characteristic peak derived from stretching vibration of a triple bond between C and N of acetonitrile was observed at a peak intensity of Is=0.07350 at around 2280 cm⁻¹ shifted toward the high wave number side from around 2250 cm⁻¹. The relationship between peak intensities of Is and Io was Is>Io.

In the IR spectrum of electrolytic solution C2 shown in FIG. 6, a characteristic peak derived from stretching vibration of a triple bond between C and N of acetonitrile was observed at a peak intensity of Io=0.04441 at around 2250 cm⁻¹ in a manner similar to FIG. 8. Additionally in the IR spectrum in FIG. 6, a characteristic peak derived from stretching vibration of a triple bond between C and N of acetonitrile was observed at a peak intensity of Is=0.03018 at around 2280 cm⁻¹ shifted toward the high wave number side from around 2250 cm⁻¹. The relationship between peak intensities of Is and Io was Is<Io.

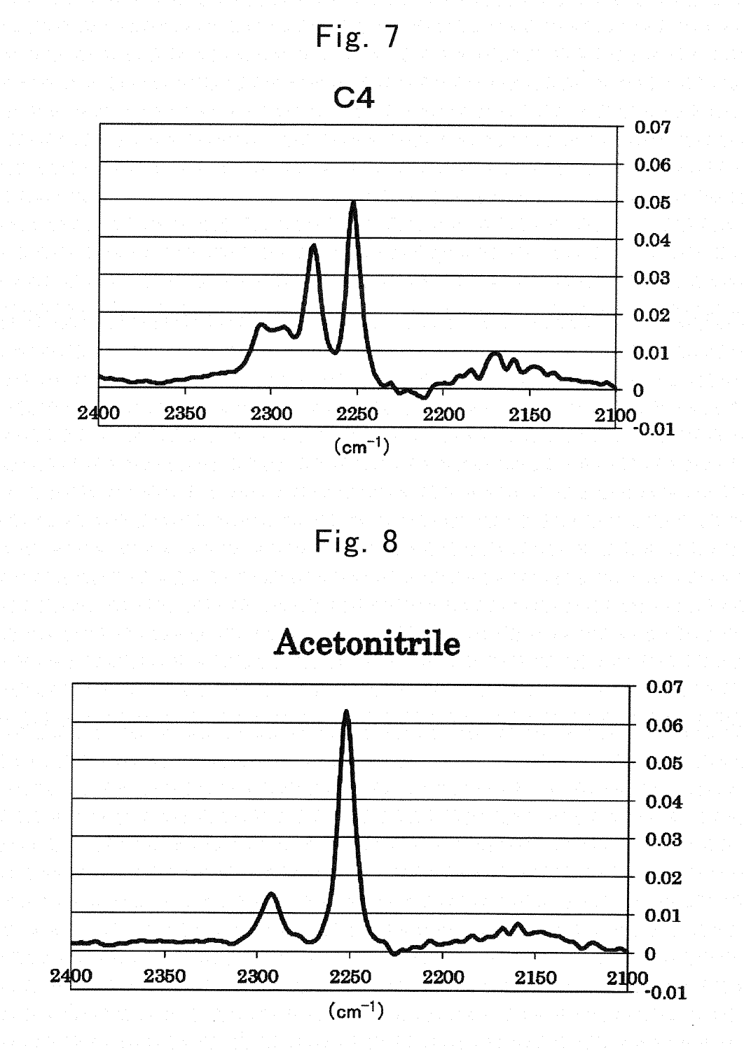

In the IR spectrum of electrolytic solution C4 shown in FIG. 7, a characteristic peak derived from stretching vibration of a triple bond between C and N of acetonitrile was observed at a peak intensity of Io=0.04975 at around 2250 cm⁻¹ in a manner similar to FIG. 8. Additionally in the IR spectrum in FIG. 7, a characteristic peak derived from stretching vibration of a triple bond between C and N of acetonitrile was observed at a peak intensity of Is=0.03804 at around 2280 cm⁻¹ shifted toward the high wave number side from around 2250 cm⁻¹. The relationship between peak intensities of Is and Io was Is<Io.

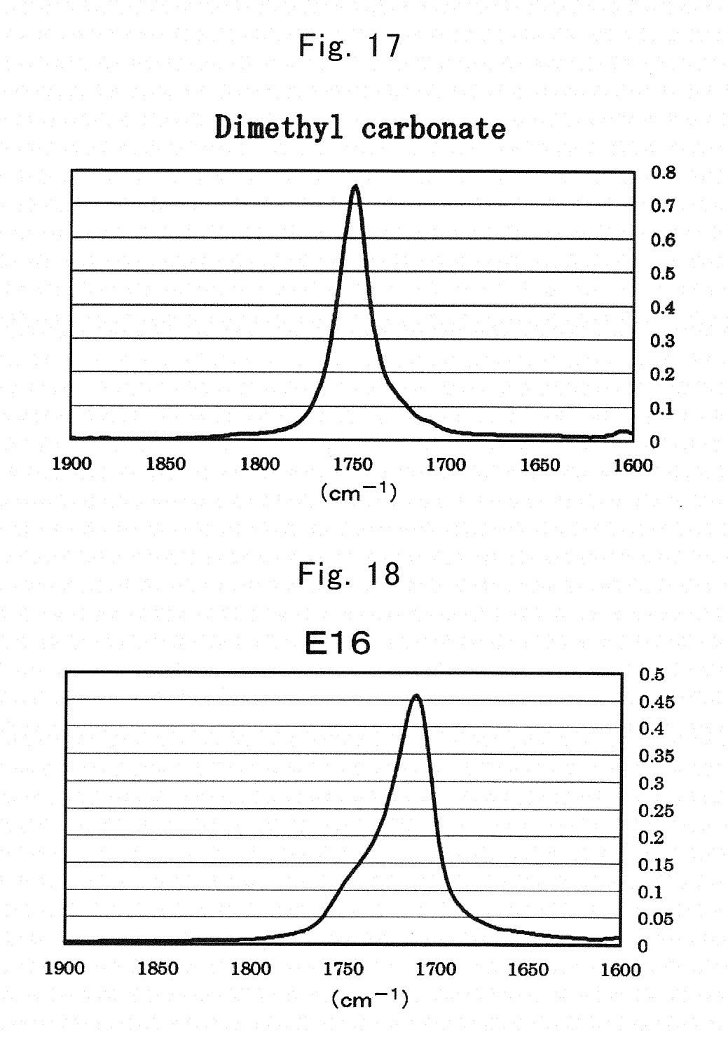

At around 1750 cm⁻¹ in the IR spectrum of dimethyl carbonate shown in FIG. 17, a characteristic peak derived from stretching vibration of a double bond between C and O of dimethyl carbonate was observed. No particular peaks were observed at around 1750 cm⁻¹ in the IR spectrum of (FSO₂)₂NLi shown in FIG. 28.

In the IR spectrum of electrolytic solution E11 shown in FIG. 11, a characteristic peak derived from stretching vibration of a double bond between C and O of dimethyl carbonate was slightly (Io=0.16628) observed at around 1750 cm⁻¹. Additionally in the IR spectrum in FIG. 11, a characteristic peak derived from stretching vibration of a double bond between C and O of dimethyl carbonate was observed at a peak intensity of Is=0.48032 at around 1717 cm⁻¹ shifted toward the low wave number side from around 1750 cm⁻¹. The relationship between peak intensities of Is and Io was Is>Io and Is=2.89×Io.

In the IR spectrum of electrolytic solution E12 shown in FIG. 12, a characteristic peak derived from stretching vibration of a double bond between C and O of dimethyl carbonate was slightly (Io=0.18129) observed at around 1750 cm⁻¹. Additionally in the IR spectrum in FIG. 12, a characteristic peak derived from stretching vibration of a double bond between C and O of dimethyl carbonate was observed at a peak intensity of Is=0.52005 at around 1717 cm⁻¹ shifted toward the low wave number side from around 1750 cm⁻¹. The relationship between peak intensities of Is and Io was Is>Io and Is=2.87×Io.

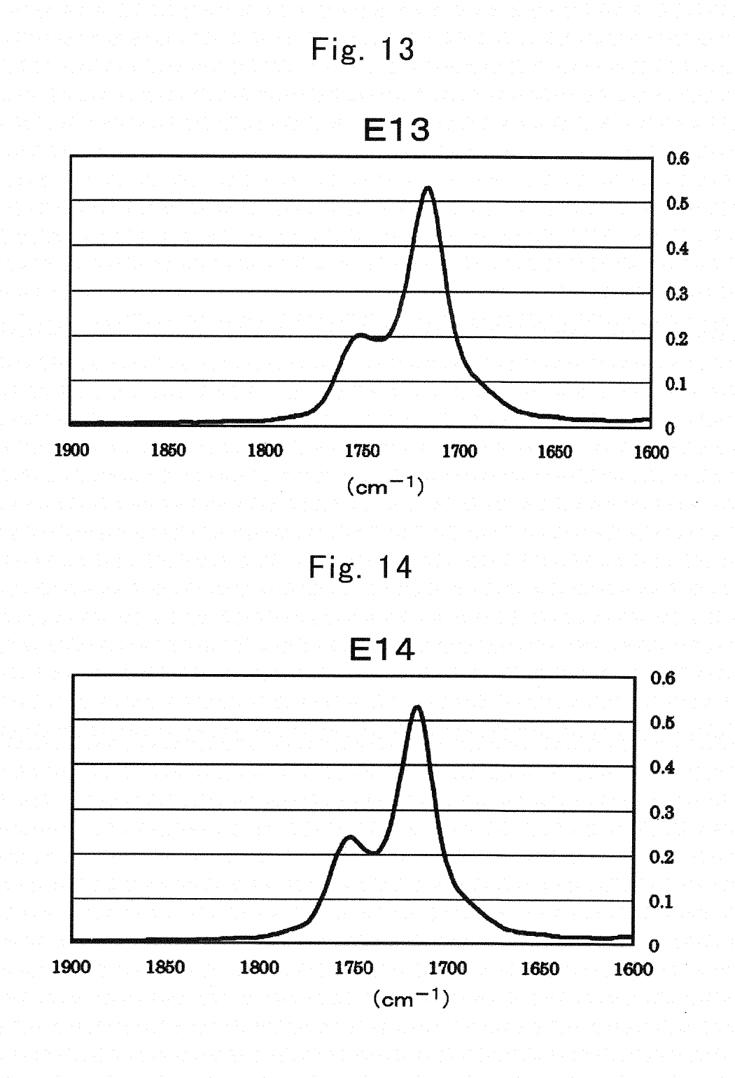

In the IR spectrum of electrolytic solution E13 shown in FIG. 13, a characteristic peak derived from stretching vibration of a double bond between C and O of dimethyl carbonate was slightly (Io=0.20293) observed at around 1750 cm⁻¹. Additionally in the IR spectrum in FIG. 13, a characteristic peak derived from stretching vibration of a double bond between C and O of dimethyl carbonate was observed at a peak intensity of Is=0.53091 at around 1717 cm⁻¹ shifted toward the low wave number side from around 1750 cm⁻¹. The relationship between peak intensities of Is and Io was Is>Io and Is=2.62×Io.

In the IR spectrum of electrolytic solution E14 shown in FIG. 14, a characteristic peak derived from stretching vibration of a double bond between C and O of dimethyl carbonate was slightly (Io=0.23891) observed at around 1750 cm⁻¹. Additionally in the IR spectrum in FIG. 14, a characteristic peak derived from stretching vibration of a double bond between C and O of dimethyl carbonate was observed at a peak intensity of Is=0.53098 at around 1717 cm⁻¹ shifted toward the low wave number side from around 1750 cm⁻¹. The relationship between peak intensities of Is and Io was Is>Io and Is=2.22×Io.

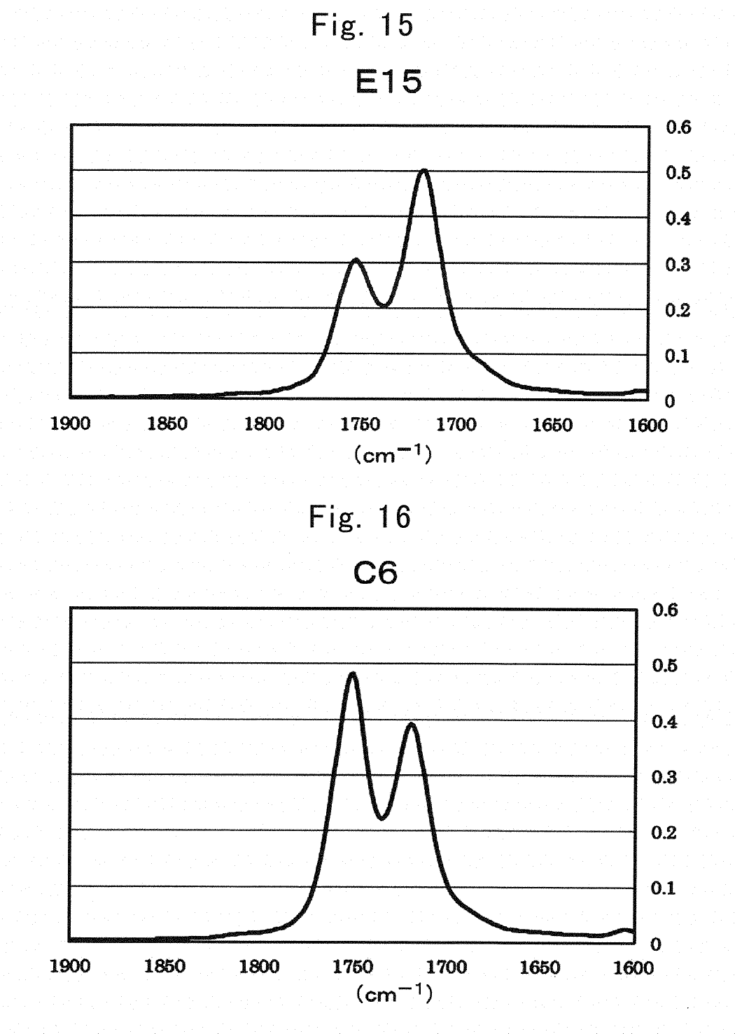

In the IR spectrum of electrolytic solution E15 shown in FIG. 15, a characteristic peak derived from stretching vibration of a double bond between C and O of dimethyl carbonate was slightly (Io=0.30514) observed at around 1750 cm⁻¹. Additionally in the IR spectrum in FIG. 15, a characteristic peak derived from stretching vibration of a double bond between C and O of dimethyl carbonate was observed at a peak intensity of Is=0.50223 at around 1717 cm⁻¹ shifted toward the low wave number side from around 1750 cm⁻¹. The relationship between peak intensities of Is and Io was Is>Io and Is=1.65×Io.

In the IR spectrum of electrolytic solution C6 shown in FIG. 16, a characteristic peak derived from stretching vibration of a double bond between C and O of dimethyl carbonate was observed (Io=0.48204) at around 1750 cm⁻¹. Additionally in the IR spectrum in FIG. 16, a characteristic peak derived from stretching vibration of a double bond between C and O of dimethyl carbonate was observed at a peak intensity of Is=0.39244 at around 1717 cm⁻¹ shifted toward the low wave number side from around 1750 cm⁻¹. The relationship between peak intensities of Is and Io was Is<Io.

At around 1745 cm⁻¹ in the IR spectrum of ethyl methyl carbonate shown in FIG. 22, a characteristic peak derived from stretching vibration of a double bond between C and O of ethyl methyl carbonate was observed.

In the IR spectrum of electrolytic solution E16 shown in FIG. 18, a characteristic peak derived from stretching vibration of a double bond between C and O of ethyl methyl carbonate was slightly (Io=0.13582) observed at around 1745 cm⁻¹. Additionally in the IR spectrum in FIG. 18, a characteristic peak derived from stretching vibration of a double bond between C and O of ethyl methyl carbonate was observed at a peak intensity of Is=0.45888 at around 1711 cm⁻¹ shifted toward the low wave number side from around 1745 cm⁻¹. The relationship between peak intensities of Is and Io was Is>Io and Is=3.38×Io.

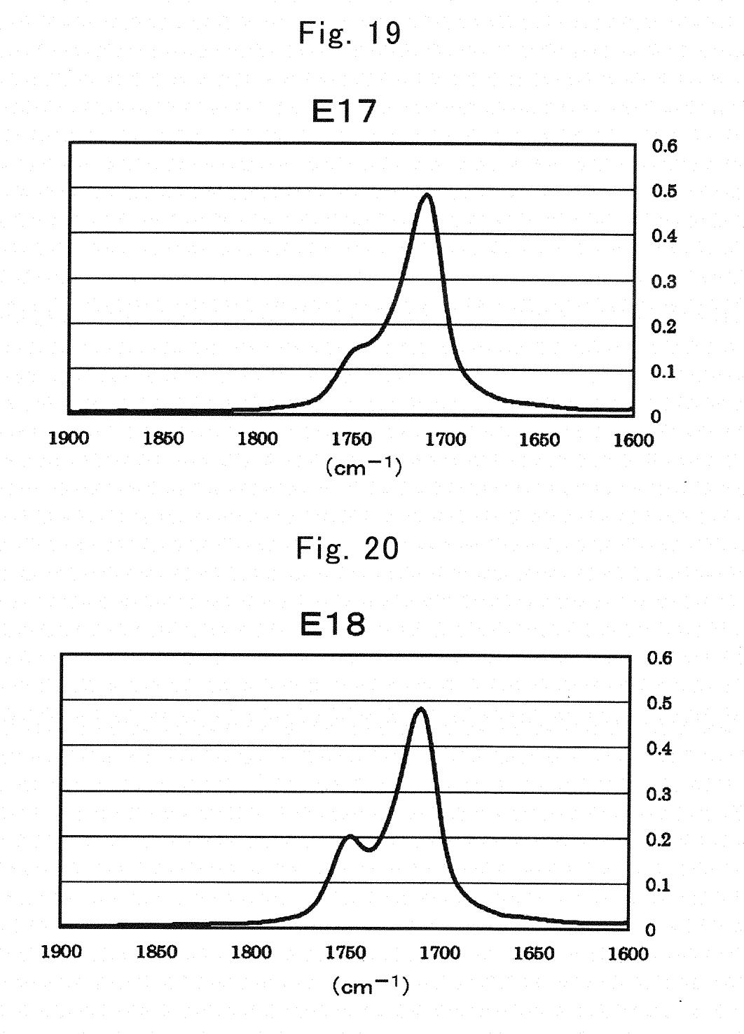

In the IR spectrum of electrolytic solution E17 shown in FIG. 19, a characteristic peak derived from stretching vibration of a double bond between C and O of ethyl methyl carbonate was slightly (Io=0.15151) observed at around 1745 cm⁻¹. Additionally in the IR spectrum in FIG. 19, a characteristic peak derived from stretching vibration of a double bond between C and O of ethyl methyl carbonate was observed at a peak intensity of Is=0.48779 at around 1711 cm⁻¹ shifted toward the low wave number side from around 1745 cm⁻¹. The relationship between peak intensities of Is and Io was Is>Io and Is=3.22×Io.

In the IR spectrum of electrolytic solution E18 shown in FIG. 20, a characteristic peak derived from stretching vibration of a double bond between C and O of ethyl methyl carbonate was slightly (Io=0.20191) observed at around 1745 cm⁻¹. Additionally in the IR spectrum in FIG. 20, a characteristic peak derived from stretching vibration of a double bond between C and O of ethyl methyl carbonate was observed at a peak intensity of Is=0.48407 at around 1711 cm⁻¹ shifted toward the low wave number side from around 1745 cm⁻¹. The relationship between peak intensities of Is and Io was Is>Io and Is=2.40×Io.

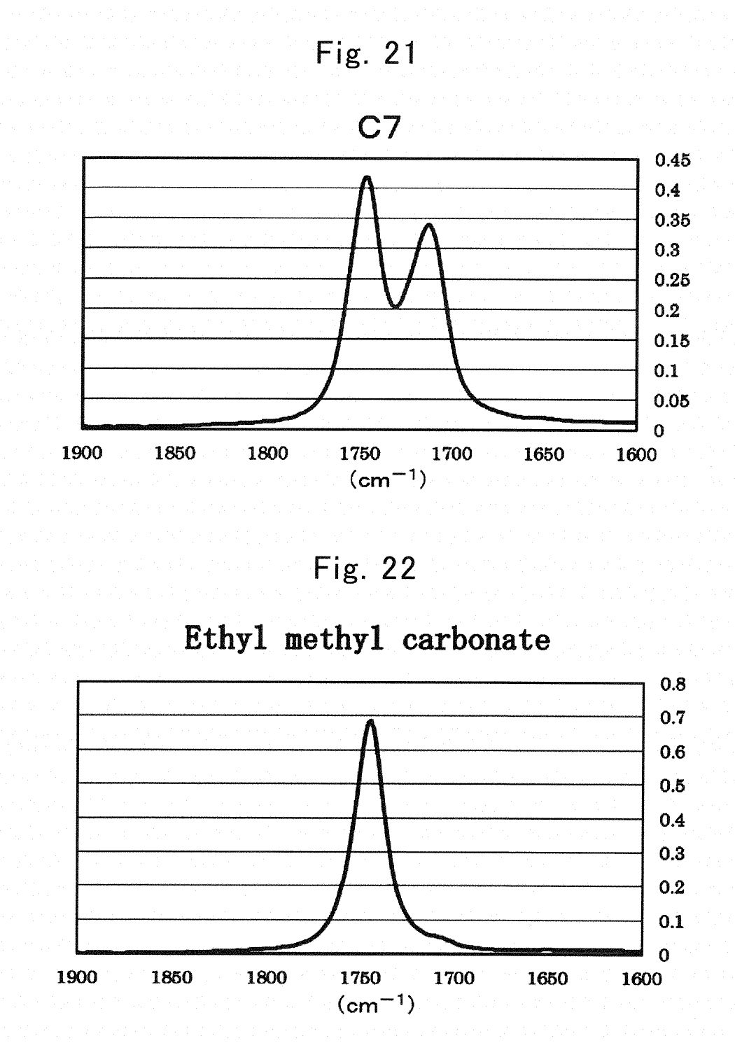

In the IR spectrum of electrolytic solution C7 shown in FIG. 21, a characteristic peak derived from stretching vibration of a double bond between C and O of ethyl methyl carbonate was observed (Io=0.41907) at around 1745 cm⁻¹. Additionally in the IR spectrum in FIG. 21, a characteristic peak derived from stretching vibration of a double bond between C and O of ethyl methyl carbonate was observed at a peak intensity of Is=0.33929 at around 1711 cm⁻¹ shifted toward the low wave number side from around 1745 cm⁻¹. The relationship between peak intensities of Is and Io was Is<Io.

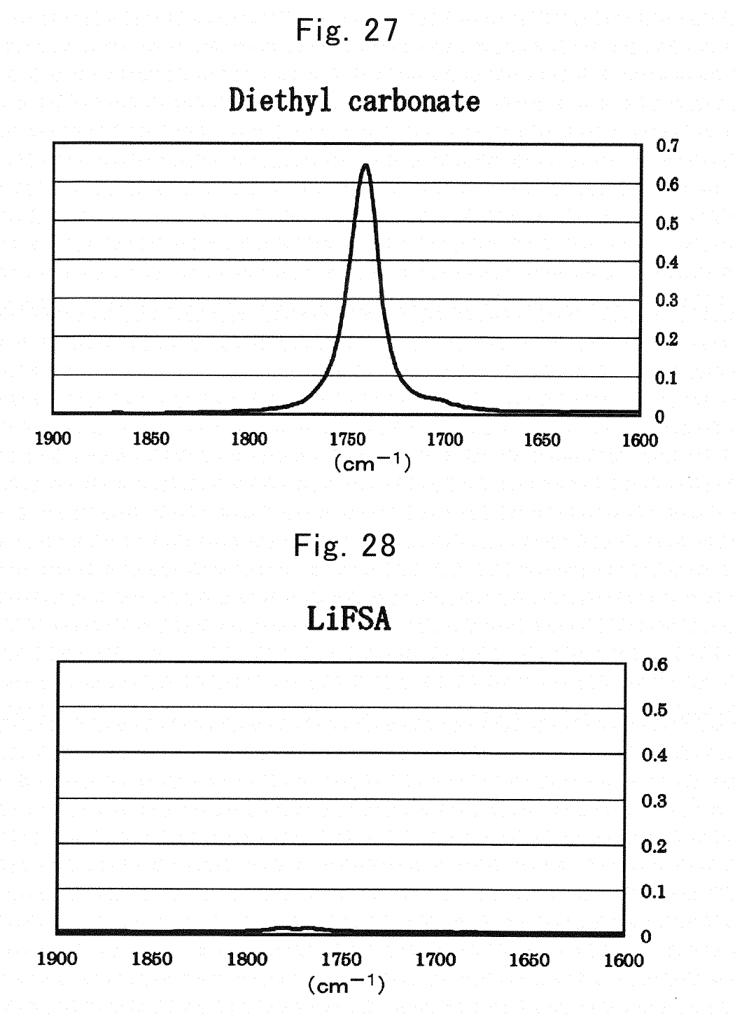

At around 1742 cm⁻¹ in the IR spectrum of diethyl carbonate shown in FIG. 27, a characteristic peak derived from stretching vibration of a double bond between C and O of diethyl carbonate was observed.

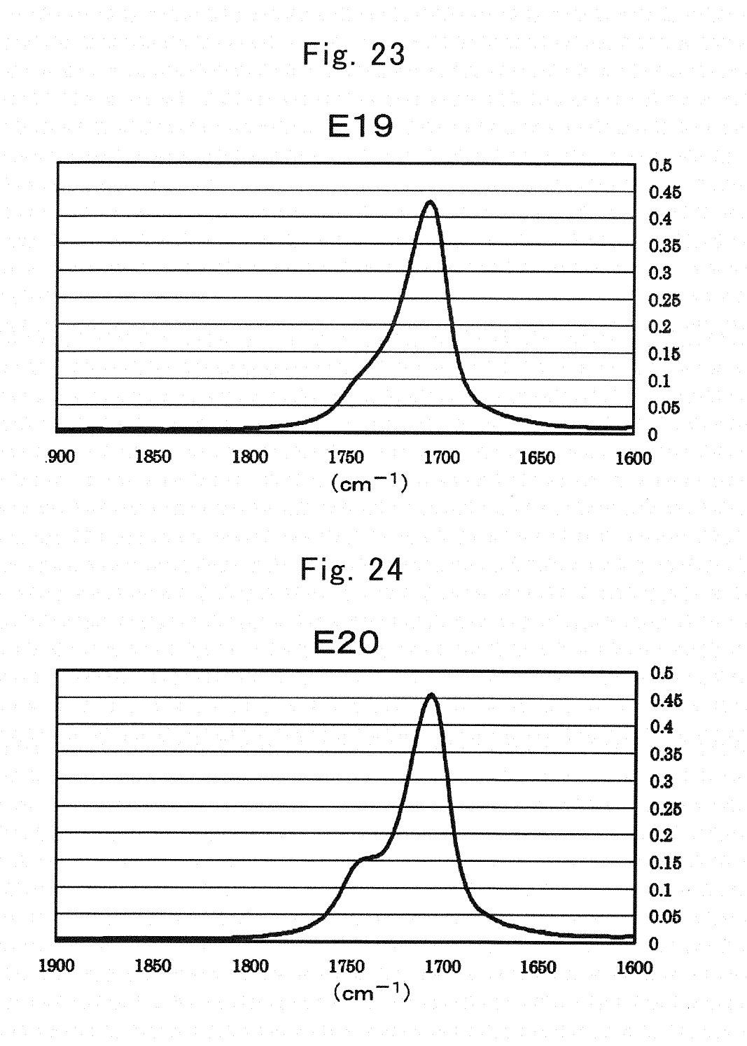

In the IR spectrum of electrolytic solution E19 shown in FIG. 23, a characteristic peak derived from stretching vibration of a double bond between C and O of diethyl carbonate was slightly (Io=0.11202) observed at around 1742 cm⁻¹. Additionally in the IR spectrum in FIG. 23, a characteristic peak derived from stretching vibration of a double bond between C and O of diethyl carbonate was observed at a peak intensity of Is=0.42925 at around 1706 cm⁻¹ shifted toward the low wave number side from around 1742 cm⁻¹. The relationship between peak intensities of Is and Io was Is>Io and Is=3.83×Io.

In the IR spectrum of electrolytic solution E20 shown in FIG. 24, a characteristic peak derived from stretching vibration of a double bond between C and O of diethyl carbonate was slightly (Io=0.15231) observed at around 1742 cm⁻¹. Additionally in the IR spectrum in FIG. 24, a characteristic peak derived from stretching vibration of a double bond between C and O of diethyl carbonate was observed at a peak intensity of Is=0.45679 at around 1706 cm⁻¹ shifted toward the low wave number side from around 1742 cm⁻¹. The relationship between peak intensities of Is and Io was Is>Io and Is=3.00×Io.

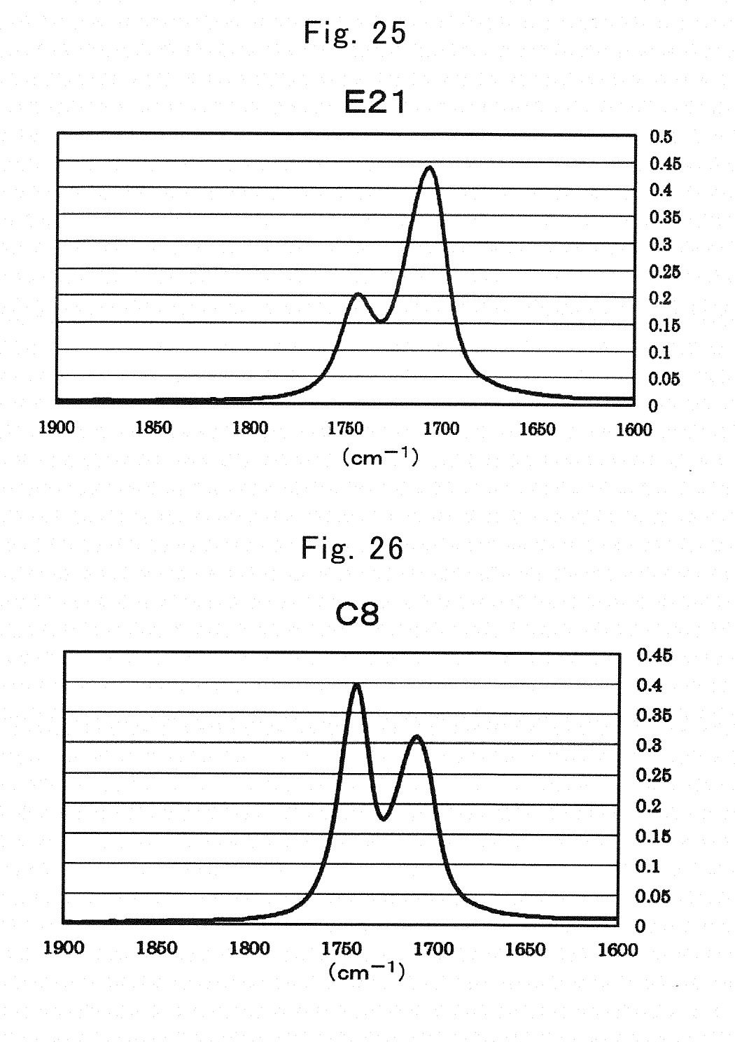

In the IR spectrum of electrolytic solution E21 shown in FIG. 25, a characteristic peak derived from stretching vibration of a double bond between C and O of diethyl carbonate was slightly (Io=0.20337) observed at around 1742 cm⁻¹. Additionally in the IR spectrum in FIG. 25, a characteristic peak derived from stretching vibration of a double bond between C and O of diethyl carbonate was observed at a peak intensity of Is=0.43841 at around 1706 cm⁻¹ shifted toward the low wave number side from around 1742 cm⁻¹. The relationship between peak intensities of Is and Io was Is>Io and Is=2.16×Io.

In the IR spectrum of electrolytic solution C8 shown in FIG. 26, a characteristic peak derived from stretching vibration of a double bond between C and O of diethyl carbonate was observed (Io=0.39636) at around 1742 cm⁻¹. Additionally in the IR spectrum in FIG. 26, a characteristic peak derived from stretching vibration of a double bond between C and O of diethyl carbonate was observed at a peak intensity of Is=0.31129 at around 1709 cm⁻¹ shifted toward the low wave number side from around 1742 cm⁻¹. The relationship between peak intensities of Is and Io was Is<Io.

### Evaluation Example 2: Raman Spectrum Measurement

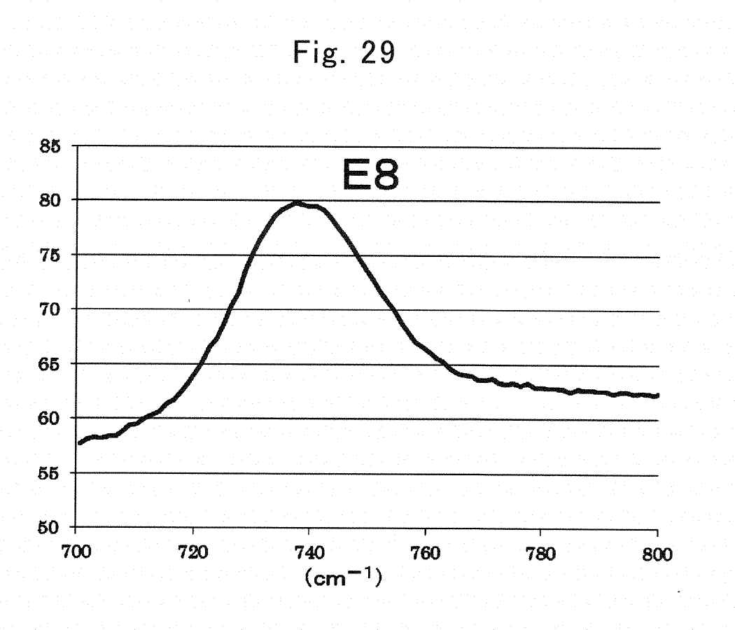

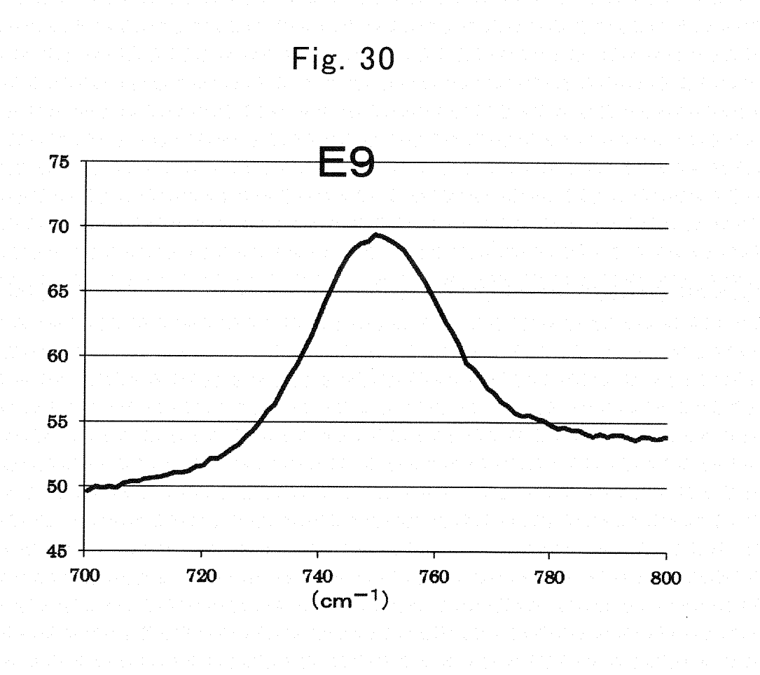

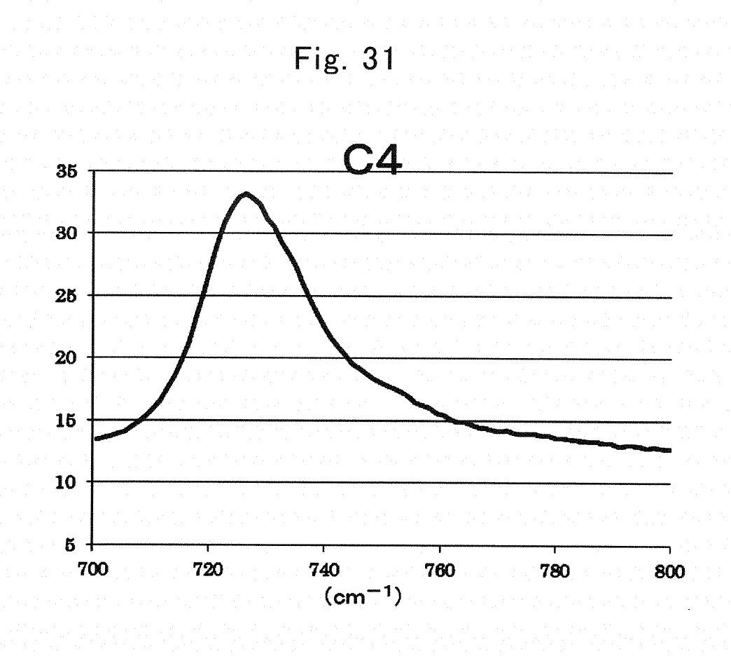

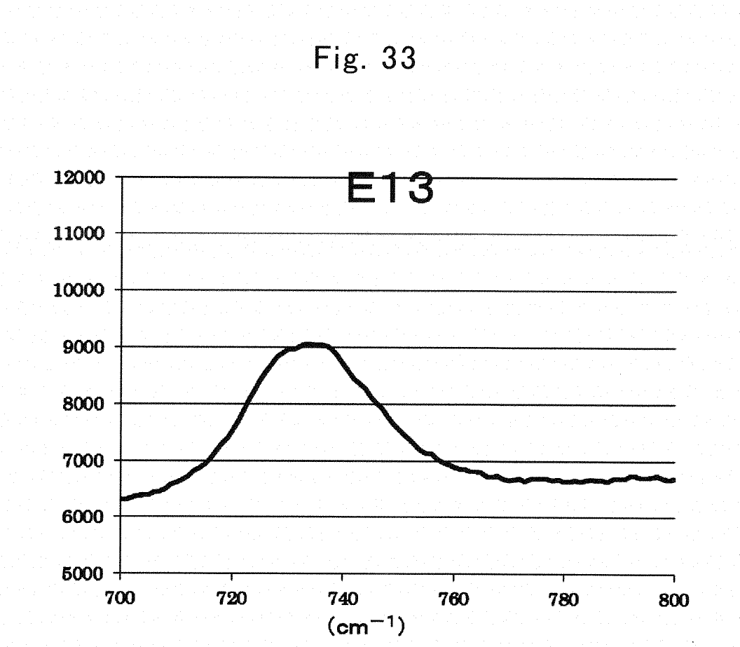

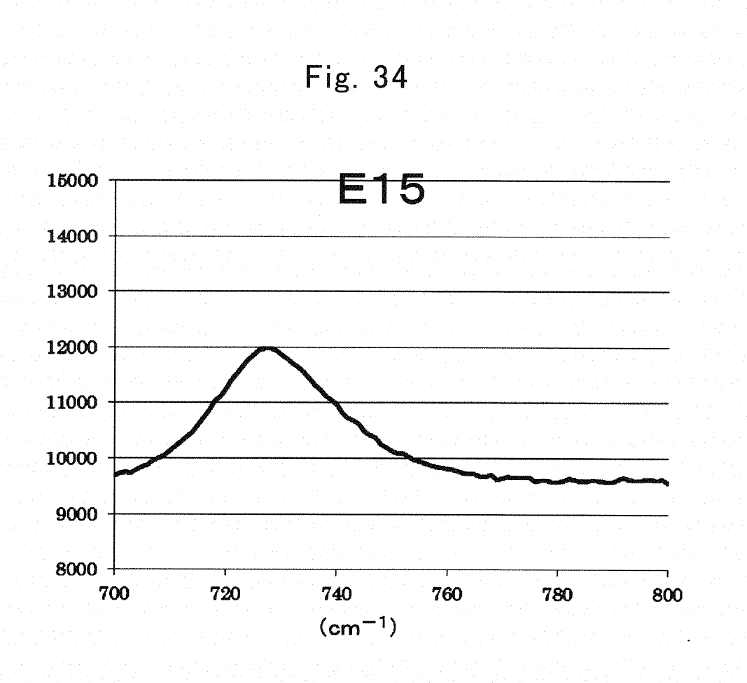

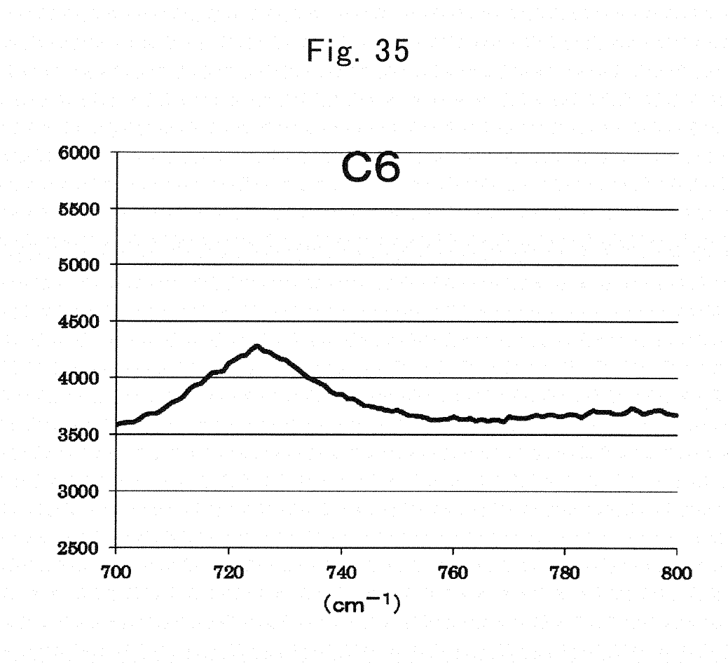

Raman spectrum measurement was performed on electrolytic solutions E8, E9, C4, E11, E13, E15, and C6 using the following conditions. FIGS. 29 to 35 each show a Raman spectrum in which a peak derived from an anion portion of a metal salt of an electrolytic solution was observed. In each of the figures, the horizontal axis represents wave number (cm⁻¹) and the vertical axis represents scattering intensity.

Raman Spectrum Measurement Conditions

Device: Laser Raman spectrometer (NRS series, JASCO Corp.)

Laser wavelength: 532 nm

The electrolytic solutions were each sealed in a quartz cell under an inert gas atmosphere and subjected to the measurement.

At 700 to 800 cm⁻¹ in the Raman spectra of electrolytic solutions E8, E9, and C4 shown in FIGS. 29 to 31, characteristic peaks derived from (FSO₂)₂N of LiFSA dissolved in acetonitrile were observed. Here based on FIGS. 29 to 31, the peak is understood as to shift toward the high wave number side associated with an increase in the concentration of LiFSA. As the concentration of the electrolytic solution becomes higher, (FSO₂)₂N corresponding to the anion of a salt is speculated to enter a state of interacting with Li. In other words, Li and an anion are speculated to mainly form an SSIP (Solvent-separated ion pairs) state at a low concentration, and mainly form a CIP (Contact ion pairs) state or an AGG (aggregate) state as the concentration becomes higher. A change in the state is thought to be observed as a peak shift in the Raman spectrum.

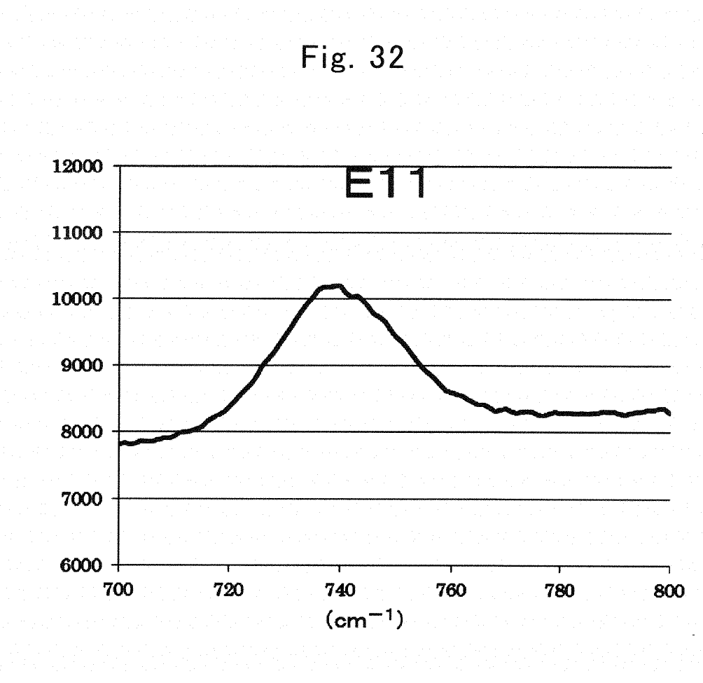

In electrolytic solutions E11, E13, E15, and C6 shown in FIGS. 32 to 35, at 700 to 800 cm⁻¹ in the Raman spectra, characteristic peaks derived from (FSO₂)₂N of LiFSA dissolved in dimethyl carbonate were observed. Here, based on FIGS. 32 to 35, the peak is understood as to shift toward the high wave number side associated with an increase in the concentration of LiFSA. As considered in the previous paragraph, this phenomenon is speculated to be a result of a state, in which (FSO₂)₂N corresponding to the anion of a salt is interacting with multiple Li ions, being reflected in the spectrum, as the concentration of the electrolytic solution became higher.

### Evaluation Example 3: Ionic Conductivity

Ionic conductivities of electrolytic solutions E1, E2, E4 to E6, E8, E11, E16, and E19 were measured using the following conditions. The results are shown in Table 4.

Ionic Conductivity Measuring Conditions

Under an Ar atmosphere, an electrolytic solution was sealed in a glass cell that has a platinum electrode and whose cell constant is known, and impedance thereof was measured at 30° C., 1 kHz. Ionic conductivity was calculated based on the result of measuring impedance. As a measurement instrument, Solartron 147055BEC (Solartron Analytical) was used.

TABLE 4

| | Lithium | Organic | Lithium salt | Ionic conductivity |
|---|---|---|---|---|
| | salt | solvent | concentration (mol/L) | (mS/cm⁻¹) |
| E1 | LiTFSA | DME | 3.2 | 2.4 |
| E2 | LiTFSA | DME | 2.8 | 4.4 |
| E4 | LiTFSA | AN | 4.2 | 1.0 |
| E5 | LiFSA | DME | 3.6 | 7.2 |
| E6 | LiFSA | DME | 4.0 | 7.1 |
| E8 | LiFSA | AN | 4.5 | 9.7 |
| E9 | LiFSA | AN | 5.0 | 7.5 |
| E11 | LiFSA | DMC | 3.9 | 2.3 |
| E13 | LiFSA | DMC | 2.9 | 4.6 |
| E16 | LiFSA | EMC | 3.4 | 1.8 |
| E19 | LiFSA | DEC | 3.0 | 1.4 |

Electrolytic solutions E1, E2, E4 to E6, E8, E11, E16, and E19 all displayed ionic conductivity. Thus, the electrolytic solutions of the present invention are understood to be all capable of functioning as electrolytic solutions of various batteries.

### Evaluation Example 4: Viscosity

Viscosities of electrolytic solutions E1, E2, E4 to 6, E8, E11, E16, E19, C1 to C4, and C6 to C8 were measured using the following conditions. The results are shown in Table 5.

Viscosity Measuring Conditions

Under an Ar atmosphere, an electrolytic solution was sealed in a test cell, and viscosity thereof was measured under a condition of 30° C. by using a falling ball viscometer (Lovis 2000 M manufactured by Anton Paar GmbH).

TABLE 5

| | Lithium | Organic | Lithium salt concentration | Viscosity |
|---|---|---|---|---|
| | salt | solvent | (mol/L) | (mPa · s) |
| E1 | LiTFSA | DME | 3.2 | 36.6 |
| E2 | LiTFSA | DME | 2.8 | 31.6 |
| E4 | LiTFSA | AN | 4.2 | 138.0 |
| E5 | LiFSA | DME | 3.6 | 25.1 |
| E6 | LiFSA | DME | 4.0 | 30.3 |
| E8 | LiFSA | AN | 4.5 | 23.8 |
| E9 | LiFSA | AN | 5.0 | 31.5 |
| E11 | LiFSA | DMC | 3.9 | 34.2 |
| E13 | LiFSA | DMC | 2.9 | 17.6 |
| E16 | LiFSA | EMC | 3.4 | 29.7 |
| E19 | LiFSA | DEC | 3.0 | 23.2 |
| C1 | LiTFSA | DME | 1.0 | 1.3 |
| C2 | LiTFSA | AN | 1.0 | 0.75 |
| C3 | LiFSA | DME | 1.0 | 1.2 |
| C4 | LiFSA | AN | 1.0 | 0.74 |
| C6 | LiFSA | DMC | 1.1 | 1.38 |
| C7 | LiFSA | EMC | 1.1 | 1.67 |
| C8 | LiFSA | DEC | 1.1 | 2.05 |

When compared to the viscosities of electrolytic solutions C1 to C4 and C6 to C8, the viscosities of electrolytic solutions E1, E2, E4 to 6, E8, E11, E16, and E19 were significantly higher. Thus, with a battery using the electrolytic solution of the present invention, even if the battery is damaged, leakage of the electrolytic solution is suppressed.

### Evaluation Example 5: Volatility

Volatilities of electrolytic solutions E2, E4, E8, E11, E13, C1, C2, C4, and C6 were measured using the following method.

Approximately 10 mg of an electrolytic solution was placed in a pan made from aluminum, and the pan was disposed in a thermogravimetry measuring device (SDT600 manufactured by TA Instruments) to measure weight change of the electrolytic solution at room temperature. Volatilization rate was calculated through differentiation of weight change (mass %) by time. Among the obtained volatilization rates, largest values were selected and are shown in Table 6.

TABLE 6

| | | | | Maximum |
|---|---|---|---|---|
| | Lithium | Organic | Lithium salt | volatilization |
| | salt | solvent | concentration (mol/L) | rate (mass %/min.) |
| E2 | LiTFSA | DME | 2.8 | 0.4 |
| E4 | LiTFSA | AN | 4.2 | 2.1 |
| E8 | LiFSA | AN | 4.5 | 0.6 |
| E11 | LiFSA | DMC | 3.9 | 0.1 |
| E13 | LiFSA | DMC | 2.9 | 1.3 |
| C1 | LiTFSA | DME | 1.0 | 9.6 |
| C2 | LiTFSA | AN | 1.0 | 13.8 |
| C4 | LiFSA | AN | 1.0 | 16.3 |
| C6 | LiFSA | DMC | 1.1 | 6.1 |

Maximum volatilization rates of electrolytic solutions E2, E4, E8, E11, and E13 were significantly smaller than maximum volatilization rates of electrolytic solutions C1, C2, C4, and C6. Thus, even if a battery using the electrolytic solution of the present invention is damaged, rapid volatilization of the organic solvent outside the battery is suppressed since the volatilization rate of the electrolytic solution is small.

### Evaluation Example 6: Combustibility

Combustibility of electrolytic solutions E4 and C2 were tested using the following method.

Three drops of an electrolytic solution were dropped on a glass filter by using a pipette to have the electrolytic solution retained by the glass filter. The glass filter was held by a pair of tweezers, and the glass filter was brought in contact with a flame.

Electrolytic solution E4 did not ignite even when being brought in contact with a flame for 15 seconds. On the other hand, electrolytic solution C2 burned out in a little over 5 seconds.

Thus, the electrolytic solution of the present invention was confirmed to be unlikely to combust.

In the following, the nonaqueous electrolyte secondary batteries (1) and (2) are described specifically. Since the following Examples, and EB and CB are described in separate sections for convenience sake, duplication may exist. In some cases, the following Examples, and EB and CB described later correspond to both Examples of the nonaqueous electrolyte secondary batteries (1) and (2).

(EB1)

A half-cell using electrolytic solution E8 was produced in the following manner. 90 parts by mass of graphite which is an active material and whose mean particle diameter is 10 μm was mixed with 10 parts by mass of polyvinylidene fluoride which is a binding agent. The mixture was dispersed in a proper amount of N-methyl-2-pyrrolidone to create a slurry. As the current collector, a copper foil having a thickness of 20 μm was prepared. The slurry was applied in a film form on the surface of the copper foil by using a doctor blade. The copper foil on which the slurry was applied was dried to remove N-methyl-2-pyrrolidone, and then the copper foil was pressed to obtain a joined object. The obtained joined object was heated and dried in a vacuum dryer for 6 hours at 120° C. to obtain a copper foil having the active material layer formed thereon. This was used as the working electrode.

Metal Li was used as the counter electrode.

The working electrode, the counter electrode, a Whatman glass fiber filter paper having a thickness of 400 μm interposed therebetween as the separator, and electrolytic solution E8 were housed in a battery case (CR2032 type coin cell case manufactured by Hohsen Corp.) to obtain a nonaqueous electrolyte secondary battery EB1. This nonaqueous electrolyte secondary battery is a nonaqueous electrolyte secondary battery for evaluation, and is also referred to as a half-cell.

(CB1)

A nonaqueous electrolyte secondary battery CB1 was produced with a method similar to that of EB1 except for using electrolytic solution C5.

### Evaluation Example 7: Rate Characteristics

Rate characteristics of EB1 and CB1 were tested using the following method.

With respect to each of the nonaqueous electrolyte secondary batteries, at 0.1 C, 0.2 C, 0.5 C, 1 C, and 2 C rates (1 C refers to a current required for full charging or discharging a battery in 1 hour under a constant current), charging and then discharging were performed, and the capacity (discharge capacity) of the working electrode was measured at each rate. In the description here, the counter electrode was regarded as the negative electrode and the working electrode was regarded as the positive electrode. With respect to the capacity of the working electrode at 0.1 C rate, proportions of capacities (rate characteristics) at other rates were calculated. The results are shown in Table 7.

TABLE 7

| | EB1 | CB1 |
|---|---|---|
| 0.1 C capacity (mAh/g) | 334 | 330 |
| 0.2 C capacity/0.1 C capacity | 0.983 | 0.966 |
| 0.5 C capacity/0.1 C capacity | 0.946 | 0.767 |
| 1 C capacity/0.1 C capacity | 0.868 | 0.498 |
| 2 C capacity/0.1 C capacity | 0.471 | 0.177 |

When compared to CB1, EB1 showed suppression of decrease in capacity and excellent rate characteristics at all rates of 0.2 C, 0.5 C, 1 C, and 2 C. Thus, the secondary battery using the electrolytic solution of the present invention was confirmed to show excellent rate characteristics.

### Evaluation Example 8: Responsivity with Respect to Repeated Rapid Charging/Discharging

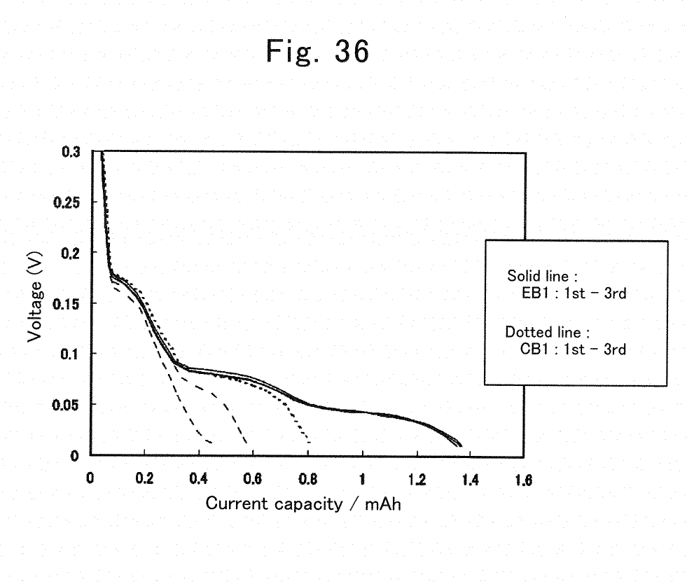

The changes in capacity and voltage were observed when charging and discharging were repeated three times at 1 C rate using the nonaqueous electrolyte secondary batteries EB1 and CB1. The results are shown in FIG. 36.

Associated with repeated charging and discharging, CB1 tended to show greater polarization when current was passed therethrough at 1 C rate, and capacity obtained from 2 V to 0.01 V rapidly decreased. On the other hand, EB1 hardly displayed increase or decrease of polarization, as confirmed also from the manner three curves overlap in FIG. 36 even when charging and discharging were repeated, and had maintained its capacity suitably. A conceivable reason why polarization had increased in CB1 is the inability of the electrolytic solution to supply sufficient amount of Li to a reaction interface with an electrode because of Li concentration unevenness generated in the electrolytic solution when charging and discharging are repeated rapidly, i.e., uneven distribution of Li concentration in the electrolytic solution. In EB1, using the electrolytic solution of the present invention having a high Li concentration is thought to have enabled suppression of uneven distribution of Li concentration of the electrolytic solution. Thus, the secondary battery using the electrolytic solution of the present invention was confirmed to show excellent responsivity with respect to rapid charging and discharging.

### Evaluation Example 9: Li Transference Number

Li transference numbers of electrolytic solutions E2, E8, C4, and C5 were measured using the following conditions. The results are shown in Table 8.

(Li Transference Number Measuring Conditions)

An NMR tube including an electrolytic solution was placed in a PFG-NMR device (ECA-500, JEOL Ltd.), and diffusion coefficient of Li ions and anions in each of the electrolytic solutions were measured on ⁷Li and ¹⁹F as targets while altering a magnetic field pulse width and using spin echo method. The Li transference number was calculated from the following formula.

Li transference number=(Li ionic diffusion coefficient)/(Li ionic diffusion coefficient+anion diffusion coefficient)

TABLE 8

| | Lithium | Organic | Lithium salt concentration | Li transference |
|---|---|---|---|---|
| | salt | solvent | (mol/L) | number |
| E2 | LiTFSA | DME | 2.8 | 0.52 |
| E8 | LiFSA | AN | 4.5 | 0.50 |
| C4 | LiFSA | AN | 1.0 | 0.42 |
| C5 | LiPF₆ | EC/DEC | 1.0 | 0.40 |

When compared to the Li transference numbers of electrolytic solutions C4 and C5, the Li transference numbers of electrolytic solutions E2 and E8 were significantly higher. Here, Li ionic conductivity of an electrolytic solution is calculated by multiplying ionic conductivity (total ion conductivity) of the electrolytic solution by the Li transference number. As a result, when compared to a conventional electrolytic solution having the same level of ionic conductivity, the electrolytic solution of the present invention shows a high transportation rate of lithium ion (cation).

In addition, the Li transference number was measured in electrolytic solution E8 in accordance with the measuring conditions for the above described Li transference numbers, while altering the temperature. The results are shown in Table 9.

TABLE 9

| Temperature (° C.) | Li transference number |
|---|---|
| 30 | 0.50 |
| 10 | 0.50 |
| −10 | 0.50 |
| −30 | 0.52 |

Based on the results in Table 9, the electrolytic solution of the present invention is understood as to maintain a suitable Li transference number regardless of the temperature. The electrolytic solution of the present invention is regarded as to maintain a liquid state even at a low temperature.

[Nonaqueous Electrolyte Secondary Battery]

(EB2) A nonaqueous electrolyte secondary battery EB2 using electrolytic solution E8 was produced in the following manner.

94 parts by mass of a lithium-containing metal oxide that has a layered rock salt structure and is represented by LiNi_{5/10}Co_{2/10}Mn_{3/10}O₂, which is a positive electrode active material, 3 parts by mass of acetylene black, which is a conductive additive, and 3 parts by mass of polyvinylidene fluoride which is a binding agent, were mixed. The mixture was dispersed in a proper amount of N-methyl-2-pyrrolidone to create a slurry. As the positive electrode current collector, an aluminum foil (JIS A1000 series) having a thickness of 20 μm was prepared. The slurry was applied in a film form on the surface of the aluminum foil by using a doctor blade. The aluminum foil on which the slurry was applied was dried for 20 minutes at 80° C. to remove N-methyl-2-pyrrolidone through volatilization. Then, the aluminum foil was pressed to obtain a joined object. The obtained joined object was heated and dried in a vacuum dryer for 6 hours at 120° C. to obtain an aluminum foil having the positive electrode active material layer formed thereon. This was used as the positive electrode. Hereinafter, if necessary, the lithium-containing metal oxide having the layered rock salt structure represented by LiNi_{5/10}Co_{2/10}Mn_{3/10}O₂ is abbreviated as NCM523, acetylene black is abbreviated as AB, and polyvinylidene fluoride is abbreviated as PVdF.

98 parts by mass of natural graphite, which is a negative electrode active material, and 1 part by mass of styrene butadiene rubber and 1 part by mass of carboxymethyl cellulose which are binding agents were mixed. The mixture was dispersed in a proper amount of ion exchanged water to create a slurry. As the negative electrode current collector, a copper foil having a thickness of 20 μm was prepared. The slurry was applied in a film form on the surface of the copper foil by using a doctor blade. The copper foil on which the slurry was applied was dried to remove water, and then the copper foil was pressed to obtain a joined object. The obtained joined object was heated and dried in a vacuum dryer for 6 hours at 100° C. to obtain a copper foil having the negative electrode active material layer formed thereon. This was used as the negative electrode. Hereinafter, if necessary, the styrene butadiene rubber is abbreviated as SBR, and carboxymethyl cellulose is abbreviated as CMC.

As the separator, a nonwoven fabric made from cellulose and having a thickness of 20 μm was prepared.

An electrode assembly was formed by sandwiching the separator between the positive electrode and the negative electrode. The electrode assembly was covered with a set of two sheets of a laminate film. The laminate film was formed into a bag-like shape by having three sides thereof sealed, and electrolytic solution E8 was poured in the laminate film. Four sides were sealed airtight by sealing the remaining one side to obtain a nonaqueous electrolyte secondary battery in which the electrode assembly and the electrolytic solution were sealed. This battery was used as the nonaqueous electrolyte secondary battery EB2.

(EB3)

A nonaqueous electrolyte secondary battery EB3 using electrolytic solution E8 was produced in the following manner.

A positive electrode was produced similarly to the positive electrode of the nonaqueous electrolyte secondary battery EB2.

90 parts by mass of natural graphite, which is a negative electrode active material, and 10 parts by mass of polyvinylidene fluoride, which is a binding agent, were mixed. The mixture was dispersed in a proper amount of ion exchanged water to create a slurry. As the negative electrode current collector, a copper foil having a thickness of 20 μm was prepared. The slurry was applied in a film form on the surface of the copper foil by using a doctor blade. The copper foil on which the slurry was applied was dried to remove water, and then the copper foil was pressed to obtain a joined object. The obtained joined object was heated and dried in a vacuum dryer for 6 hours at 120° C. to obtain a copper foil having the negative electrode active material layer formed thereon. This was used as the negative electrode.

As the separator, a nonwoven fabric made from cellulose and having a thickness of 20 μm was prepared.

An electrode assembly was formed by sandwiching the separator between the positive electrode and the negative electrode. The electrode assembly was covered with a set of two sheets of a laminate film. The laminate film was formed into a bag-like shape by having three sides thereof sealed, and electrolytic solution E8 was poured in the laminate film. Then, four sides of the laminate film were sealed by sealing the remaining one side to obtain a nonaqueous electrolyte secondary battery in which the electrode assembly and the electrolytic solution were sealed in the laminate film. This battery was used as the nonaqueous electrolyte secondary battery EB3.

(CB2)

A nonaqueous electrolyte secondary battery CB2 was produced similarly to EB2 except for using electrolytic solution C5.

(CB3)

A nonaqueous electrolyte secondary battery CB3 was produced similarly to EB3 except for using electrolytic solution C5.

### Evaluation Example 10: Input-Output Characteristics of Nonaqueous Electrolyte Secondary Battery

Output characteristics of nonaqueous electrolyte secondary batteries EB2, EB3, CB2, and CB3 were evaluated using the following conditions.

(1) Input Characteristics Evaluation at 0° C. or 25° C., SOC 80%

The used evaluation conditions were: state of charge (SOC) of 80%, 0° C. or 25° C., usage voltage range of 3 V to 4.2 V, and capacity of 13.5 mAh. Evaluation of input characteristics of each of the batteries was performed three times each for 2-second input and 5-second input.

In addition, based on the volume of each of the batteries, battery output density (W/L) at 25° C. in 2-second input was calculated.

Evaluation results of input characteristics are shown in Table 10. In Table 10, “2-second input” refers to an input inputted at 2 seconds after the start of charging, and “5-second input” refers to an input inputted at 5 seconds after the start of charging.

As shown in Table 10, regardless of the difference in temperature, the input of EB2 was significantly higher than the input of CB2. Similarly, the input of EB3 was significantly higher than the input of CB3.

In addition, the battery input density of EB2 was significantly higher than the battery input density of CB2. Similarly, the battery input density of EB3 was significantly higher than the battery input density of CB3.

(2) Output Characteristics Evaluation at 0° C. or 25° C., SOC 20%

The used evaluation conditions were: state of charge (SOC) of 20%, 0° C. or 25° C., usage voltage range of 3 V to 4.2 V, and capacity of 13.5 mAh. SOC 20% at 0° C. is in a range in which output characteristics are unlikely to be exerted such as, for example, when used in a cold room. Evaluation of output characteristics of each of the batteries was performed three times each for 2-second output and 5-second output.

In addition, based on the volume of each of the batteries, battery output density (W/L) at 25° C. in 2-second output was calculated.

Evaluation results of output characteristics are shown in Table 10. In Table 10, “2-second output” refers to an output outputted at 2 seconds after the start of discharging, and “5-second output” refers to an output outputted at 5 seconds after the start of discharging.

As shown in Table 10, regardless of the difference in temperature, the output of EB2 was significantly higher than the output of CB2. Similarly, the output of EB3 was significantly higher than the output of CB3.

In addition, the battery output density of EB2 was significantly higher than the battery output density of CB2. Similarly, the battery output density of EB3 was significantly higher than the battery output density of CB3.

TABLE 10

| | | Battery | | | |
|---|---|---|---|---|---|
| | | EB2 | CB2 | EB3 | CB3 |
| Electrolytic solution | | E8 | C5 | E8 | C5 |
| Positive electrode current collector | | Al | Al | Al | Al |
| SOC80%, | 2-second input (mW) | 1285.1 | 732.2 | 1113.6 | 756.9 |
| 25° C. | 5-second input (mW) | 1004.2 | 602.2 | 858.2 | 614.2 |
| SOC80%, | 2-second input (mW) | 498.5 | 232.3 | 423.2 | 218.3 |
| 0° C. | 5-second input (mW) | 408.4 | 206.8 | 348.6 | 191.2 |
| SOC20%, | 2-second output (mW) | 924.6 | 493.5 | 1079.3 | 696.0 |
| 25° C. | 5-second output (mW) | 899.6 | 425.9 | 1057.3 | 659.9 |
| SOC20%, | 2-second output (mW) | 305.2 | 175.3 | 354.8 | 207.5 |
| 0° C. | 5-second output (mW) | 291.7 | 165.6 | 347.1 | 202.1 |

| | | | | |
|---|---|---|---|---|
| Battery input density (W/L): | 6255.0 | 3563.9 | 3762.1 | 2558.4 |
| SOC80%, 25° C. | | | | |
| Battery output density (W/L): | 4497.4 | 2399.6 | 3647.1 | 2352.6 |
| SOC20%, 25° C. | | | | |

### Evaluation Example 11: Low Temperature Test

Electrolytic solutions E11, E13, E16, and E19 were each placed in a container, and the container was filled with inert gas and sealed. These solutions were stored in a −30° C. freezer for two days. Each of the electrolytic solutions after storage was observed. All of the electrolytic solutions maintained a liquid state without solidifying, and depositing of salts was also not observed.

### Example 1-1

A nonaqueous electrolyte secondary battery of Example 1-1 using electrolytic solution E8 was produced in the following manner. A positive electrode was produced similarly to the positive electrode of the nonaqueous electrolyte secondary battery EB2.

98 parts by mass of natural graphite, which is a negative electrode active material, and 1 part by mass of SBR and 1 part by mass of CMC which are binding agents were mixed. The mixture was dispersed in a proper amount of ion exchanged water to create a slurry. As the negative electrode current collector, a copper foil having a thickness of 20 μm was prepared. The slurry was applied in a film form on the surface of the copper foil by using a doctor blade. The copper foil on which the slurry was applied was dried to remove water, and then the copper foil was pressed to obtain a joined object. The obtained joined object was heated and dried in a vacuum dryer for 6 hours at 100° C. to obtain a copper foil having the negative electrode active material layer formed thereon. This was used as the negative electrode.

As a separator, a filter paper for experiments (Toyo Roshi Kaisha, Ltd., made from cellulose, thickness of 260 μm) was prepared.

An electrode assembly was formed by sandwiching the separator between the positive electrode and the negative electrode. The electrode assembly was covered with a set of two sheets of a laminate film. The laminate film was formed into a bag-like shape by having three sides thereof sealed, and electrolytic solution E8 was poured in the laminate film. Four sides were sealed airtight by sealing the remaining one side to obtain a nonaqueous electrolyte secondary battery in which the electrode assembly and the electrolytic solution were sealed. This battery was used as the nonaqueous electrolyte secondary battery of Example 1-1.

### Example 1-2

The nonaqueous electrolyte secondary battery of Example 1-2 was identical to the nonaqueous electrolyte secondary battery of Example 1-1, except for using electrolytic solution E4 as the electrolytic solution. The electrolytic solution in the nonaqueous electrolyte secondary battery of Example 1-2 is obtained by dissolving (SO₂CF₃)₂NLi (LiTFSA), which serves as the supporting salt, in acetonitrile, which serves as the solvent. The concentration of the lithium salt contained in 1 liter of the electrolytic solution was 4.2 mol/L. The electrolytic solution contains 2 molecules of acetonitrile with respect to 1 molecule of the lithium salt.

### Example 1-3

The nonaqueous electrolyte secondary battery of Example 1-3 was identical to the nonaqueous electrolyte secondary battery of Example 1-1, except for using electrolytic solution E11 as the electrolytic solution. The electrolytic solution in the nonaqueous electrolyte secondary battery of Example 1-3 was obtained by dissolving LiFSA, which serves as the supporting salt, in DMC, which serves as the solvent. The concentration of the lithium salt contained in 1 liter of the electrolytic solution was 3.9 mol/L. The electrolytic solution contains 2 molecules of DMC with respect to 1 molecule of the lithium salt.

### Example 1-4

A nonaqueous electrolyte secondary battery of Example 1-4 was obtained by using electrolytic solution E11. The nonaqueous electrolyte secondary battery of Example 1-4 was identical to the nonaqueous electrolyte secondary battery of Example 1-1, except for the type of the electrolytic solution, the mixing ratio of the positive electrode active material, the conductive additive, and the binding agent, the mixing ratio of the negative electrode active material and the binding agent, and the separator. In the positive electrode, NCM523 was used as the positive electrode active material, AB was used as the conductive additive for the positive electrode, and PVdF was used as the binding agent. These were similar to those of Example 1-1. The blend ratio of those was NCM523:AB:PVdF=90:8:2. The active material layer of the positive electrode had a weight per area of 5.5 mg/cm² and a density of 2.5 g/cm³. The same applies for the following Examples 1-5 to 1-7 and Comparative Examples 1-2 and 1-3.

In the negative electrode, natural graphite was used as the negative electrode active material, and SBR and CMC were used as the binding agent for the negative electrode. These were also similar to those of Example 1-1. The blend ratio of those was natural graphite:SBR:CMC=98:1:1. The active material layer of the negative electrode had a weight per area of 3.8 mg/cm² and a density of 1.1 g/cm³. The same applies for the following Examples 1-5 to 1-7 and Comparative Examples 1-2 and 1-3.

As the separator, a cellulose nonwoven fabric having a thickness of 20 μm was used.

The electrolytic solution in the nonaqueous electrolyte secondary battery of Example 1-4 is obtained by dissolving LiFSA, which serves as the supporting salt, in DMC, which serves as the solvent. The concentration of the lithium salt contained in 1 liter of the electrolytic solution was 3.9 mol/L. The electrolytic solution contains 2 molecules of DMC with respect to 1 molecule of the lithium salt.

### Example 1-5

A nonaqueous electrolyte secondary battery of Example 1-5 was obtained by using electrolytic solution E8. The nonaqueous electrolyte secondary battery of Example 1-5 was identical to the nonaqueous electrolyte secondary battery of Example 1-1, except for the mixing ratio of the positive electrode active material, the conductive additive, and the binding agent, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

### Example 1-6

A nonaqueous electrolyte secondary battery of Example 1-6 was obtained by using electrolytic solution E11. The nonaqueous electrolyte secondary battery of Example 1-6 was identical to the nonaqueous electrolyte secondary battery of Example 1-1, except for the type of the electrolytic solution, the mixing ratio of the positive electrode active material, the conductive additive, and the binding agent, the type of the binding agent for the negative electrode, the mixing ratio of the negative electrode active material and the binding agent, and the separator. NCM523:AB:PVdF=90:8:2 was used for the positive electrode. In the negative electrode, natural graphite was used as the negative electrode active material, and polyacrylic acid (PAA) was used as the binding agent for the negative electrode. The blend ratio of these was natural graphite:PAA=90:10. As the separator, a cellulose nonwoven fabric having a thickness of 20 μm was used.

### Example 1-7

A nonaqueous electrolyte secondary battery of Example 1-7 was obtained by using electrolytic solution E8. The nonaqueous electrolyte secondary battery of Example 1-7 was identical to the nonaqueous electrolyte secondary battery of Example 1-1, except for the mixing ratio of the positive electrode active material, the conductive additive, and the binding agent, the type of the binding agent for the negative electrode, the mixing ratio of the negative electrode active material and the binding agent, and the separator. NCM523:AB:PVdF=90:8:2 was used for the positive electrode. Natural graphite:PAA=90:10 was used for the negative electrode. As the separator, a cellulose nonwoven fabric having a thickness of 20 μm was used.

### Example 1-8

A nonaqueous electrolyte secondary battery of Example 1-8 was obtained by using electrolytic solution E13. The nonaqueous electrolyte secondary battery of Example 1-8 was identical to the nonaqueous electrolyte secondary battery of Example 1-1, except for the mixing ratio of the positive electrode active material and the conductive additive, the type of the binding agent for the negative electrode, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

### Comparative Example 1-1

A nonaqueous electrolyte secondary battery of Comparative Example 1-1 was similar to that in Example 1-1 except for using electrolytic solution C5 as the electrolytic solution.

### Comparative Example 1-2

A nonaqueous electrolyte secondary battery of Comparative Example 1-2 was obtained by using electrolytic solution C5. The nonaqueous electrolyte secondary battery of Comparative Example 1-2 was identical to the nonaqueous electrolyte secondary battery of Example 1-1, except for the type of the electrolytic solution, the mixing ratio of the positive electrode active material, the conductive additive, and the binding agent, the mixing ratio of the negative electrode active material and the binding agent, and the separator. NCM523:AB:PVdF=90:8:2 was used for the positive electrode. Natural graphite:SBR:CMC=98:1:1 was used for the negative electrode. As the separator, a cellulose nonwoven fabric having a thickness of 20 μm was used.

### Comparative Example 1-3

A nonaqueous electrolyte secondary battery of Comparative Example 1-3 was obtained by using electrolytic solution C5. The nonaqueous electrolyte secondary battery of Comparative Example 1-3 was identical to the nonaqueous electrolyte secondary battery of Example 1-1, except for the type of the electrolytic solution, the mixing ratio of the positive electrode active material, the conductive additive, and the binding agent, the type of the binding agent for the negative electrode, the mixing ratio of the negative electrode active material and the binding agent, and the separator. NCM523:AB:PVdF=90:8:2 was used for the positive electrode. Natural graphite:PAA=90:10 was used for the negative electrode. As the separator, a cellulose nonwoven fabric having a thickness of 20 μm was used.

The configuration of the batteries of the Examples and Comparative Examples are shown in Table 11.

TABLE 11

| | | Negative | | | | Positive |
|---|---|---|---|---|---|---|
| | Positive | electrode | | | | electrode |
| | electrode | Natural | Natural | Electrolytic | | current |
| | NCM523:AB:PVdF | graphite:SBR:CMC | graphite:PAA | solution | Separator | collector |
| Example | 94:3:3 | 98:1:1 | | E8 | 260 μm- | Al |
| 1-1 | | | | | filter | current |
| | | | | | paper for | collector |
| | | | | | experiments | |
| Example | 94:3:3 | 98:1:1 | | E4 | 260 μm- | Al |
| 1-2 | | | | | filter | current |
| | | | | | paper for | collector |
| | | | | | experiments | |
| Example | 94:3:3 | 98:1:1 | | E11 | 260 μm- | Al |
| 1-3 | | | | | filter | current |
| | | | | | paper for | collector |
| | | | | | experiments | |
| Example | 90:8:2 | 98:1:1 | | E11 | 20 μm- | Al |
| 1-4 | | | | | cellulose | current |
| | | | | | nonwoven | collector |
| | | | | | fabric | |
| Example | 90:8:2 | 98:1:1 | | E8 | 20 μm- | Al |
| 1-5 | | | | | cellulose | current |
| | | | | | nonwoven | collector |
| | | | | | fabric | |
| Example | 90:8:2 | | 90:10 | E11 | 20 μm- | Al |
| 1-6 | | | | | cellulose | current |
| | | | | | nonwoven | collector |
| | | | | | fabric | |
| Example | 90:8:2 | | 90:10 | E8 | 20 μm- | Al |
| 1-7 | | | | | cellulose | current |
| | | | | | nonwoven | collector |
| | | | | | fabric | |
| Example | 90:8:2 | 98:1:1 | | E13 | 20 μm- | Al |
| 1-8 | | | | | cellulose | current |
| | | | | | nonwoven | collector |
| | | | | | fabric | |
| Comparative | 94:3:3 | 98:1:1 | | C5 | 260 μm- | Al |
| Example | | | | | filter | current |
| 1-1 | | | | | paper for | collector |
| | | | | | experiments | |
| Comparative | 90:8:2 | 98:1:1 | | C5 | 20 μm- | Al |
| Example | | | | | cellulose | current |
| 1-2 | | | | | nonwoven | collector |
| | | | | | fabric | |
| Comparative | 90:8:2 | | 90:10 | C5 | 20 μm- | Al |
| Example | | | | | cellulose | current |
| 1-3 | | | | | nonwoven | collector |
| | | | | | fabric | |

### Evaluation Example 12: Analysis of S,O-Containing Coating

Hereinafter, if necessary, an S,O-containing coating formed on each of the surfaces of the negative electrodes in the nonaqueous electrolyte secondary batteries of the Examples is abbreviated as a negative-electrode S,O-containing coating of each of the Examples, and a coating formed on the surfaces of the negative electrodes in the nonaqueous electrolyte secondary batteries of the Comparative Examples is abbreviated as a negative-electrode coating of each of the Comparative Examples.

In addition, if necessary, a coating formed on each of the surfaces of the positive electrodes in the nonaqueous electrolyte secondary batteries of the Examples is abbreviated as a positive-electrode S,O-containing coating of each of the Examples, and a coating formed on each of the surfaces of the positive electrodes in the nonaqueous electrolyte secondary batteries of the Comparative Examples is abbreviated as a positive-electrode coating of each of the Comparative Examples.

(Analysis of Negative-Electrode S,O-Containing Coating and Negative-Electrode Coating)

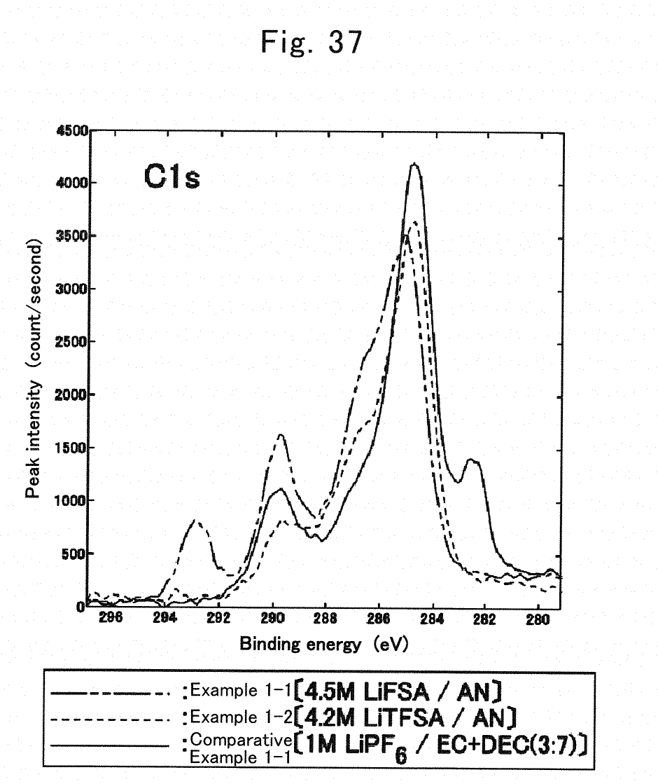

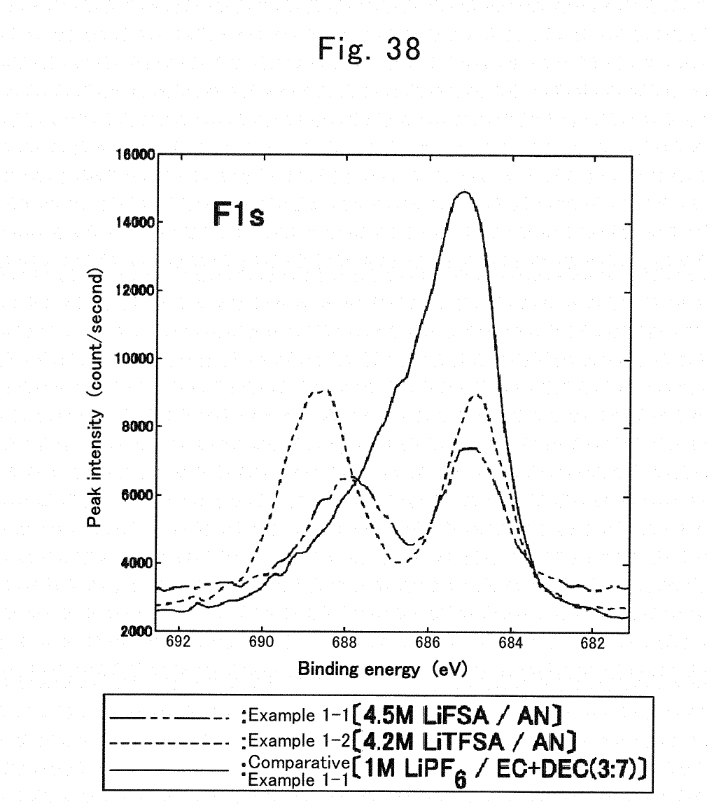

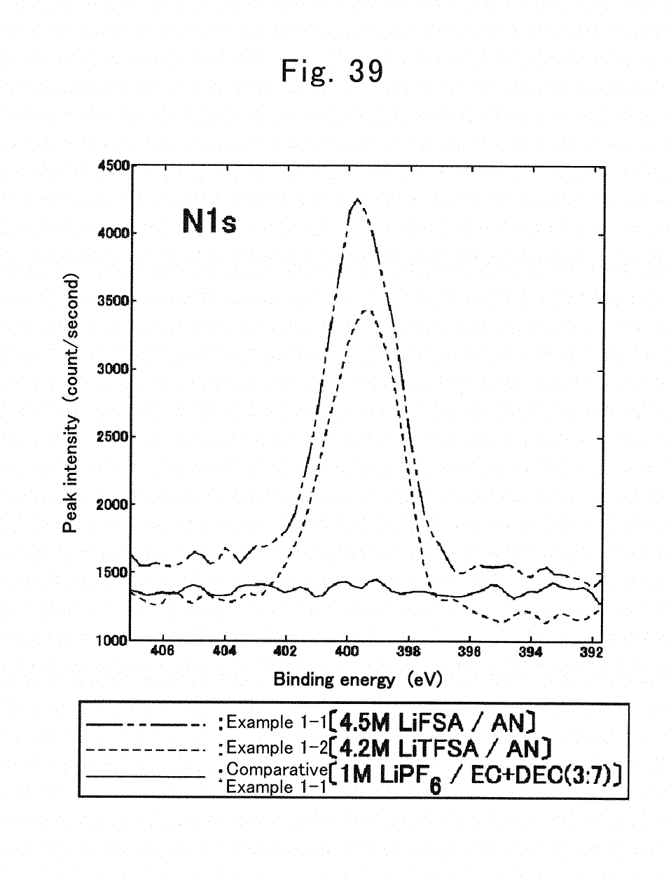

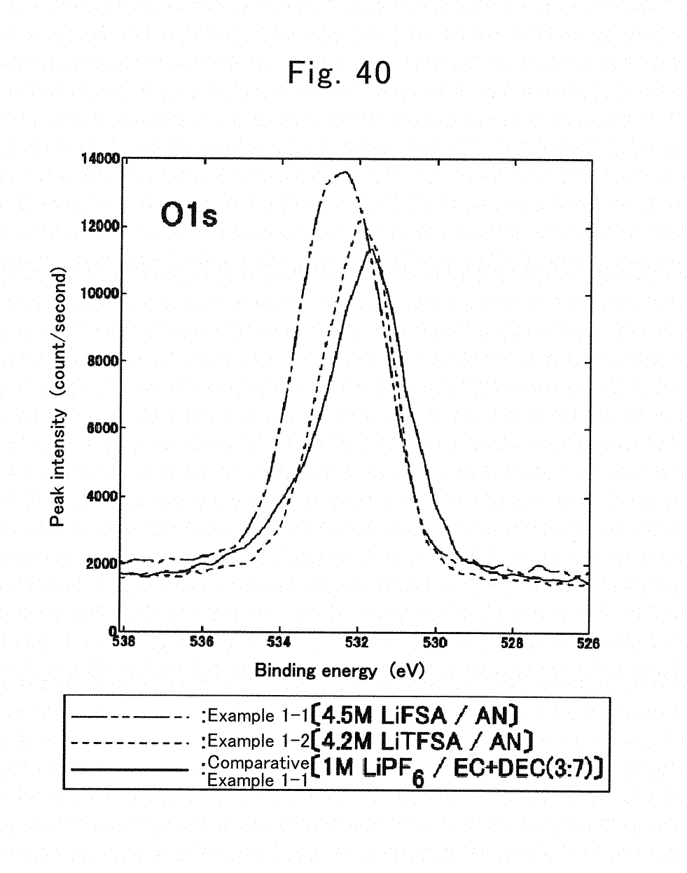

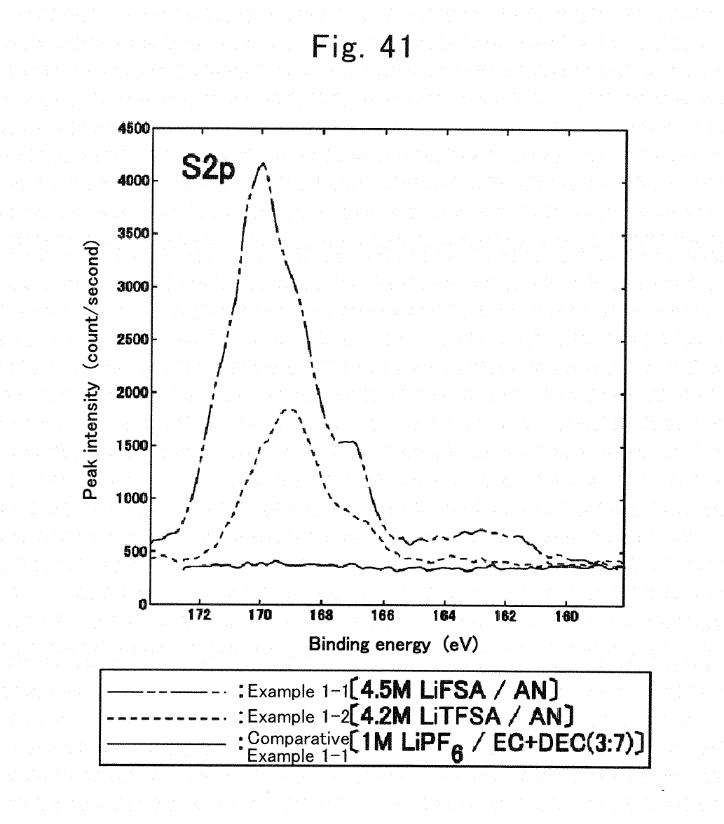

With respect to the nonaqueous electrolyte secondary batteries of Examples 1-1 and 1-2 and Comparative Example 1-1, charging and discharging were repeated for 100 cycles, and analysis of the surfaces of the S,O-containing coating or the coating was performed using X-ray photoelectron spectroscopy (XPS) at a discharged state with a voltage of 3.0 V. As a pre-treatment, the following treatment was performed. First, the nonaqueous electrolyte secondary battery was disassembled to extract a negative electrode, and the negative electrode was rinsed and dried to obtain the negative electrode that is a subject for analysis. The rinsing was performed for three times using DMC (dimethyl carbonate). In addition, all the steps, from disassembling the cell to transporting the negative electrode as the subject for analysis into an analysis device, were performed under an Ar gas atmosphere without exposing the negative electrode to air. The pre-treatment described below was performed on each of the nonaqueous electrolyte secondary batteries of Examples 1-1 and 1-2 and Comparative Example 1-1, and XPS analysis was performed on an obtained negative electrode sample. As the device, PHI 5000 VersaProbe II of ULVAC-PHI, Inc., was used. The X-ray source was monochromatic Al K-alpha radiation (15 kV, 10 mA). The analysis results of the negative-electrode S,O-containing coatings of Examples 1-1 and 1-2 and the negative-electrode coating of Comparative Example 1-1 measured through XPS are shown in FIGS. 37 to 41. Specifically, FIG. 37 shows the results of analysis regarding carbon element, FIG. 38 shows the results of analysis regarding fluorine element, FIG. 39 shows the results of analysis regarding nitrogen element, FIG. 40 shows the results of analysis regarding oxygen element, and FIG. 41 shows the results of analysis regarding sulfur element.

The electrolytic solution in the nonaqueous electrolyte secondary battery of Example 1-1 and the electrolytic solution in the nonaqueous electrolyte secondary battery of Example 1-2 include sulfur element (S), oxygen element, and nitrogen element (N) in the salts. On the other hand, the electrolytic solution in the nonaqueous electrolyte secondary battery of Comparative Example 1-1 does not include these in the salt. Furthermore, the electrolytic solutions in the nonaqueous electrolyte secondary batteries of Examples 1-1 and 1-2 and Comparative Example 1-1 all include fluorine element (F), carbon element (C), and oxygen element (O) in the salts.

As shown in FIGS. 37 to 41, as a result of the analysis on the negative-electrode S,O-containing coating of Example 1-1 and the negative-electrode S,O-containing coating of Example 1-2, a peak indicating the existence of S (FIG. 41) and a peak indicating the existence of N (FIG. 39) were observed. Thus, the negative-electrode S,O-containing coating of Example 1-1 and the negative-electrode S,O-containing coating of Example 1-2 included S and N. However, these peaks were not identified in the analysis results of the negative-electrode coating of Comparative Example 1-1. Thus, the negative-electrode coating of Comparative Example 1-1 did not include any of S and N at an amount equal to or more than a detection limit. The peaks indicating the existence of F, C, and O were observed in all the analysis results regarding the negative-electrode S,O-containing coatings of Examples 1-1 and 1-2, and the negative-electrode coating of Comparative Example 1-1. Thus, the negative-electrode S,O-containing coatings of Examples 1-1 and 1-2 and the negative-electrode coating of Comparative Example 1-1 all included F, C, and O.

These elements are all components derived from the electrolytic solution. In particular, S, O, and F are components included in the metal salt of the electrolytic solution, more specifically, components included in the chemical structure of the anion of the metal salt. Based on these results, the negative-electrode S,O-containing coatings and the negative-electrode coatings are understood as to include components derived from the chemical structure of the anion of the metal salt (i.e., supporting salt).

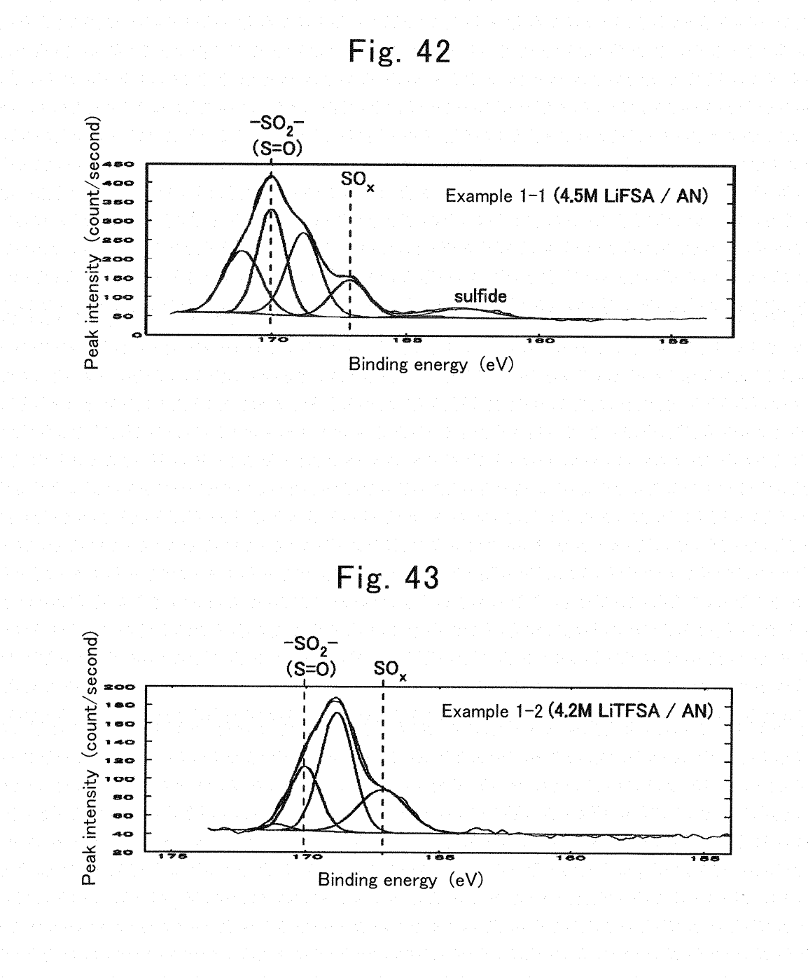

Detailed analysis was further performed on the analysis result regarding sulfur element (S) shown in FIG. 41. With respect to the analysis result of Examples 1-1 and 1-2, peak resolution was performed using mixed Gaussian/Lorentzian function. The analysis results of Examples 1-1 and 1-2 are respectively shown in FIGS. 42 and 43.

As shown in FIGS. 42 and 43, as a result of analyzing the negative-electrode S,O-containing coatings of Examples 1-1 and 1-2, a relatively large peak (waveform) was observed at around 165 to 175 eV. Then, as shown in FIGS. 42 and 43, this peak (waveform) at around 170 eV was separated into four peaks. Among these, one is a peak around 170 eV indicating the existence of SO₂ (S═O structure). Based on this result, the S,O-containing coating formed on the surface of the negative electrode in the nonaqueous electrolyte secondary battery of the present invention is considered to have a S═O structure. When this result and the XPS analysis results described above are considered, S included in the S═O structure of the S,O-containing coating is speculated to be S included in the chemical structure of the anion of the metal salt, i.e., supporting salt.

(S Element Ratio in Negative-Electrode S,O-Containing Coating)

Based on the XPS analysis results of the negative-electrode S,O-containing coatings described above, the ratio of S element at the discharged state in the negative-electrode S,O-containing coatings of Example 1-1 and Example 1-2 and the negative-electrode coating of Comparative Example 1-1 were calculated. Specifically, with respect to each of the negative-electrode S,O-containing coatings and the negative-electrode coating, the element ratio of S was calculated when the total of peak intensities of S, N, F, C, and O was defined as 100%. The results are shown in Table 12.

TABLE 12

| | Example 1-1 | Example 1-2 | Comparative Example 1-1 |
|---|---|---|---|
| S element | 10.4 | 3.7 | 0.0 |
| ratio (at. %) | | | |

As described above, although the negative-electrode coating of Comparative Example 1-1 did not include S at an amount equal to or more than the detection limit, S was detected in the negative-electrode S,O-containing coating of Example 1-1 and the negative-electrode S,O-containing coating of Example 1-2. In addition, the negative-electrode S,O-containing coating of Example 1-1 included more S than the negative-electrode S,O-containing coating of Example 1-2. Since S was not detected in the negative-electrode S,O-containing coating of Comparative Example 1-1, S included in the negative-electrode S,O-containing coating of each of the Examples is said to be derived not from unavoidable impurities and other additives included in the positive electrode active material but from the metal salt in the electrolytic solution.

Since the S element ratio in the negative-electrode S,O-containing coating of Example 1-1 was 10.4 at. % and the S element ratio in the negative-electrode S,O-containing coating of Example 1-2 was 3.7 at. %; in the nonaqueous electrolyte secondary battery of the present invention, the S element ratio in the negative-electrode S,O-containing coating is not lower than 2.0 at. %, preferably not lower than 2.5 at. %, more preferably not lower than 3.0 at. %, and further preferably not lower than 3.5 at. %. The element ratio (at. %) of S refers to a peak intensity ratio of S when the total of peak intensities of S, N, F, C, and O was defined as 100%. Although the upper limit value of the element ratio of S is not determined in particular, a ratio not higher than 25 at. % is preferable.

(Thickness of Negative-Electrode S,O-Containing Coating)

With respect to the nonaqueous electrolyte secondary battery of Example 1-1, one that was set in a discharged state with a voltage of 3.0 V after charging and discharging were repeated for 100 cycles, and one that was set in a charged state with a voltage of 4.1 V after charging and discharging were repeated for 100 cycles were prepared, and negative electrode samples that were subject for analysis were obtained with a method similar to the pre-treatment in the XPS analysis described above. By performing FIB (Focused Ion Beam) processing on the obtained negative electrode samples, samples, having a thickness of about 100 nm, for STEM analysis were obtained. As a pre-treatment for the FIB processing, Pt was vapor-deposited on the negative electrode. The steps above were performed without exposing the negative electrode to air.

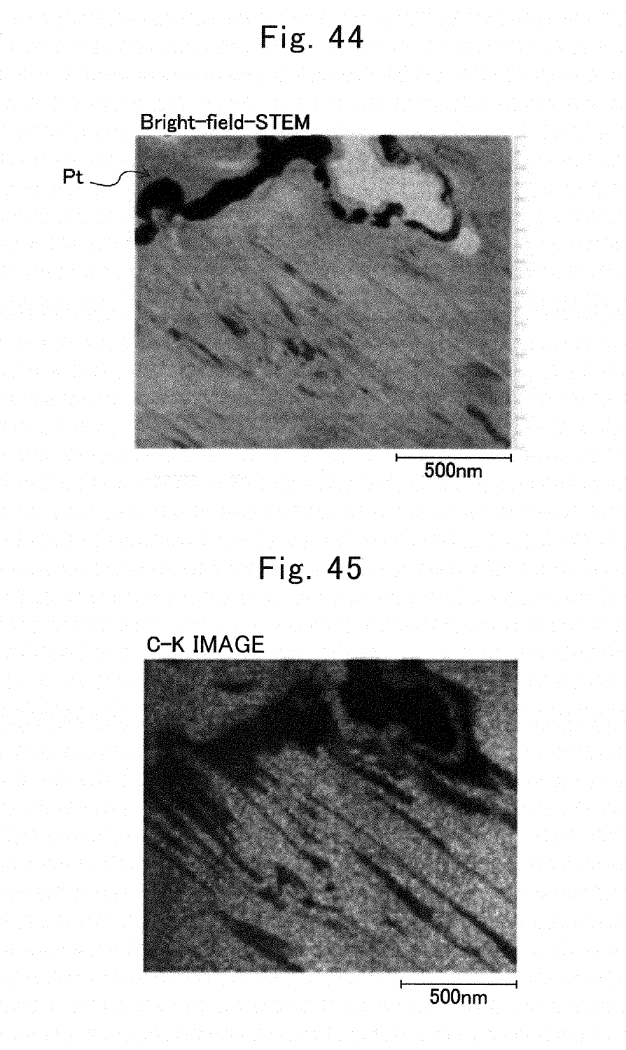

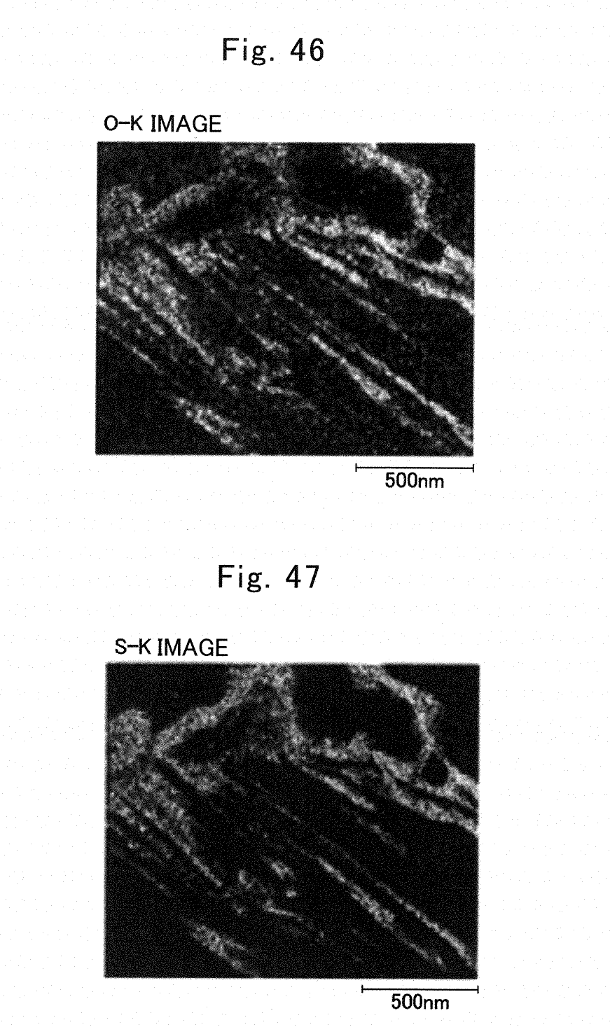

Each of the samples for STEM analysis was analyzed using a STEM (Scanning Transmission Electron Microscope) to which an EDX (Energy Dispersive X-ray spectroscopy) device was attached. The results are shown in FIGS. 44 to 47. Of these, FIG. 44 is a BF (Bright-field)-STEM image, and FIGS. 45 to 47 are element distribution images obtained using the SETM-EDX in the observation area identical to that in FIG. 44. FIG. 45 shows the results of analysis regarding C, FIG. 46 shows the results of analysis regarding O, and FIG. 47 shows the results of analysis regarding S. FIGS. 45 to 47 are analysis results of the negative electrode in the nonaqueous electrolyte secondary battery in the discharged state.

As show in FIG. 44, a black portion exists in the upper left part of the STEM image. The black portion is derived from Pt that has been vapor-deposited in the pre-treatment of the FIB processing. In each of the STEM images, a portion above the portion derived from Pt (referred to as Pt part) is regarded as a portion that was tainted after vapor deposition of Pt. Thus, in FIGS. 45 to 47, only the portion below the Pt part was studied.

As shown in FIG. 45, C formed a layer below the Pt part. This is considered as a layer structure of graphite which is the negative electrode active material. In FIG. 46, O was found at portions corresponding to the outer circumference and interlayer of graphite. Also in FIG. 47, S was found at portions corresponding to the outer circumference and interlayer of graphite. Based on these results, the negative-electrode S,O-containing coating including S and O such as a S═O structure is speculated to be formed on the surface and interlayer of graphite.

Ten parts of the negative-electrode S,O-containing coating formed on the surface of graphite were randomly selected, and thicknesses of the negative-electrode S,O-containing coating were measured to calculate an average value of the measured values. The negative electrode in the nonaqueous electrolyte secondary battery in a charged state was also analyzed similarly, and, based on the analysis results, an average value of the thickness of the negative-electrode S,O-containing coating formed on the surface of graphite was calculated. The results are shown in Table 13.

TABLE 13

| | Negative-electrode S,O-containing | |
|---|---|---|
| | coating of Example 1-1 | |
| | Discharged state | Charged state |
| | (3.0 V) | (4.1 V) |
| Thickness of negative-electrode | 40 | 48 |
| S,O-containing coating (nm) | | |

As shown in Table 13, the thickness of the negative-electrode S,O-containing coating increased after charging. Based on this result, in the negative-electrode S,O-containing coating, a fixed portion that exists stably against charging and discharging and an adsorption portion that increases or decreases associated with charging and discharging are speculated to exist. The negative-electrode S,O-containing coating is speculated to increase or decrease in thickness upon charging and discharging because the adsorption portion exists.

(Analysis of Positive-Electrode Coating)

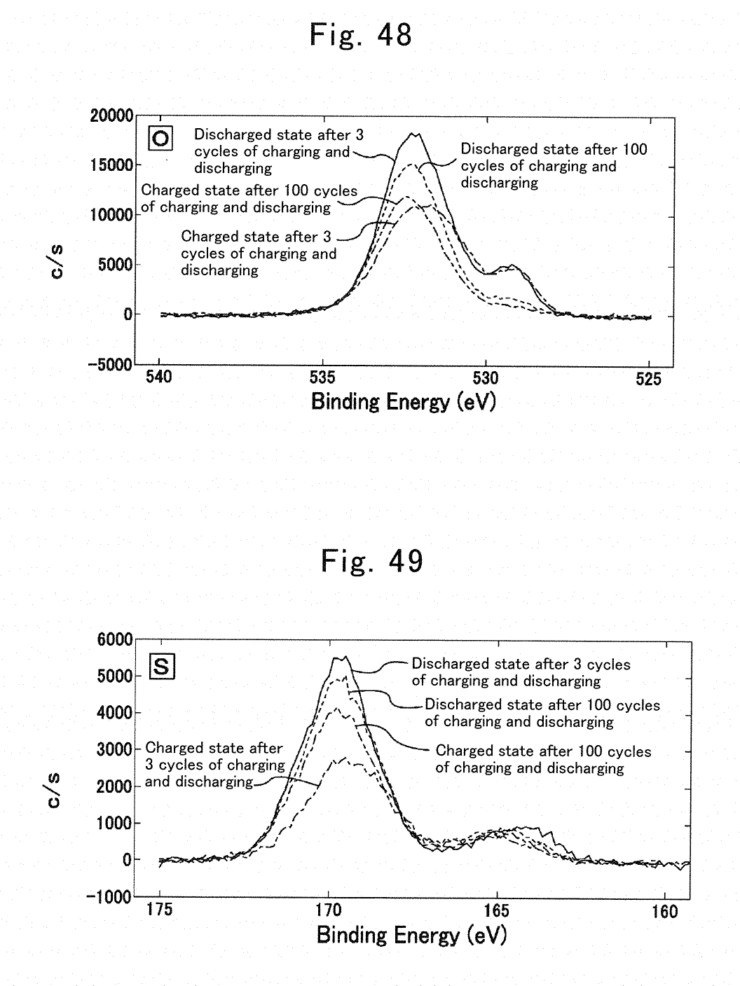

With respect to the nonaqueous electrolyte secondary battery of Example 1-1, the following four were prepared: one that was set in a discharged state with a voltage of 3.0 V after charging and discharging were repeated for 3 cycles; one that was set in a charged state with a voltage of 4.1 V after charging and discharging were repeated for 3 cycles; one that was set in a discharged state with a voltage of 3.0 V after charging and discharging were repeated for 100 cycles; and one that was set in a charged state with a voltage of 4.1 V after charging and discharging were repeated for 100 cycles. With respect to each of the four nonaqueous electrolyte secondary batteries of Example 1-1, a positive electrode that was the subject for analysis was obtained using a method similar to that described above. Then, XPS analysis was performed on the obtained positive electrodes. The results are shown in FIGS. 48 and 49. FIG. 48 shows the results of analysis regarding oxygen element, and FIG. 49 shows the results of analysis regarding sulfur element.

As shown in FIGS. 48 and 49, the positive-electrode S,O-containing coating of Example 1-1 is also understood as to include S and O. In addition, since a peak around 170 eV was observed in FIG. 49, the positive-electrode S,O-containing coating of Example 1-1 is understood as to include a S═O structure derived from the electrolytic solution of the present invention, similarly to the negative-electrode S,O-containing coating of Example 1-1.

As shown in FIG. 48, the height of a peak existing around 529 eV was decreased after the cycles. This peak is thought to show existence of O derived from the positive electrode active material, and, more specifically, is thought to be a result of a photoelectron excited by an O atom in the positive electrode active material passing the S,O-containing coating and being detected in the XPS analysis. Since the peak was decreased after the cycles, the thickness of the S,O-containing coating formed on the surface of the positive electrode is thought to have increased associated with the cycles.

As shown in FIGS. 48 and 49, O and S in the positive-electrode S,O-containing coating increased at the discharged state and decreased at the charged state. Based on this result, O and S are thought to move in and out of the positive-electrode S,O-containing coating in association with charging and discharging. Based on this, associated with charging and discharging, the concentration of S and O in the positive-electrode S,O-containing coating is speculated to increase and decrease, or, similarly to the negative-electrode S,O-containing coating, the thickness is speculated to increase and decrease also in the positive-electrode S,O-containing coating due to existence of the adsorption portion.

In addition, XPS analysis was performed on the positive-electrode S,O-containing coating and the negative-electrode S,O-containing coating in the nonaqueous electrolyte secondary battery of Example 1-4.

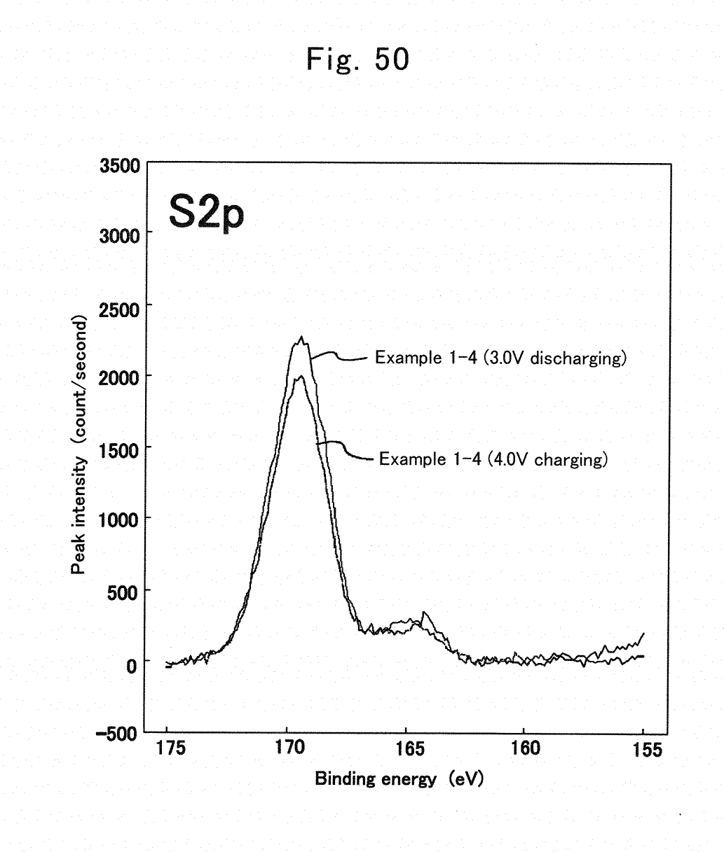

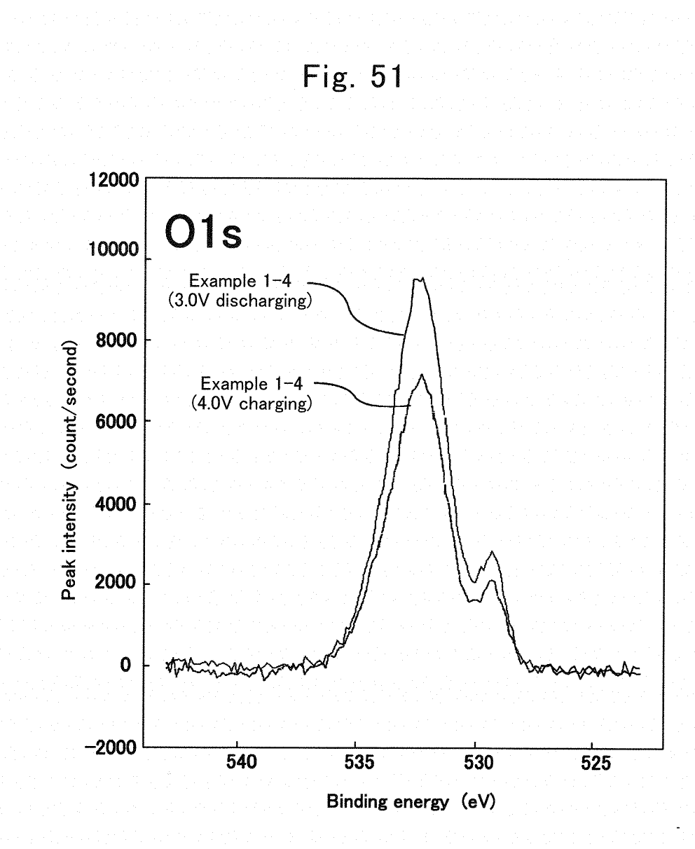

By using the nonaqueous electrolyte secondary battery of Example 1-4, CC charging and discharging were repeated for 500 cycles at a rate of 1 C at 25° C. in a usage voltage range of 3.0 V to 4.1 V. After 500 cycles, XPS spectra of the positive-electrode S,O-containing coating at a discharged state of 3.0 V and a charged state of 4.0 V were measured. In addition, with respect to the negative-electrode S,O-containing coating in the discharged state of 3.0 V before the cycle test (i.e., after the first charging and discharging) and the negative-electrode S,O-containing coating in the discharged state of 3.0 V after 500 cycles; elemental analysis using XPS was performed and the ratios of S element contained in the negative-electrode S,O-containing coatings were calculated. FIGS. 50 and 51 show the analysis results of the positive-electrode S,O-containing coating of Example 1-4 measured through XPS. Specifically, FIG. 50 shows the results of analysis regarding sulfur element, and FIG. 51 shows the results of analysis regarding oxygen element. In addition, Table 14 shows the S element ratio (at. %) of the negative-electrode coating measured through XPS. The S element ratio was calculated similarly to that in the above described section of “S element ratio of negative-electrode S,O-containing coating.”

As shown in FIGS. 50 and 51, also from the positive-electrode S,O-containing coating in the nonaqueous electrolyte secondary battery of Example 1-4, a peak indicating the existence of S and a peak indicating the existence of O were detected. In addition, both the peak of S and the peak of O increased at the discharged state and decreased at the charged state. This result also confirms the positive-electrode S,O-containing coating having the S═O structure, and O and S in the positive-electrode S,O-containing coating moving in and out of the positive-electrode S,O-containing coating in association with charging and discharging.

TABLE 14
<S element ratio of negative-electrode S,O-containing coating>

| | After first charging and | After 500 |
|---|---|---|
| | discharging | cycles |
| S element ratio | 3.1 | 3.8 |
| (at. %) | | |

In addition, as shown in Table 14, the negative-electrode S,O-containing coating of Example 1-4 included S by not less than 2.0 at. % after the first charging and discharging and also after 500 cycles. From this result, the negative-electrode S,O-containing coating of the nonaqueous electrolyte secondary battery of the present invention is understood as to include S by not less than 2.0 at. % in both before the cycles and after the cycles.

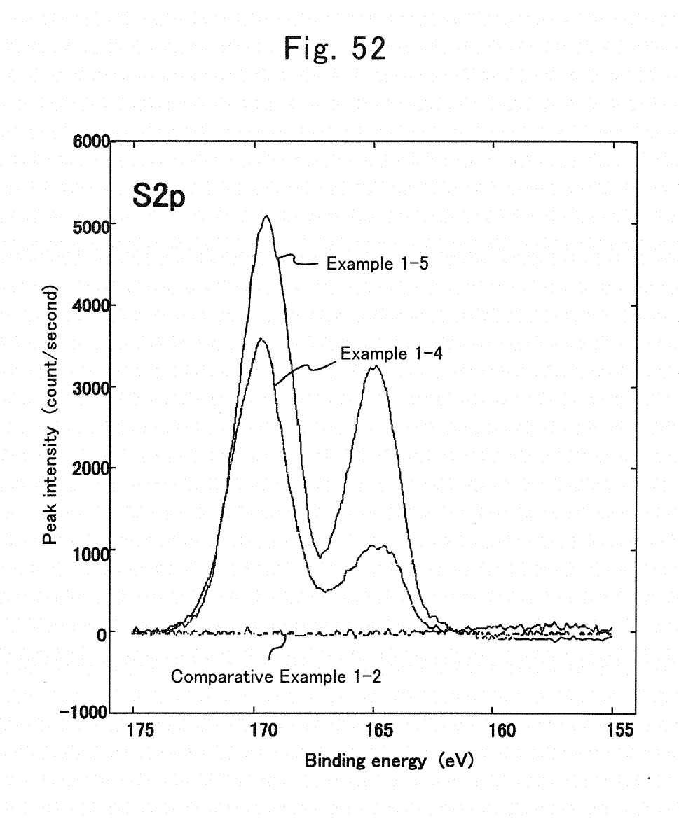

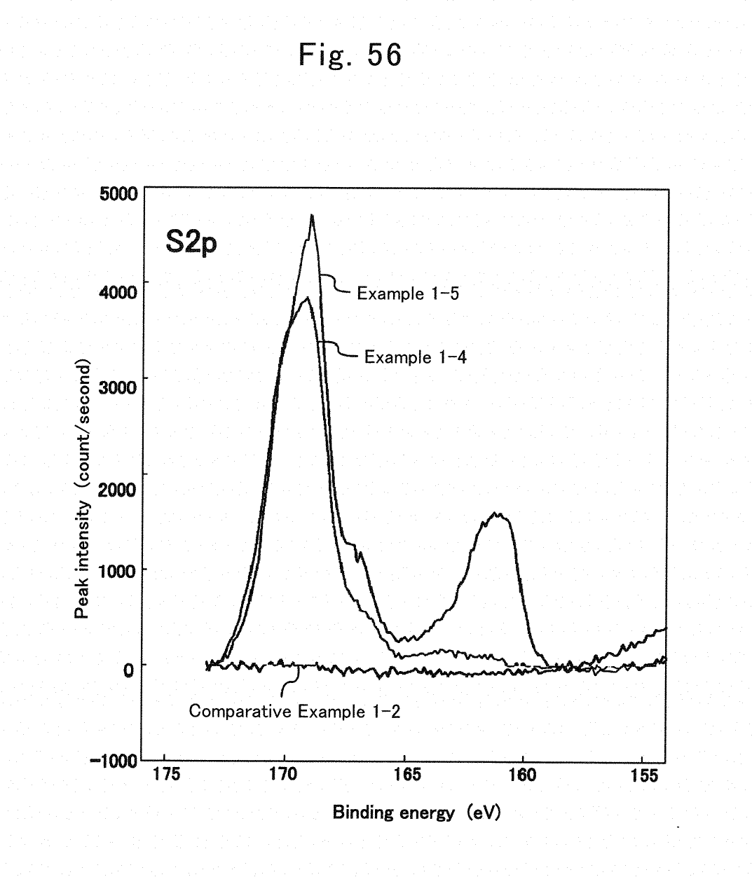

With respect to the nonaqueous electrolyte secondary batteries of Examples 1-4 to 1-7, and Comparative Examples 1-2 and 1-3, a high-temperature storage test of storing at 60° C. for 1 week was performed. After the high-temperature storage test, the positive-electrode S,O-containing coatings and the negative-electrode S,O-containing coatings of respective Examples and the positive-electrode coating and the negative-electrode coating of respective Comparative Examples were analyzed. Before starting the high-temperature storage test, CC-CV charging was performed at a rate of 0.33 C from 3.0 V to 4.1 V. The charge capacity at this time was used as a standard (SOC100), and a portion of 20% with respect to this standard was CC discharged to adjust each of the batteries to SOC80, and the high-temperature storage test was started. After the high-temperature storage test, CC-CV discharging to 3.0 V was performed at 1 C. After the discharging, XPS spectra of the positive-electrode S,O-containing coatings, the negative-electrode S,O-containing coatings, the positive-electrode coatings, and the negative-electrode coatings were measured. FIGS. 52 to 55 show analysis results of the positive-electrode S,O-containing coatings of Examples 1-4 to 1-7 and the positive-electrode coatings of Comparative Examples 1-2 and 1-3 measured through XPS. In addition, FIG. 56 to FIG. 52 show analysis results of the negative-electrode S,O-containing coatings of Examples 1-4 to 1-7 and the negative-electrode coatings of Comparative Examples 1-2 and 1-3 measured through XPS.

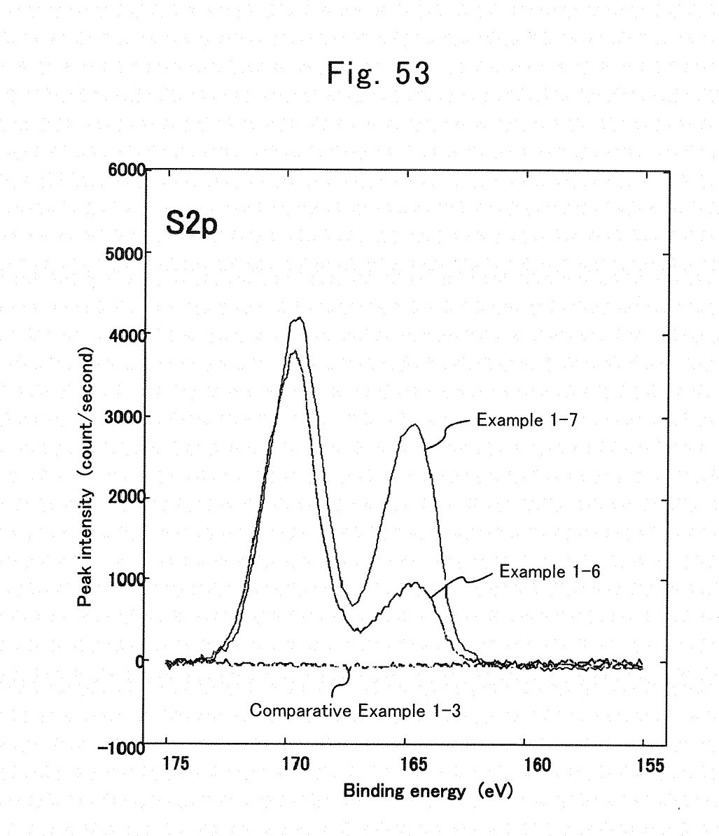

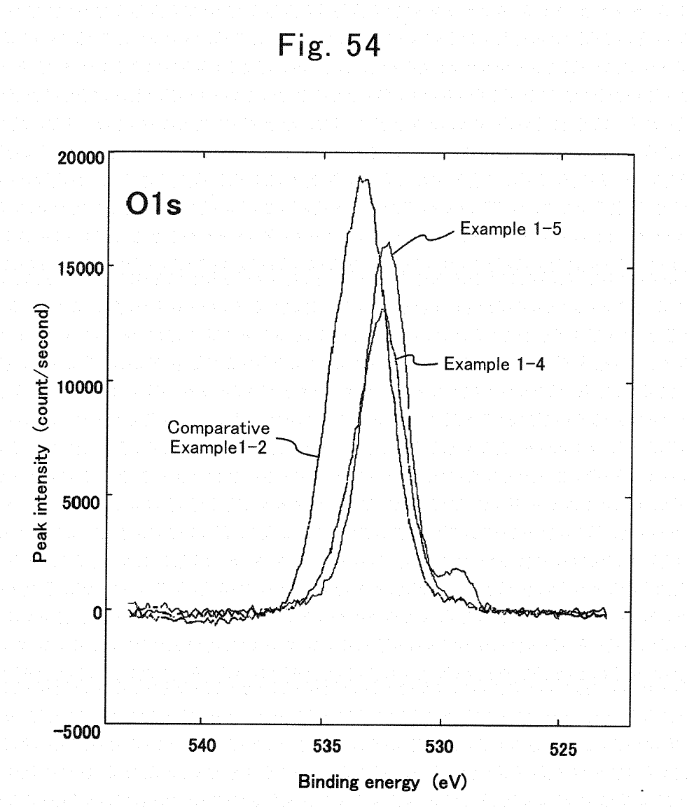

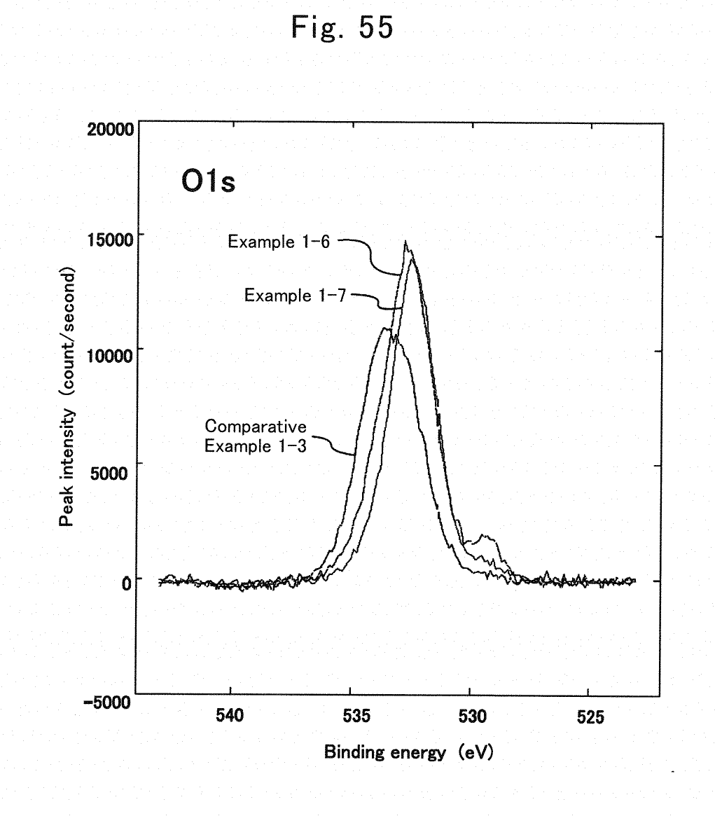

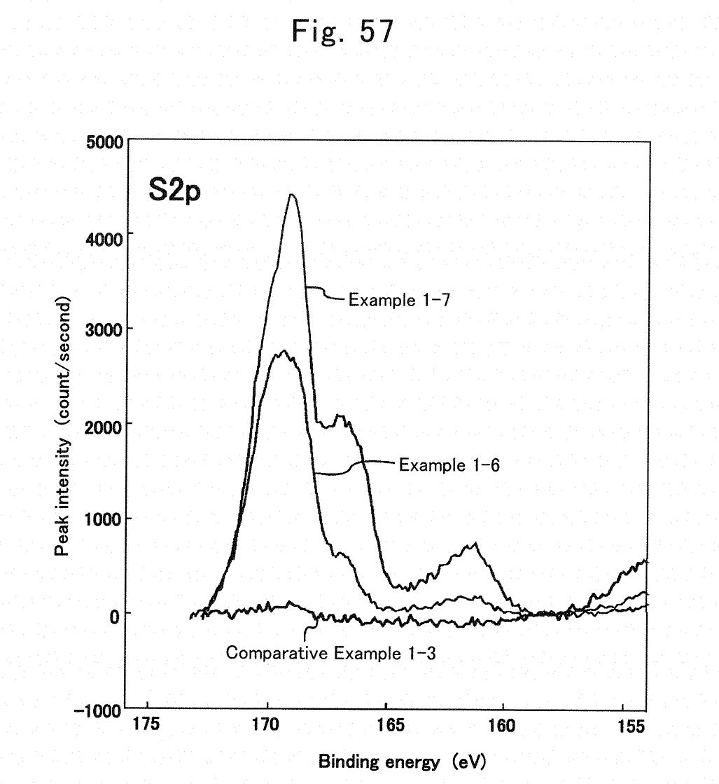

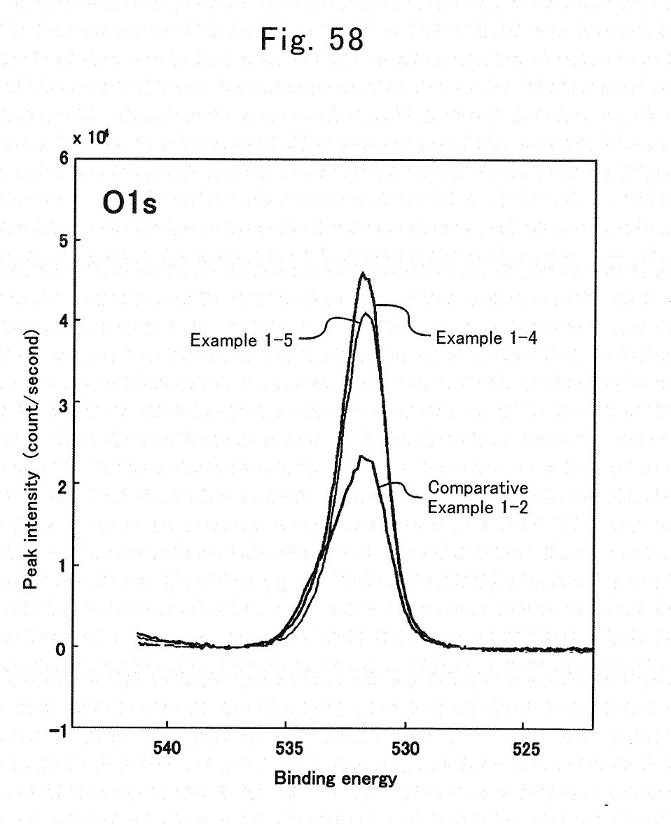

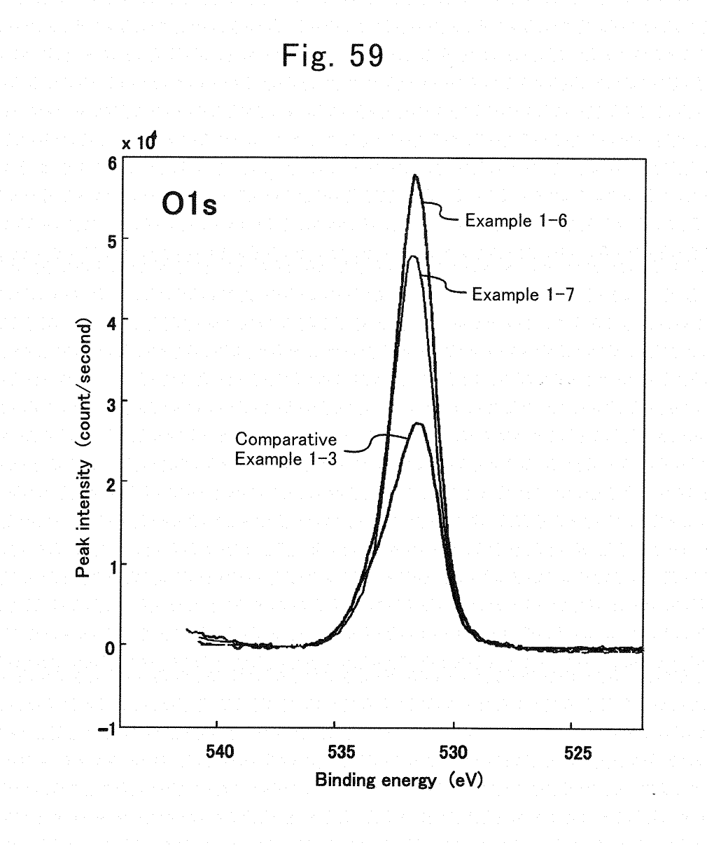

Specifically, FIG. 52 shows the results of analysis regarding sulfur element in the positive-electrode S,O-containing coatings of Examples 1-4 and 1-5 and the positive-electrode coating of Comparative Example 1-2. FIG. 53 shows the results of analysis regarding sulfur element in the positive-electrode S,O-containing coatings of Examples 1-6 and 1-7 and the positive-electrode coating of Comparative Example 1-3. FIG. 54 shows the results of analysis regarding oxygen element in the positive-electrode S,O-containing coatings of Examples 1-4 and 1-5 and the positive-electrode coating of Comparative Example 1-2. FIG. 55 shows the results of analysis regarding oxygen element in the positive-electrode S,O-containing coatings of Examples 1-6 and 1-7 and the positive-electrode coating of Comparative Example 1-3. FIG. 56 shows the results of analysis regarding sulfur element in the negative-electrode S,O-containing coatings of Examples 1-4 and 1-5 and the negative-electrode coating of Comparative Example 1-2. FIG. 57 shows the results of analysis regarding sulfur element in the negative-electrode S,O-containing coatings of Examples 1-6 and 1-7 and the negative-electrode coating of Comparative Example 1-3. FIG. 58 shows the results of analysis regarding oxygen element in the negative-electrode S,O-containing coatings of Examples 1-4 and 1-5 and the negative-electrode coating of Comparative Example 1-2. FIG. 59 shows the results of analysis regarding oxygen element in the negative-electrode S,O-containing coatings of Examples 1-6 and 1-7 and the negative-electrode coating of Comparative Example 1-3.

As shown in FIGS. 52 and 53, although the nonaqueous electrolyte secondary batteries of Comparative Examples 1-2 and 1-3 using the conventional electrolytic solution did not include S in the positive-electrode coatings, the nonaqueous electrolyte secondary batteries of Examples 1-4 to 1-7 using the electrolytic solution of the present invention included S in the positive-electrode S,O-containing coatings. As shown in FIGS. 54 and 55, all the nonaqueous electrolyte secondary batteries of Examples 1-4 to 1-7 included O in the positive-electrode S,O-containing coating. Furthermore, as shown in FIGS. 52 and 53, from all the positive-electrode S,O-containing coatings of the nonaqueous electrolyte secondary batteries of Examples 1-4 to 1-7, a peak of around 170 eV indicating the existence of SO₂ (S═O structure) was detected. From these results, with the nonaqueous electrolyte secondary battery of the present invention, in both when AN was used and when DMC was used as the organic solvent for the electrolytic solution, a stable positive-electrode S,O-containing coating that includes S and O is understood as to be formed. In addition, since the positive-electrode S,O-containing coating is not affected by the type of the negative electrode binding agent, O in the positive-electrode S,O-containing coating is thought to be not derived from CMC. Furthermore, as shown in FIGS. 54 and 55, when DMC was used as the organic solvent for the electrolytic solution, a peak of O derived from the positive electrode active material was detected at around 530 eV. Thus, when DMC was used as the organic solvent for the electrolytic solution, the thickness of the positive-electrode S,O-containing coating is thought to be smaller compared to when AN was used.

Similarly, as shown in FIGS. 56 to 59, the nonaqueous electrolyte secondary batteries of Examples 1-4 to 1-7 are understood as to each include S and O also in the negative-electrode S,O-containing coating, and these are understood as to form a S═O structure and be derived from the electrolytic solution. In addition, the negative-electrode S,O-containing coating is understood as to be formed in both when AN was used and when DMC was used as the organic solvent for the electrolytic solution.

With respect to the nonaqueous electrolyte secondary batteries of Examples 1-4 and 1-5 and Comparative Example 1-2, after the high-temperature storage test and discharging, XPS spectra of the respective negative-electrode S,O-containing coatings and the negative-electrode coatings were measured, and the ratio of S element at the discharged state was calculated in each of the negative-electrode S,O-containing coating of Examples 1-4 and 1-5 and the negative-electrode coating of Comparative Example 1-2. Specifically, with respect to each of the negative-electrode S,O-containing coatings or the negative-electrode coatings, an element ratio of S when the total peak intensity of S, N, F, C, and O was defined as 100% was calculated. The results are shown in Table 15.

TABLE 15

| | | | Comparative |
|---|---|---|---|
| | Example 1-4 | Example 1-5 | Example 1-2 |
| S element ratio (at. %) | 4.2 | 6.4 | 0.0 |

As shown in Table 15, although the negative-electrode coating of Comparative Example 1-2 did not include S at an amount equal to or more than the detection limit, S was detected in the negative-electrode S,O-containing coatings of Examples 1-4 and 1-5. In addition, the negative-electrode S,O-containing coating of Example 1-5 included more S than the negative-electrode S,O-containing coating of Example 1-4. From this result, the S element ratio in the negative-electrode S,O-containing coating is understood as to be not lower than 2.0 at. % even after high temperature storage.

### Evaluation Example 13: Internal Resistance of Battery

The nonaqueous electrolyte secondary batteries of Examples 1-4, 1-5, and 1-8 and Comparative Example 1-2 were prepared, and internal resistances of the batteries were evaluated.

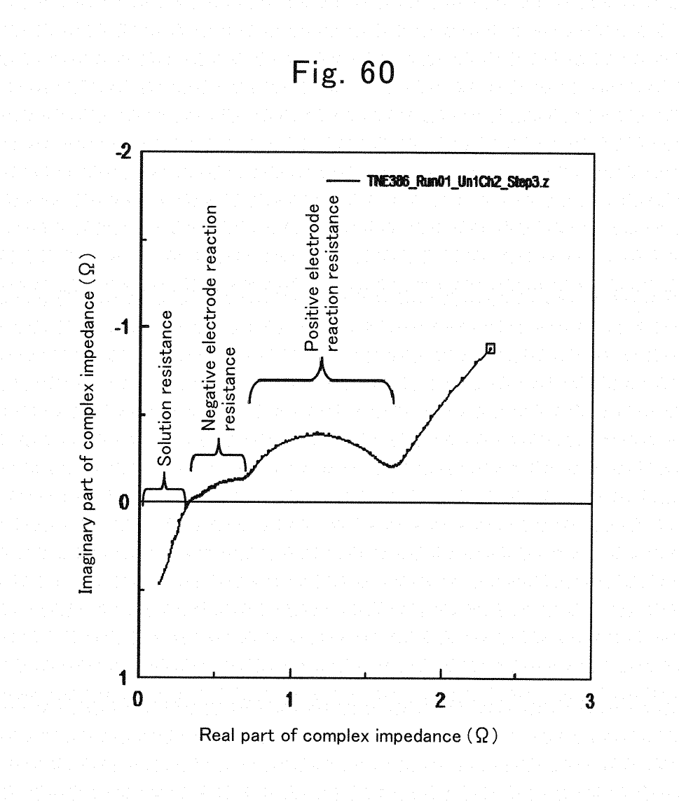

With each of the nonaqueous electrolyte secondary batteries of Examples 1-4, 1-5, and 1-8 and Comparative Example 1-2, CC charging and discharging, i.e., constant current charging and discharging, were repeated at room temperature in a range of 3.0 V to 4.1 V (vs. Li reference). Then, an alternating current impedance after the first charging and discharging and an alternating current impedance after 100 cycles were measured. Based on obtained complex impedance planar plots, reaction resistances of electrolytic solutions, negative electrodes, and positive electrodes were each analyzed. As shown in FIG. 60, two circular arcs were observed in a complex impedance planar plot. A circular arc on the left side of the figure (i.e., a side in which the real part of complex impedance is smaller) is referred to as a first circular arc. A circular arc on the right side of the figure is referred to as a second circular arc. Reaction resistance of a negative electrode was analyzed based on the size of the first circular arc, and reaction resistance of a positive electrode was analyzed based on the size of the second circular arc. Resistance of an electrolytic solution was analyzed based on a plot continuing from the first circular arc toward the leftmost side in FIG. 60. The analysis results are shown in Tables 16 and 17. Table 16 shows a resistance of an electrolytic solution (i.e., solution resistance), a reaction resistance of a negative electrode, and a reaction resistance of a positive electrode after the first charging and discharging. Table 17 shows respective resistances after 100 cycles.

TABLE 16
<Initial alternating-current resistance>

Unit: Ω

| | | | | | Compar- |
|---|---|---|---|---|---|
| | | | | | ative |
| | | Example | Example | Example | Example |
| | | 1-4 | 1-5 | 1-8 | 1-2 |
| Electrolytic | Organic | DMC | AN | DMC | EC/DEC |
| solution | solvent | | | | |
| | Metal salt | LiFSA | LiFSA | LiFSA | LiPF₆ |

| | | | | |
|---|---|---|---|---|
| Solution resistance | 0.5 | 0.3 | 0.4 | 0.3 |
| Negative-electrode | 0.5 | 0.4 | 0.4 | 0.4 |
| reaction resistance | | | | |
| Positive-electrode | 0.5 | 0.1 | 0.5 | 1.0 |
| reaction resistance | | | | |

TABLE 17
<Alternating-current resistance after 100 cycles>

Unit: Ω

| | | | | | Compar- |
|---|---|---|---|---|---|
| | | | | | ative |
| | | Example | Example | Example | Example |
| | | 1-4 | 1-5 | 1-8 | 1-2 |
| Electrolytic | Organic | DMC | AN | DMC | EC/DEC |
| solution | solvent | | | | |
| | Metal salt | LiFSA | LiFSA | LiFSA | LiPF₆ |

| | | | | |
|---|---|---|---|---|
| Solution resistance | 0.5 | 0.3 | 0.3 | 0.3 |
| Negative-electrode | 0.4 | 0.2 | 0.3 | 0.4 |
| reaction resistance | | | | |
| Positive-electrode | 0.2 | 0.3 | 0.2 | 0.6 |
| reaction resistance | | | | |
| Durability | AA | A | AA | B |

As shown in Tables 16 and 17, in each of the nonaqueous electrolyte secondary batteries, the reaction resistances of the negative and positive electrodes tended to decrease after 100 cycles when compared to the respective resistances after the first charging and discharging. After 100 cycles as shown in Table 17, the reaction resistances of the negative and positive electrodes of the nonaqueous electrolyte secondary batteries of the Examples were lower when compared to the reaction resistances of the negative and positive electrodes of the nonaqueous electrolyte secondary battery of Comparative Example 1-2.

As described above, the nonaqueous electrolyte secondary batteries of Examples 1-4, 1-5, and 1-8 use the electrolytic solution of the present invention, and S,O-containing coatings derived from the electrolytic solution of the present invention were formed on the surfaces of the negative electrodes and the positive electrodes. On the other hand, the nonaqueous electrolyte secondary battery of Comparative Example 1-2 in which the electrolytic solution of the present invention was not used, the S,O-containing coating was not formed on the surfaces of the negative electrode and the positive electrode. As shown in Table 17, the reaction resistances of the negative and positive electrodes of Examples 1-4, 1-5, and 1-8 were lower than that of the nonaqueous electrolyte secondary battery of Comparative Example 1-2. Based on this, in each of the Examples, the reaction resistances of the negative and positive electrodes are speculated to be lowered because of the existence of the S,O-containing coating derived from the electrolytic solution of the present invention.

The solution resistances of the electrolytic solutions in the nonaqueous electrolyte secondary battery of Example 1-5 and Comparative Example 1-2 were almost identical, whereas the solution resistances of the electrolytic solutions in the nonaqueous electrolyte secondary batteries of Example 1-4 and Example 1-8 were higher compared to those in Example 1-5 and Comparative Example 1-2. In addition, the solution resistance of each of the electrolytic solutions of the nonaqueous electrolyte secondary batteries was almost identical between after the first charging and discharging and after 100 cycles. Thus, deterioration in durability is considered not to be occurring in each of the electrolytic solutions. The difference that emerged between the reaction resistances of the negative and positive electrodes in the Comparative Examples and Examples is considered to be occurring in the electrode itself and not related to deterioration in durability of the electrolytic solution.

Internal resistance of a nonaqueous electrolyte secondary battery is comprehensively determined from a solution resistance of an electrolytic solution, a reaction resistance of a negative electrode, and a reaction resistance of a positive electrode. Based on the results of Tables 16 and 17 and from a standpoint of suppressing an increase in internal resistance of a nonaqueous electrolyte secondary battery, the nonaqueous electrolyte secondary batteries of Examples 1-4 and 1-8 are considered to excel the most particularly in terms of durability, and the nonaqueous electrolyte secondary battery of Example 1-5 is considered to excel the next in terms of durability.

### Evaluation Example 14: Cycle Durability of Battery

With respect to the nonaqueous electrolyte secondary batteries of Examples 1-4, 1-5, and 1-8 and Comparative Example 1-2, CC charging and discharging were repeated at room temperature in a range of 3.0 V to 4.1 V (vs. Li reference), and a discharge capacity at the first charging and discharging, a discharge capacity at the 100-th cycle, and a discharge capacity at the 500-th cycle were measured. When a capacity of each of the nonaqueous electrolyte secondary batteries at the first charging and discharging was defined as 100%, capacity retention rates (%) of each of the nonaqueous electrolyte secondary batteries at the 100-th cycle and the 500-th cycle were calculated. The results are shown in Table 18.

TABLE 18

| | | Example | Example | Example | Comparative |
|---|---|---|---|---|---|
| | | 1-4 | 1-5 | 1-8 | Example 1-2 |
| Electro- | Organic | DMC | AN | DMC | EC/DEC |
| lytic | solvent | | | | |
| solution | Metal salt | LiFSA | LiFSA | LiFSA | LiPF₆ |
| Capacity | 100 cycle | 97 | 92 | 97 | 96 |
| retention | 500 cycle | 90 | 67 | | 85 |
| rate (%) | | | | | |

As shown in Table 18, the nonaqueous electrolyte secondary batteries of Examples 1-4, 1-5, and 1-8, even though not containing EC that becomes a material of SEI, each showed a capacity retention rate comparable to that of the nonaqueous electrolyte secondary battery of Comparative Example 1-2 containing EC. The reason may be that an S,O-containing coating originated from the electrolytic solution of the present invention exists on the positive electrode and the negative electrode of each of the nonaqueous electrolyte secondary batteries of the Examples. The nonaqueous electrolyte secondary battery of Example 1-4 particularly showed an extremely high capacity retention rate even after 500 cycles, and was particularly excellent in durability. Based on this result, durability is considered to improve more when DMC is selected as the organic solvent compared to when AN is selected.

### Evaluation Example 15: High-Temperature Storage Test

With respect to the nonaqueous electrolyte secondary batteries of Example 1-4 and 1-5 and Comparative Example 1-2, a high-temperature storage test of storing at 60° C. for 1 week was performed. Before starting the high-temperature storage test, CC-CV (constant current constant voltage) charging was performed from 3.0 V to 4.1 V. The charge capacity at this time was used as a standard (SOC100), and a portion of 20% with respect to this standard was CC discharged to adjust each of the batteries to SOC80, and the high-temperature storage test was started. After the high-temperature storage test, CC-CV discharging to 3.0 V was performed at 1 C. Based on a ratio of a discharge capacity at this moment and a capacity at SOC80 before storage, a remaining capacity was calculated using the following formula. The results are shown in Table 19.

Remaining capacity=100×(CC-CV discharge capacity after storage)/(Capacity at SOC80 before storage)

TABLE 19

| | | Example | Example | Comparative |
|---|---|---|---|---|
| | | 1-4 | 1-5 | Example 1-2 |
| Electrolytic | Organic | DMC | AN | EC/DEC |
| solution | solvent | | | |
| | Metal salt | LiFSA | LiFSA | LiPF₆ |

| | | | |
|---|---|---|---|
| Remaining capacity (%) | 54 | 36 | 20 |

The remaining capacities of the nonaqueous electrolyte secondary batteries of Examples 1-4 and 1-5 were larger than the remaining capacity of the nonaqueous electrolyte secondary battery of Comparative Example 1-2. Based on this result, the S,O-containing coatings derived from the electrolytic solution of the present invention and formed on the positive electrode and the negative electrode are considered to also contribute in increasing the remaining capacity.

### Evaluation Example 16: Rate Capacity Characteristics

Rate capacity characteristics of the nonaqueous electrolyte secondary batteries of Example 1-1 and Comparative Example 1-1 were evaluated using the following method. The capacity of each of the batteries was adjusted to 160 mAh/g. Regarding the evaluation conditions, with respect to each of the nonaqueous electrolyte secondary batteries, at 0.1 C, 0.2 C, 0.5 C, 1 C, and 2 C rates, charging and then discharging were performed, and the capacity (discharge capacity) of the working electrode was measured at each rate. Discharge capacity after performing a 0.1 C-discharge and a 1 C-discharge is shown in Table 20. The discharge capacity shown in Table 20 is a calculated value of capacity per mass (g) of the positive electrode active material.

TABLE 20

| | Example 1-1 | Comparative Example 1-1 |
|---|---|---|
| 0.1 C capacity (mAh/g) | 158.3 | 158.2 |
| 1.0 C capacity (mAh/g) | 137.5 | 125.0 |

As shown in Table 20, almost no difference in discharge capacity exists between the nonaqueous electrolyte secondary batteries of Example 1-1 and Comparative Example 1-1 when the discharge rate is low (0.1 C). However, when the discharge rate is high (1.0 C), the discharge capacity of the nonaqueous electrolyte secondary battery of Example 1-1 is large compared to the discharge capacity of the nonaqueous electrolyte secondary battery of Comparative Example 1-1. Based on this result, the nonaqueous electrolyte secondary battery of the present invention was confirmed to have excellent rate capacity characteristics. Conceivable reasons are the electrolytic solution in the nonaqueous electrolyte secondary battery of the present invention being different from that of a conventional one, and the S,O-containing coating formed on the negative electrode and/or the positive electrode of the nonaqueous electrolyte secondary battery of the present invention also being different from that of a conventional one.

### Evaluation Example 17: Output Characteristics Evaluation at 0° C., SOC 20%

Output characteristics of the nonaqueous electrolyte secondary batteries of Example 1-1 and Comparative Example 1-1 were evaluated. The used evaluation conditions were: state of charge (SOC) of 20%, 0° C., usage voltage range of 3 V to 4.2 V, and capacity of 13.5 mAh. SOC 20% at 0° C. is in a range in which output characteristics are unlikely to be exerted such as, for example, when used in a cold room. Evaluation of output characteristics of the nonaqueous electrolyte secondary batteries of Example 1-1 and Comparative Example 1-1 was performed three times each for 2-second output and 5-second output. Evaluation results of the output characteristics are shown in Table 21. In Table 21, “2-second output” refers to an output outputted at 2 seconds after the start of discharging, and “5-second output” refers to an output outputted at 5 seconds after the start of discharging. The same also applies for Tables 22 and 23 presented later.

TABLE 21
Output characteristics (0° C., SOC20%)

| | Example 1-1 | Comparative Example 1-1 |
|---|---|---|
| 2-second output | 121.7 | 98.1 |
| (mW) | 123.9 | 98.5 |
| | 119.8 | 99.2 |
| 5-second output | 98.4 | 75.1 |
| (mW) | 101.0 | 75.7 |
| | 96.3 | 76.5 |

As shown in Table 21, the output of the nonaqueous electrolyte secondary battery of Example 1-1 at 0° C., SOC 20% was 1.2 to 1.3 times higher than the output of the nonaqueous electrolyte secondary battery of Comparative Example 1-1.

### Evaluation Example 18: Output Characteristics Evaluation at 25° C., SOC 20%

Output characteristics of the lithium ion battery of Example 1-1 and Comparative Example 1-1 were evaluated at conditions of: state of charge (SOC) of 20%, 25° C., usage voltage range of 3 V to 4.2 V, and capacity of 13.5 mAh. Evaluation of output characteristics of the nonaqueous electrolyte secondary batteries of Example 1-1 and Comparative Example 1-1 was performed three times each for 2-second output and 5-second output. Evaluation results are shown in Table 22.

TABLE 22
Output characteristics (25° C., SOC20%)

| | Example 1-1 | Comparative Example 1-1 |
|---|---|---|
| 2-second output | 458.9 | 371.4 |
| (mW) | 471.3 | 372.4 |
| | 466.8 | 370.8 |
| 5-second output | 374.1 | 290.4 |
| (mW) | 387.6 | 292.7 |
| | 382.0 | 285.4 |

As shown in Table 22, the output of the nonaqueous electrolyte secondary battery of Example 1-1 at 25° C., SOC 20% was 1.2 to 1.3 times higher than the output of the nonaqueous electrolyte secondary battery of Comparative Example 1-1.

### Evaluation Example 19: Effect of Temperature on Output Characteristics

The effect of temperature during measurement on output characteristics of the nonaqueous electrolyte secondary batteries of Example 1-1 and Comparative Example 1-1 was investigated. Measurements were performed at 0° C. and 25° C., and the used evaluation conditions were: state of charge (SOC) of 20%, usage voltage range of 3 V to 4.2 V, and capacity of 13.5 mAh for the measurements at both temperatures. A ratio (0° C.-output/25° C.-output) of an output at 0° C. with respect to an output at 25° C. was calculated. The results are shown in Table 23.

TABLE 23
0° C. output/25° C. output

| | Example 1-1 | Comparative Example 1-1 |
|---|---|---|
| 2-second output | 0.26 | 0.27 |
| 5-second output | 0.26 | 0.26 |

As shown in Table 23, since the ratios (0° C.-output/25° C.-output) of output at 0° C. with respect to output at 25° C. for 2-second output and 5-second output in the nonaqueous electrolyte secondary battery of Example 1-1 were about the same level as those of the nonaqueous electrolyte secondary battery of Comparative Example 1-1, the nonaqueous electrolyte secondary battery of Example 1-1 was revealed to be capable of suppressing decrease of output at a low temperature at the same level as the nonaqueous electrolyte secondary battery of Comparative Example 1-1.

### Evaluation Example 20: Thermal Stability

Thermal stability of an electrolytic solution against a charged-state positive electrode of the nonaqueous electrolyte secondary batteries of Example 1-1 and Comparative Example 1-1 was evaluated using the following method.

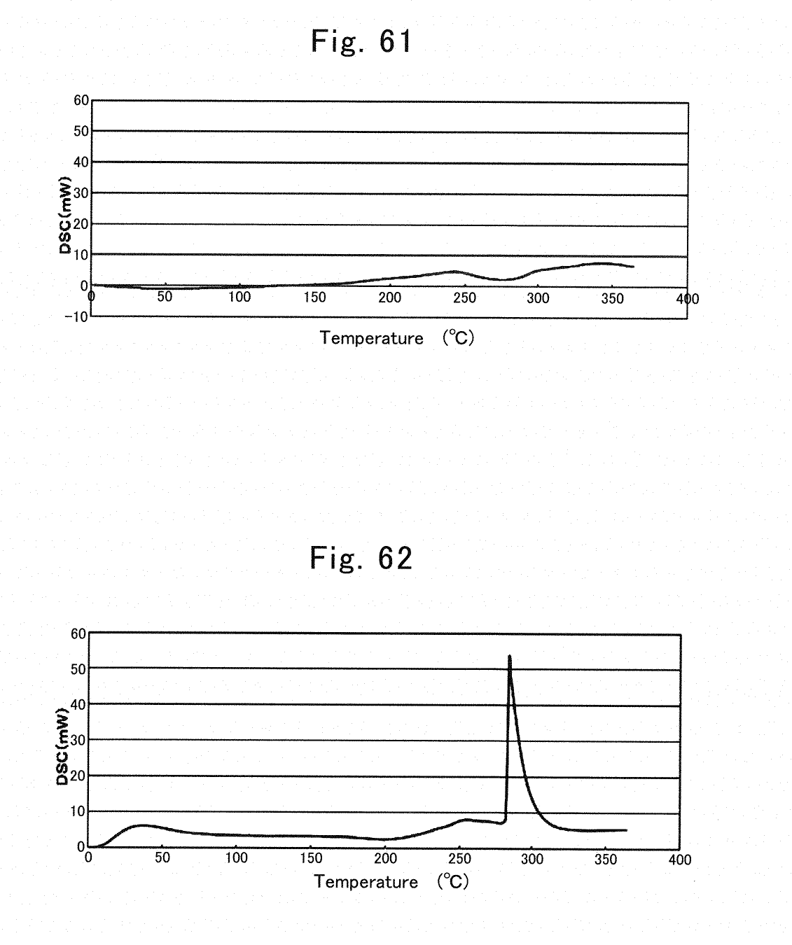

Each of the nonaqueous electrolyte secondary batteries was fully charged under constant current constant voltage conditions to obtain a charge end voltage of 4.2 V. The nonaqueous electrolyte secondary battery was disassembled after being fully charged, and the positive electrode thereof was removed. 3 mg of a positive electrode active material layer obtained from the positive electrode and 1.8 μL of an electrolytic solution were placed in a stainless steel pan, and the pan was sealed. Differential scanning calorimetry analysis was performed using the sealed pan under a nitrogen atmosphere at a temperature increase rate of 20° C./min., and a DSC curve was observed. As a differential scanning calorimeter, Rigaku DSC8230 was used. FIG. 61 shows a DSC chart obtained when the electrolytic solution and the charged-state positive electrode active material layer of the nonaqueous electrolyte secondary battery of Example 1-1 were placed together. In addition, FIG. 62 shows a DSC chart obtained when the electrolytic solution and the charged-state positive electrode active material layer of the nonaqueous electrolyte secondary battery of Comparative Example 1-1 were placed together.

As obvious from the results of FIGS. 61 and 62, although endothermic/exothermic peaks were hardly observed in the DSC curve obtained when the electrolytic solution and the charged-state positive electrode of the nonaqueous electrolyte secondary battery of Example 1-1 were placed together, an exothermic peak was observed at around 300° C. in the DSC curve obtained when the electrolytic solution and the charged-state positive electrode of the nonaqueous electrolyte secondary battery of Comparative Example 1-1 were placed together. The exothermic peak is estimated to be generated as a result of a reaction between the positive electrode active material and the electrolytic solution.

Based on these results, when compared to a nonaqueous electrolyte secondary battery using a conventional electrolytic solution, the nonaqueous electrolyte secondary battery using the electrolytic solution of the present invention is understood as having excellent thermal stability since reactivity between the positive electrode active material and the electrolytic solution is low.

As described above, an imide salt is thought to easily corrode an aluminum current collector. Conventionally, when using an aluminum current collector, for the purpose of forming a protective coating for suppressing corrosion of the aluminum current collector, using a lithium salt such as LiPF₆ was thought to be necessary as part of the metal salt of the electrolytic solution. For example, in the Examples in JP2013145732 (A), LiPF₆ is blended in an electrolytic solution at an amount about 4 times of that of an imide salt. On the other hand, as shown in the following, the electrolytic solution of the present invention hardly corrodes aluminum. Thus, an aluminum current collector is suitably used in the nonaqueous electrolyte secondary battery of the present invention.

### Evaluation Example 21: First Confirmation of Elution of Al

(EB4)

A nonaqueous electrolyte secondary battery using electrolytic solution E8 was produced in the following manner.

An aluminum foil (JIS A1000 series) having a diameter of 13.82 mm, an area size of 1.5 cm², and a thickness of 20 μm was used as the working electrode, and metal Li was used as the counter electrode. As the separator, a Whatman glass fiber filter paper (stock number: 1825-055) having a thickness of 400 μm was used.

The working electrode, the counter electrode, the separator, and the electrolytic solution of E8 were housed in a battery case (CR2032 type coin cell case manufactured by Hohsen Corp.) to obtain a nonaqueous electrolyte secondary battery.

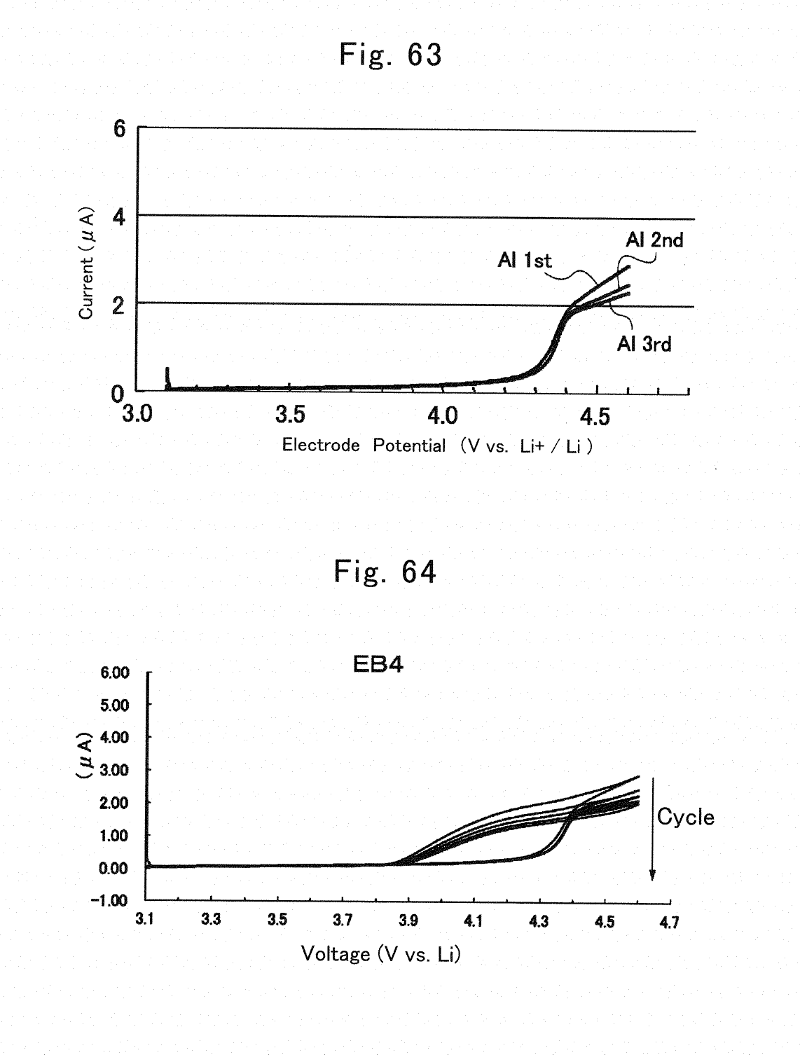

The changes in current and electrode potential were observed when linear sweep voltammetry (i.e., LSV) measurement was performed on EB4 repeatedly for ten times in a range of 3.1 V to 4.6 V (vs. Li reference) at a rate of 1 mV/s. FIG. 63 is a graph showing the relationship between current and electrode potential after the first, second, and third charging and discharging of EB4.

In FIG. 63, current was hardly confirmed at 4.0 V in EB4 in which the working electrode was Al, and, although the current slightly increased at 4.3 V for a moment, a large increase was not observed thereafter up to 4.6 V. In addition, the amount of current reduced and became steady through repeating of charging and discharging.

Based on the results described above, the nonaqueous electrolyte secondary battery using the electrolytic solution of the present invention and the aluminum current collector on the positive electrode is thought unlikely to cause elution of Al even at a high potential. Although the reason why elution of Al is unlikely to occur is unclear, solubility of Al with respect to the electrolytic solution of the present invention is speculated to be low when compared to a conventional electrolytic solution since the electrolytic solution of the present invention is different from the conventional electrolytic solution regarding the types and existing environment of the metal salt and the organic solvent, and the concentration of the metal salt.

### Evaluation Example 22: Cyclic Voltammetry Evaluation Using Al Working Electrode

(EB5)

A nonaqueous electrolyte secondary battery EB5 was obtained similarly to EB4 except for using electrolytic solution E11 instead of electrolytic solution E8.

(EB6)

A nonaqueous electrolyte secondary battery EB6 was obtained similarly to EB4 except for using electrolytic solution E16 instead of electrolytic solution E8.

(EB7)

A nonaqueous electrolyte secondary battery EB7 was obtained similarly to EB4 except for using electrolytic solution E19 instead of electrolytic solution E8.

(EB8)

A nonaqueous electrolyte secondary battery EB8 was obtained similarly to EB4 except for using electrolytic solution E13 instead of electrolytic solution E8.

(CB4)

A nonaqueous electrolyte secondary battery CB4 was obtained similarly to EB4 except for using electrolytic solution C5 instead of electrolytic solution E8.

(CB5)

A nonaqueous electrolyte secondary battery CB5 was obtained similarly to EB4 except for using electrolytic solution C6 instead of electrolytic solution E8.

With respect to the nonaqueous electrolyte secondary batteries EB4 to EB7 and CB4, 5 cycles of cyclic voltammetry evaluation were performed with a condition of 1 mV/s in a range of 3.1 V to 4.6 V. Then, 5 cycles of cyclic voltammetry evaluation were performed with a condition of 1 mV/s in a range of 3.1 V to 5.1 V.

With respect to the half-cells EB5, EB8, and CB5, 10 cycles of cyclic voltammetry evaluation were performed with a condition of 1 mV/s in a range of 3.0 V to 4.5 V. Then, 10 cycles of cyclic voltammetry evaluation were performed with a condition of 1 mV/s in a range of 3.0 V to 5.0 V.

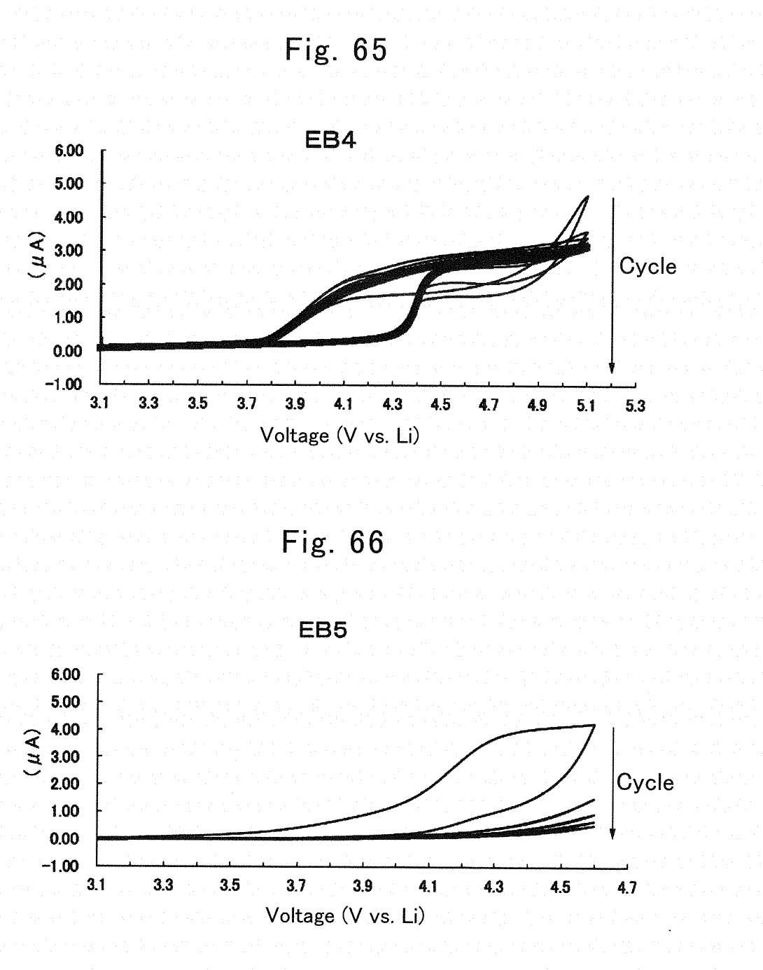

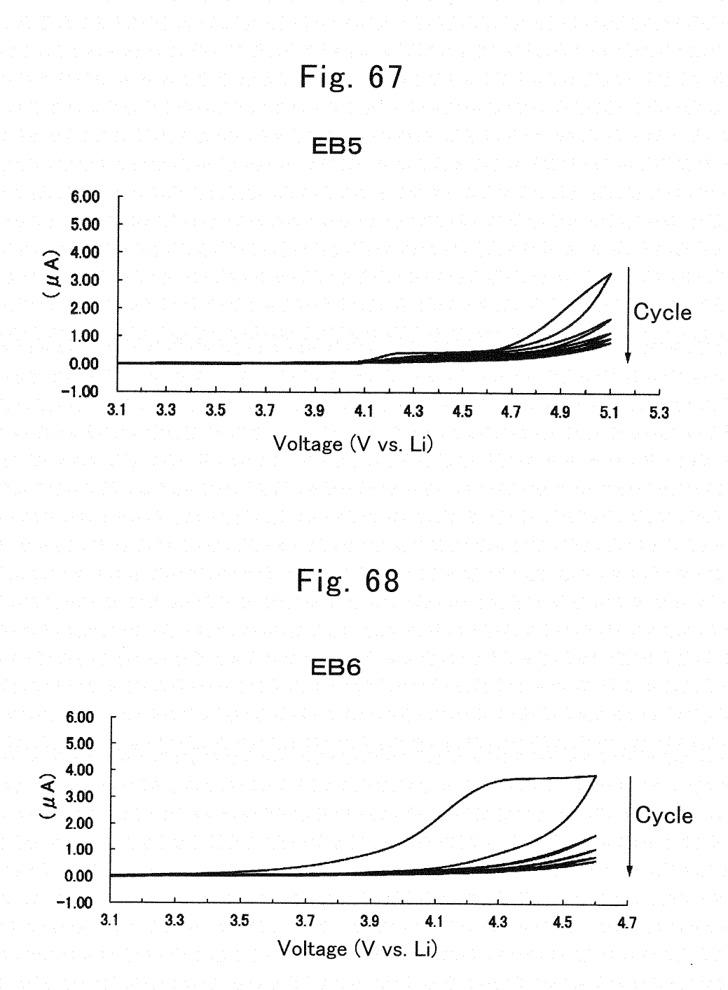

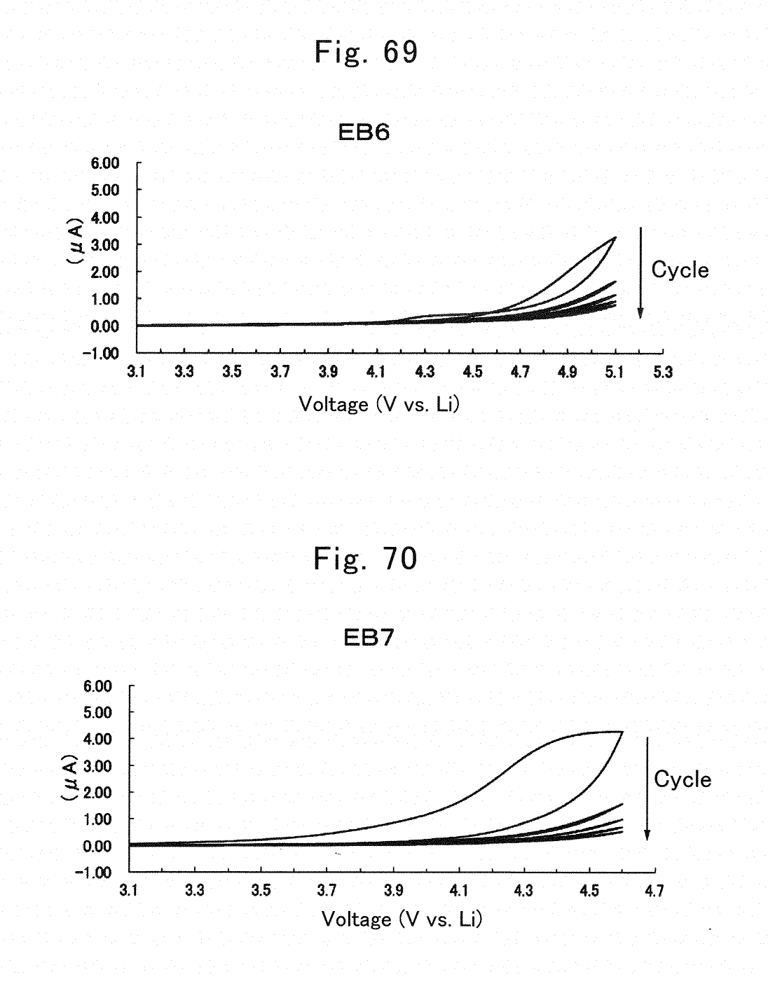

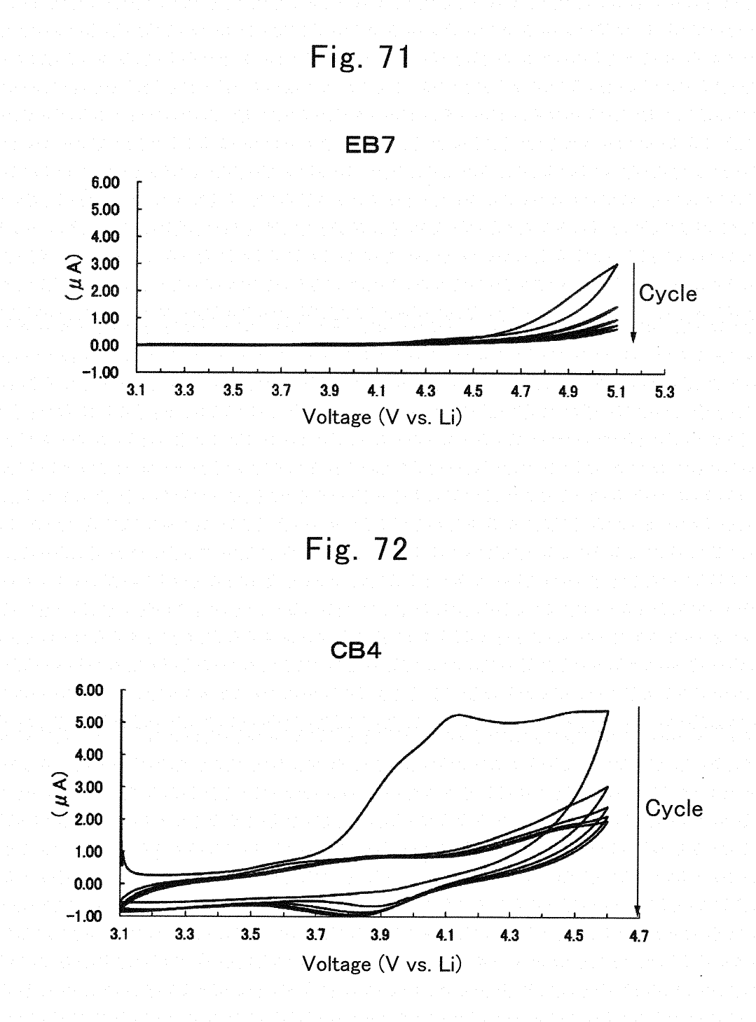

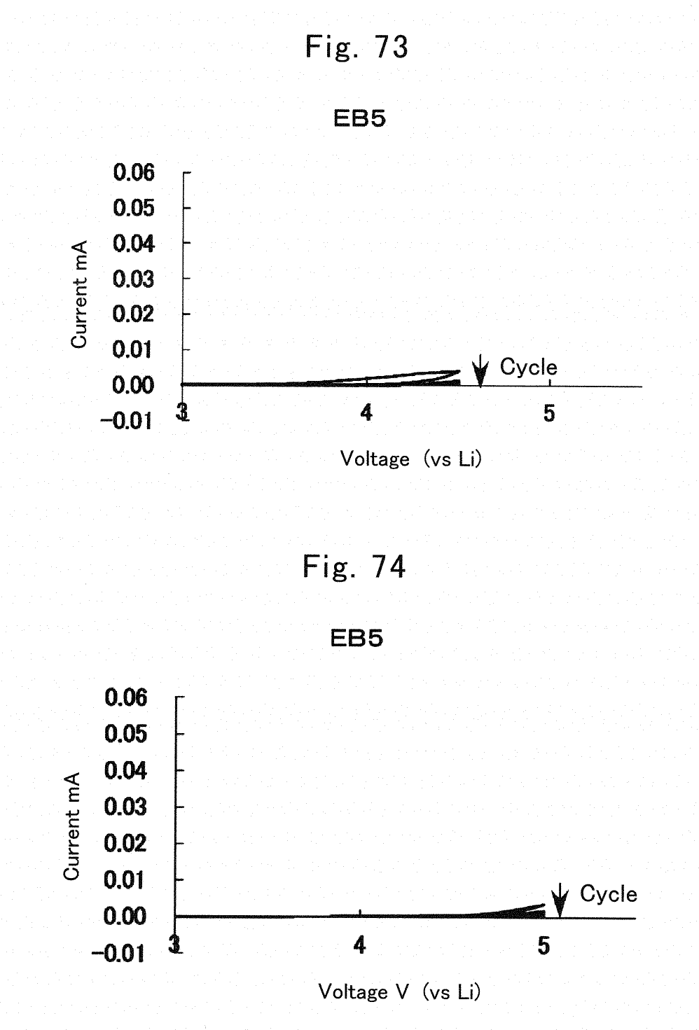

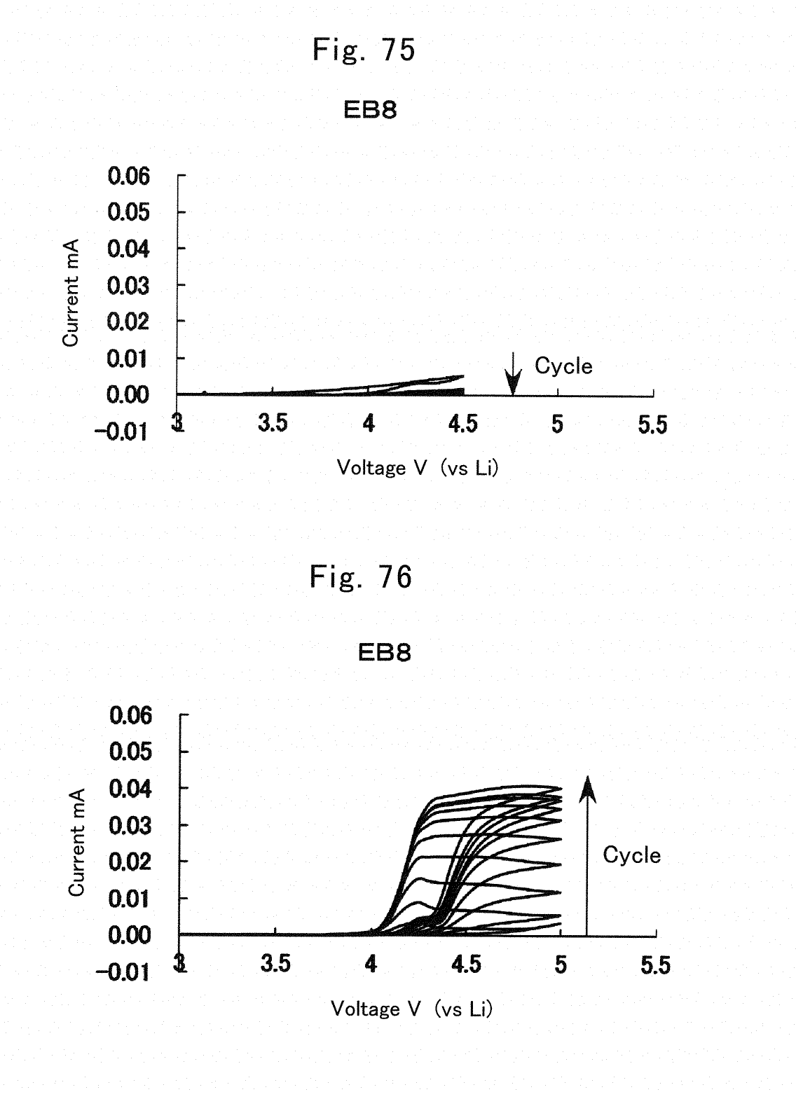

FIGS. 64 to 72 show graphs showing the relationship between potential and response current in EB4 to EB7 and CB4. In addition, FIGS. 73 to 78 show graphs showing the relationship between potential and response current in EB5, EB8, and CB5.

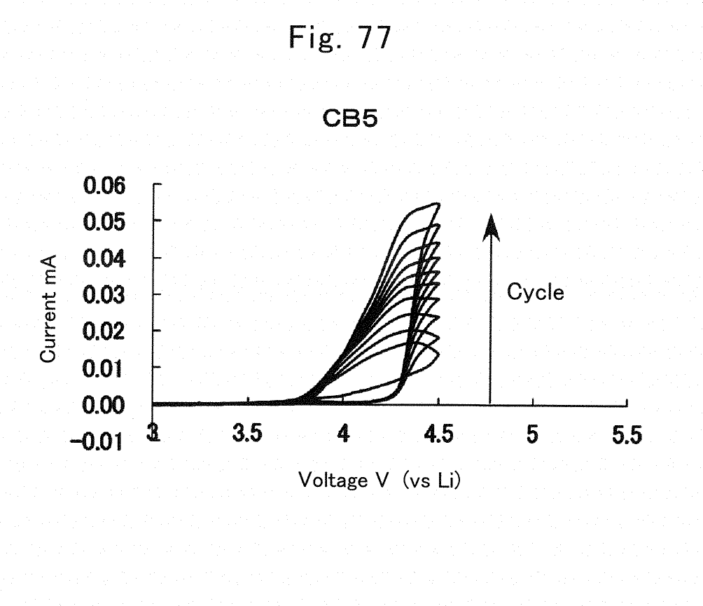

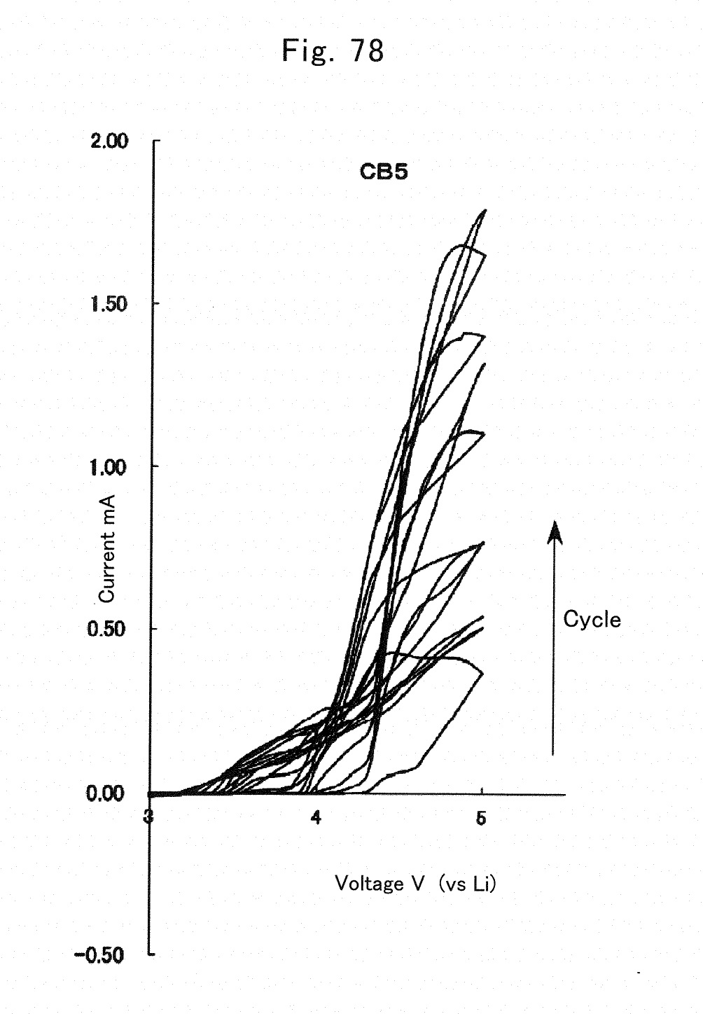

From FIG. 72, with CB4, current is understood to be flowing in a range of 3.1 V to 4.6 V during and after the second cycle, and the current is understood to increase as the potential became higher. In addition, from FIGS. 77 and 78, also with CB5, current flowed in a range of 3.0 V to 4.5 V during and after the second cycle, and current increased as the potential became higher. This current is estimated to be a current resulting from oxidation of Al, generated through corrosion of aluminum of the working electrode.

On the other hand, from FIGS. 64 to 71, with EB4 to EB7, almost no current is understood as to flow in a range of 3.1 V to 4.6 V during and after the second cycle. Although a slight increase in current was observed associated with an increase in potential in a range equal to or higher than 4.3 V, the amount of current decreased and became steady as the cycle was repeated. Particularly in EB5 to EB7, a significant increase in current was not observed up to a high potential of 5.1 V, and a decrease in the amount of current associated with repeated cycles was observed.

In addition, from FIGS. 73 to 76, similarly with EB5 and EB8, almost no current is understood as to flow in a range of 3.0 V to 4.5 V during and after the second cycle. In particular, during and after the third cycle, almost no increase in current was observed until reaching 4.5 V. Although an increase in current beyond a high potential of 4.5 V was observed in EB8, the value was much smaller when compared to a current value beyond 4.5 V in CB5. In EB5, almost no increase in current was observed beyond 4.5 V up to 5.0 V, and a decrease in the amount of current associated with repeated cycles was observed in manner similar to EB5 to EB7.

From the results of cyclic voltammetry evaluation, corrosiveness of electrolytic solutions E8, E11, E16, and E19 with respect to aluminum is considered to be low even at a high potential condition exceeding 5 V. Thus, electrolytic solutions E8, E11, E16, and E19 are considered as electrolytic solutions suitable for a battery using aluminum as a current collector or the like.

### Evaluation Example 23: Second Confirmation of Elution of Al

The nonaqueous electrolyte secondary batteries of Examples 1-1 and 1-2 and Comparative Example 1-1 were subjected to 100 repeats of charging and discharging at a rate of 1 C in a usage voltage range of 3 V to 4.2 V, were disassembled after 100 times of charging and discharging to have negative electrodes removed therefrom. The amount of Al eluted to the electrolytic solution from the positive electrode, and deposited on the surface of the negative electrode was measured using an ICP (high frequency inductively coupled plasma) emission spectrophotometer. The measurement results are shown in Table 24. The amount (%) of Al in Table 24 shows, in %, the mass of Al per 1 g of the negative electrode active material layer. The amount Gig/sheet) of Al shows the mass (m) of Al per single sheet of the negative electrode active material layer, and was calculated from a calculation formula of: amount of Al (%)/100×mass of single sheet of each negative electrode active material layer=amount of Al (μg/sheet).

TABLE 24

| | Al amount (%) | Al amount (μg/sheet) |
|---|---|---|
| Example 1-1 | 0.00480 | 11.183 |
| Example 1-2 | 0.00585 | 13.634 |
| Comparative Example 1-1 | 0.03276 | 76.331 |

The amount of Al deposited on the surface of the negative electrode was significantly less in the nonaqueous electrolyte secondary batteries of Examples 1-1 and 1-2 than the nonaqueous electrolyte secondary battery of Comparative Example 1-1. From this, elution of Al from the current collector of the positive electrode was revealed to be suppressed more in the nonaqueous electrolyte secondary batteries of Examples 1-1 and 1-2 using the electrolytic solution of the present invention than in the nonaqueous electrolyte secondary battery of Comparative Example 1-1 using a conventional electrolytic solution.

### Evaluation Example 24: Surface Analysis of Al Current Collector

The nonaqueous electrolyte secondary batteries of Examples 1-1 and 1-2 were subjected to 100 repeats of charging and discharging at a rate of 1 C in a usage voltage range of 3 V to 4.2 V, and were disassembled after 100 times of charging and discharging. The aluminum foils which are the positive electrode current collectors were each removed and the surfaces of the aluminum foils were rinsed using dimethyl carbonate.

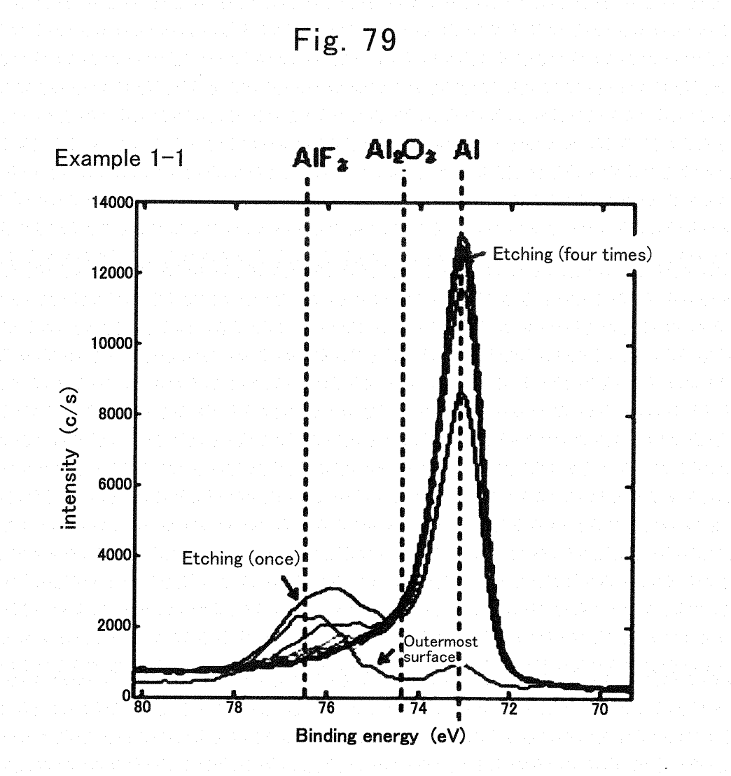

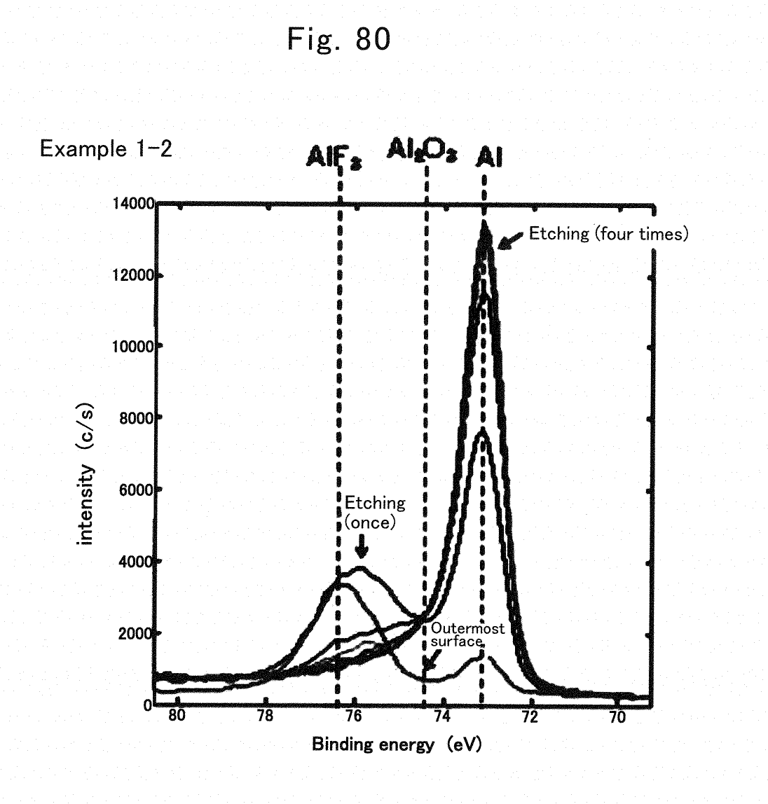

After the rinsing, surface analysis using X-ray photoelectron spectroscopy (XPS) was performed on the surfaces of the aluminum foils of the nonaqueous electrolyte secondary batteries of Examples 1-1 and 1-2 while etching was performed thereon through Ar sputtering. The results of surface analysis of the aluminum foils after charging and discharging the nonaqueous electrolyte secondary batteries of Examples 1-1 and 1-2 are shown in FIGS. 79 and 80.

When FIGS. 79 and 80 are compared, the results of surface analysis of the aluminum foils, which are the positive electrode current collectors, after charging and discharging the nonaqueous electrolyte secondary batteries of Examples 1-1 and 1-2 were almost the same, and whereby the following is determined. At the surfaces of the aluminum foils, the chemical state of Al on the outermost surface was AlF₃. When etching was performed on the aluminum foils in the depth direction, peaks for Al, O, and F were detected. At parts reachable after one to three times of etching from the surfaces of the aluminum foils, the chemical state of Al was revealed to be a composite state of Al—F bonds and Al—O bonds. After further etching, peaks for O and F disappeared and only a peak for Al was observed from the fourth time of etching (a depth of approximately 25 nm calculated based on SiO₂). In XPS measurement data, AlF₃ was observed at Al peak position 76.3 eV, pure Al was observed at Al peak position 73 eV, and the composite state of Al—F bonds and Al—O bonds was observed at Al peak position 74 eV to 76.3 eV. Dashed lines shown in FIGS. 79 and 80 show respective peak positions representative for AlF₃, Al, and Al₂O₃.

Based on the results above, on the surfaces of the aluminum foils of the nonaqueous electrolyte secondary battery of the present invention after charging and discharging, a layer of Al—F bonds (speculated to be AlF₃) and a layer in which Al—F bonds (speculated to be AlF₃) and Al—O bonds (speculated to be Al₂O₃) coexist were confirmed to be formed in a thickness of approximately 25 nm in the depth direction.

Thus, in the nonaqueous electrolyte secondary batteries of the present invention using an aluminum foil as the positive electrode current collector, also when the electrolytic solution of the present invention is used, a passive film including Al—F bonds (speculated to be AlF₃) was revealed to be formed on the outermost surfaces of the aluminum foils after charging and discharging.

Based on the results of Evaluation Examples 21 to 24, in the nonaqueous electrolyte secondary battery obtained by combining the electrolytic solution of the present invention and the positive electrode current collector formed of aluminum or an aluminum alloy, a passive film was revealed to be formed on the surface of the positive electrode current collector through charging and discharging, and elution of Al from the positive electrode current collector was revealed to be suppressed even in a high potential state.

### Evaluation Example 25: Analysis of Positive-Electrode S,O-Containing Coating

By using TOF-SIMS (Time-of-Flight Secondary Ion Mass Spectrometry), structural information of each molecule included in the positive-electrode S,O-containing coating of Example 1-4 was analyzed.

The nonaqueous electrolyte secondary battery of Example 1-4 was subjected to 3 cycles of charging and discharging at 25° C., and disassembled at a 3 V-discharged state to remove the positive electrode. Aside from this, the nonaqueous electrolyte secondary battery of Example 1-4 was subjected to 500 cycles of charging and discharging at 25° C., and disassembled at the 3 V-discharged state to remove the positive electrode. Also aside from this, the nonaqueous electrolyte secondary battery of Example 1-4 was subjected to 3 cycles of charging and discharging at 25° C., left for one month at 60° C., and disassembled at the 3 V-discharged state to remove the positive electrode. Each of the positive electrodes was rinsed three times with DMC to obtain a positive electrode for analysis. On each of the positive electrodes, a positive-electrode S,O-containing coating was formed, and structural information of molecules included in the positive-electrode S,O-containing coating was analyzed in the following analysis.

Each of the positive electrodes for analysis was analyzed using TOF-SIMS. A time-of-flight secondary ion mass spectrometer was used as a mass spectrometer to measure positive secondary ions and negative secondary ions. Bi was used as a primary ion source, and the primary accelerating voltage was 25 kV. Ar-GCIB (Ar1500) was used as a sputtering ion source. The results of the measurement are shown in Tables 25 to 27. A positive ionic strength (relative value) of each fragment in Table 26 is a relative value when the total of the positive ionic strength of all the detected fragments was defined as 100%. Similarly, a negative ionic strength (relative value) of each fragment described in Table 27 is a relative value when the total of the negative ionic strength of all the detected fragments was defined as 100%.

TABLE 25
(Detected main fragments)

| | Positive | Negative secondary |
|---|---|---|
| | secondary ion | ion |
| S-containing fragments | SO, Li₂SO₂, | SO₃, Li₃S₂O₃, SNO₂, |
| (estimated to be coating | Li₃SO₃, Li₃SO₄ | SFO₂, SFO₃, S₂F₂NO₄ |
| component derived from | | |
| metal salt) | | |
| Hydrocarbon fragments | C₃H₃, C₄H₃ | Attributable |
| (estimated to be coating | | fragments not |
| component derived from | | present |
| solvent) | | |
| Other Li containing fragments | Li, Li₃O, Li₂F, | LiF₂, Li₂F₃ |
| | Li₃F₂, Li₃CO₃ | |

TABLE 26
(Positive ion analysis results)

| | | Positive ionic strength (relative value) | | |
|---|---|---|---|---|
| | | 3 cycle | 500 cycle | 60° C. storage |
| Positive secondary ion | SO | 2.2E−04 | 2.2E−04 | 2.5E−04 |
| | Li₂SO₂ | 1.9E−03 | 2.0E−03 | 1.5E−03 |
| | Li₃SO₃ | 4.4E−03 | 4.2E−03 | 2.2E−03 |
| | Li₃SO₄ | 7.5E−03 | 5.4E−03 | 2.6E−03 |
| | C₃H₃ | 1.2E−02 | 1.3E−02 | 1.5E−02 |
| | C₄H₃ | 2.8E−03 | 3.6E−03 | 4.2E−03 |
| | Li | 4.5E−02 | 3.6E−02 | 2.2E−02 |
| | Li₃O | 2.4E−02 | 1.7E−02 | 5.7E−03 |
| | Li₂F | 1.3E−01 | 1.4E−01 | 8.2E−02 |
| | Li₃F₂ | 4.7E−02 | 5.3E−02 | 2.9E−02 |
| | Li₃CO₃ | 3.7E−03 | 2.3E−03 | 1.8E−03 |

TABLE 27
(Negative ion analysis results)

| | | Negative ionic strength (relative value) | | |
|---|---|---|---|---|
| | | 3 cycle | 500 cycle | 60° C. storage |
| Negative secondary | SO₃ | 3.0E−02 | 4.0E−02 | 2.5E−02 |
| ion | Li₃S₂O₆ | 1.6E−03 | 1.3E−03 | 1.3E−03 |
| | SNO₂ | 2.0E−02 | 2.4E−02 | 3.1E−02 |
| | SFO₂ | 1.6E−02 | 2.1E−02 | 2.6E−02 |
| | SFO₃ | 4.6E−03 | 7.6E−03 | 9.1E−03 |
| | S₂F₂NO₄ | 2.2E−01 | 3.1E−01 | 4.6E−01 |
| | LiF₂ | 8.0E−03 | 1.1E−02 | 6.1E−03 |
| | Li₂F₃ | 4.0E−03 | 5.5E−03 | 2.8E−03 |

As shown in Table 25, fragments that were estimated to be derived from the solvent of the electrolytic solution were only C₃H₃ and C₄H₃ detected as positive secondary ions. Fragments estimated to be derived from the salt of the electrolytic solution were mainly detected as negative secondary ions, and had larger ionic strengths than the fragments derived from the solvent described above. In addition, fragments including Li were mainly detected as positive secondary ions, and the ionic strength of the fragments including Li accounted for a large proportion among the positive secondary ions and the negative secondary ions.

Thus, the main component of the S,O-containing coating of the present invention is speculated to be a component derived from the metal salt contained in the electrolytic solution, and the S,O-containing coating of the present invention is speculated to include a large amount of Li.

Furthermore, as shown in Table 25, as fragments estimated to be derived from the salt, SNO₂, SFO₂, and S₂F₂NO₄, etc., were also detected. All of these have the S═O structure, and a structure in which N or F are bound to S. Thus, in the S,O-containing coating of the present invention, S not only forms a double bond with O, but also forms a structure bound to other elements such as SNO₂, SFO₂, and S₂F₂NO₄. Thus, the S,O-containing coating of the present invention preferably has at least the S═O structure, and S included in the S═O structure may bind with other elements. Obviously, the S,O-containing coating of the present invention may include S and O that do not form the S═O structure.

In a conventional electrolytic solution described in, for example, JP2013145732 (A) described above, more specifically, in a conventional electrolytic solution including EC as the organic solvent, LiPF₆ as the metal salt, and LiFSA as the additive; S is taken into a degradation product of the organic solvent. Thus, in the negative-electrode coating and/or the positive-electrode coating, S is thought to exist as an ion of such as CₚH_{q}S (p and q are independently an integer). On the other hand, as shown in Tables 25 to 27, the fragments including S, detected in the S,O-containing coating of the present invention, were not fragments of CₚH_{q}S, but were mainly fragments reflecting an anion structure. This also reveals that the S,O-containing coating of the present invention is fundamentally different from a coating formed on a conventional nonaqueous electrolyte secondary battery.

(Other Mode I)

Battery characteristics of the nonaqueous electrolyte secondary battery using the electrolytic solution of the present invention were evaluated in the following manner.

(EB9)

A nonaqueous electrolyte secondary battery using electrolytic solution E8 was produced in the following manner.

90 parts by mass of graphite which is an active material and whose mean particle diameter is 10 μm was mixed with 10 parts by mass of polyvinylidene fluoride which is a binding agent. The mixture was dispersed in a proper amount of N-methyl-2-pyrrolidone to create a slurry. As the current collector, a copper foil having a thickness of 20 μm was prepared. The slurry was applied in a film form on the surface of the copper foil by using a doctor blade. The copper foil on which the slurry was applied was dried to remove N-methyl-2-pyrrolidone, and then the copper foil was pressed to obtain a joined object. The obtained joined object was heated and dried in a vacuum dryer for 6 hours at 120° C. to obtain a copper foil having the active material layer formed thereon. This was used as the working electrode. The mass of the active material per 1 cm² of the copper foil was 1.48 mg. In addition, the density of graphite and polyvinylidene fluoride before pressing was 0.68 g/cm³, whereas the density of the active material layer after pressing was 1.025 g/cm³.

Metal Li was used as the counter electrode.

The working electrode, the counter electrode, a Whatman glass fiber filter paper having a thickness of 400 μm interposed therebetween as the separator, and electrolytic solution E8 were housed in a battery case (CR2032 type coin cell case manufactured by Hohsen Corp.) having a diameter of 13.82 mm to obtain a nonaqueous electrolyte secondary battery EB9.

(EB10)

A nonaqueous electrolyte secondary battery EB10 was obtained with a method similar to that of EB9 except for using electrolytic solution E11.

(EB11)

A nonaqueous electrolyte secondary battery EB11 was obtained with a method similar to that of EB9 except for using electrolytic solution E16.

(EB12)

A nonaqueous electrolyte secondary battery EB12 was obtained with a method similar to that of EB9 except for using electrolytic solution E19.

(CB6)

A nonaqueous electrolyte secondary battery CB6 was obtained with a method similar to that of EB9 except for using electrolytic solution C5.

(Evaluation Example 26: Rate Characteristics)

Rate characteristics of EB9 to EB12 and CB6 were tested using the following method. With respect to each of the nonaqueous electrolyte secondary batteries, at 0.1 C, 0.2 C, 0.5 C, 1 C, and 2 C rates, charging and then discharging were performed, and the capacity (discharge capacity) of the working electrode was measured at each rate. “1 C” refers to a current required for fully charging or discharging a battery in 1 hour under a constant current. In the description here, the counter electrode was regarded as the negative electrode and the working electrode was regarded as the positive electrode. With respect to the capacity of the working electrode at 0.1 C rate, proportions of capacities (rate characteristics) at other rates were calculated. The results are shown in Table 28.

TABLE 28

| | EB9 | EB10 | EB11 | EB12 | CB6 |
|---|---|---|---|---|---|
| 0.2 C capacity/0.1 C capacity | 0.982 | 0.981 | 0.981 | 0.985 | 0.974 |
| 0.5 C capacity/0.1 C capacity | 0.961 | 0.955 | 0.956 | 0.960 | 0.931 |
| 1 C capacity/0.1 C capacity | 0.925 | 0.915 | 0.894 | 0.905 | 0.848 |
| 2 C capacity/0.1 C capacity | 0.840 | 0.777 | 0.502 | 0.538 | 0.575 |

When compared to CB6, since decrease in capacity was suppressed at rates of 0.2 C, 0.5 C and 1 C in EB9, EB10, EB11, and EB12, and at 2 C rate in EB9 and EB10; EB9, EB10, EB11, and EB12 were confirmed to display excellent rate characteristics.

### Evaluation Example 27: Capacity Retention Rate

Capacity retention rates of EB9 to EB12 and CB6 were tested using the following method.

With respect to each of the nonaqueous electrolyte secondary batteries, a charging/discharging cycle from 2.0 V to 0.01 V involving CC charging (constant current charging) to a voltage of 2.0 V and CC discharging (constant current discharging) to a voltage of 0.01 V was performed at 25° C. for 3 cycles at a charging/discharging rate of 0.1 C. Then, charging and discharging were performed for three cycles at respective charging/discharging rates of 0.2 C, 0.5 C, 1 C, 2 C, 5 C, and 10 C, sequentially. Lastly, charging and discharging were performed for three cycles at 0.1 C. Capacity retention rate (%) of each of the nonaqueous electrolyte secondary batteries was obtained from the following formula.

Capacity Retention rate (%)=B/A×100

A: Second discharge capacity of the working electrode in the first charging/discharging cycle at 0.1 C

B: Second discharge capacity of the working electrode in the last charging/discharging cycle at 0.1 C

The results are shown in Table 29. In the description here, the counter electrode was regarded as the negative electrode and the working electrode was regarded as the positive electrode.

TABLE 29

| | EB9 | EB10 | EB11 | EB12 | CB6 |
|---|---|---|---|---|---|
| Capacity retention rate (%) | 98.1 | 98.7 | 98.9 | 99.8 | 98.8 |

All the nonaqueous electrolyte secondary batteries underwent the charging/discharging reaction finely, and displayed suitable capacity retention rates. In particular, capacity retention rates of EB10, EB11, and EB12 were significantly superior.

### Evaluation Example 28: Reversibility of Charging and Discharging

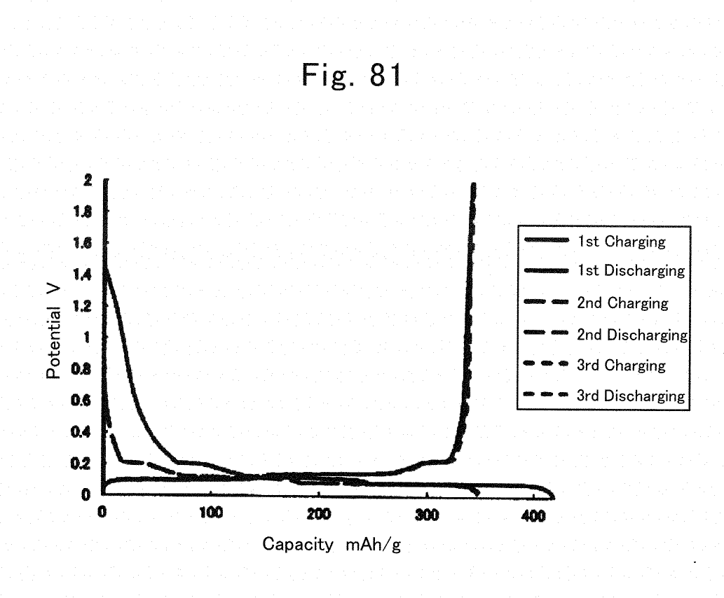

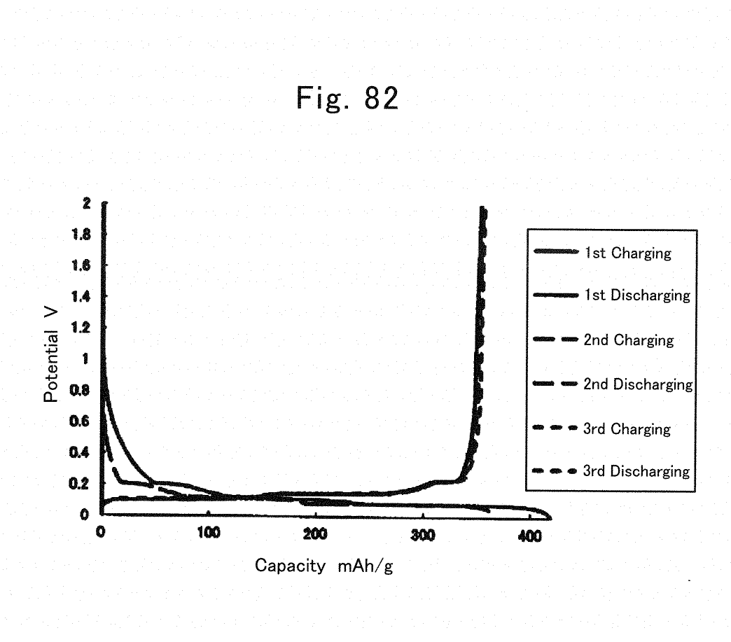

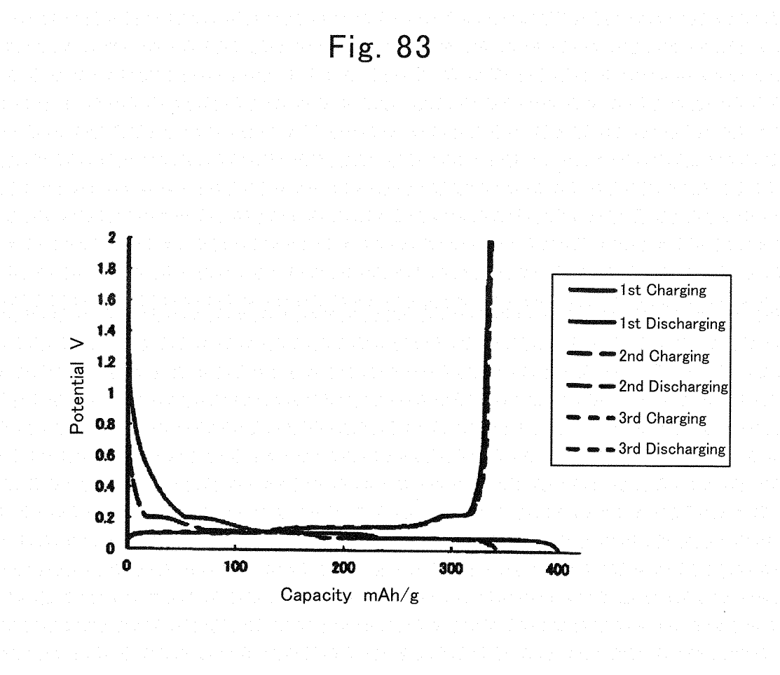

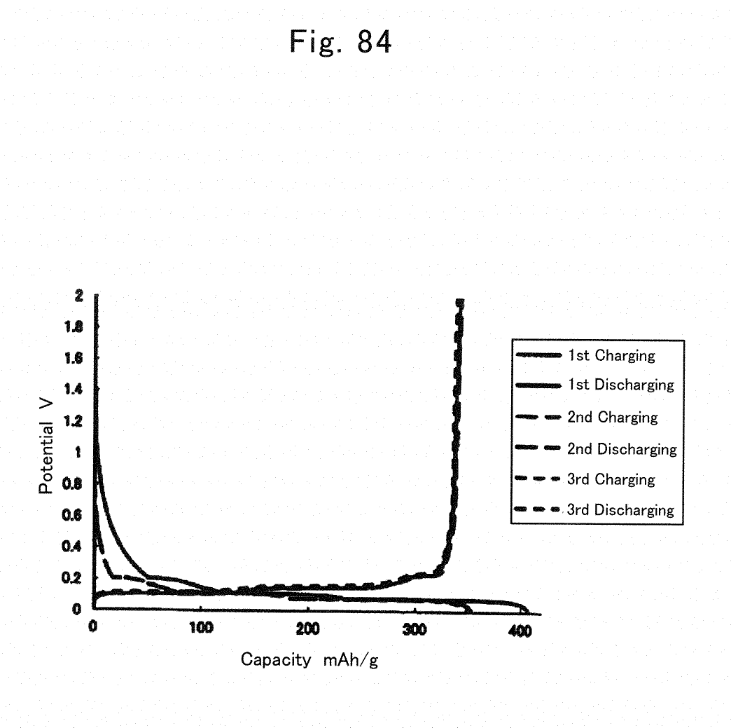

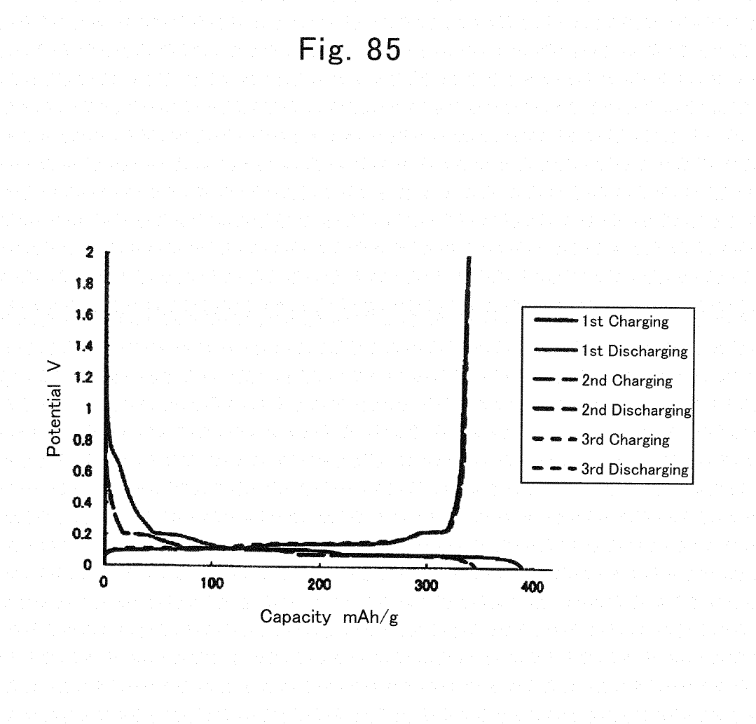

With respect to EB9 to EB12 and CB6, a charging/discharging cycle from 2.0 V to 0.01 V involving CC charging (constant current charging) to a voltage of 2.0 V and CC discharging (constant current discharging) to a voltage of 0.01 V was performed at 25° C. for 3 cycles at a charging/discharging rate of 0.1 C. Charging/discharging curves of each of the nonaqueous electrolyte secondary batteries are shown in FIGS. 81 to 85.

As shown in FIGS. 81 to 85, EB9 to EB12 were shown to undergo reversible charging/discharging reaction similarly to CB6 using a general electrolytic solution.

(EB13)

A nonaqueous electrolyte secondary battery EB13 was obtained similarly to EB9 except for using electrolytic solution E9.

### Evaluation Example 29: Rate Characteristics at Low Temperature

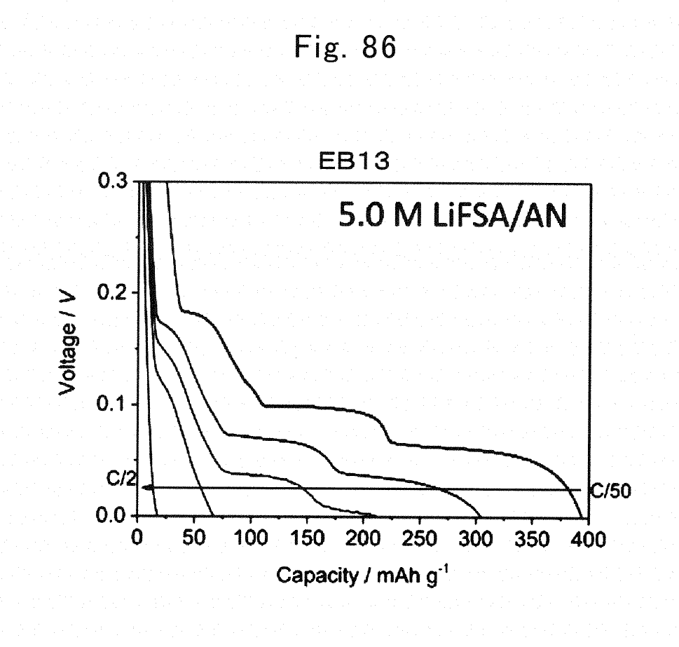

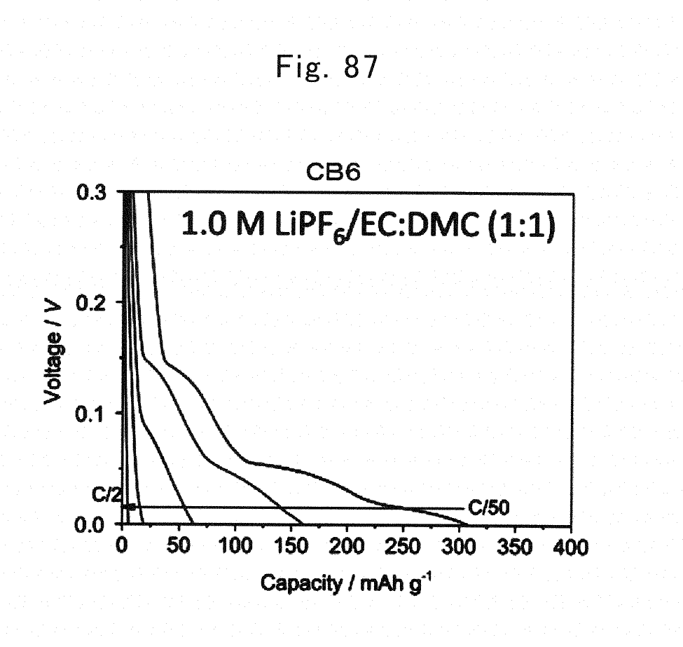

By using EB13 and CB6, rate characteristics at −20° C. were evaluated in the following manner. The results are shown in FIGS. 86 and 87.

(1) Current is supplied in a direction that causes occlusion of lithium to the negative electrode (evaluation electrode).

(2) Voltage range: From 2 V down to 0.01 V (v.s. Li/Li⁺)

(3) Rate: 0.02 C, 0.05 C, 0.1 C, 0.2 C, and 0.5 C (stop current after reaching 0.01 V)

1 C represents a current value required for fully charging or discharging a battery in 1 hour under constant current.

Based on FIGS. 86 and 87, voltage curves of EB13 are understood as to show high voltage at each of the current rates when compared to voltage curves of CB6. Based on this result, the nonaqueous electrolyte secondary battery of the present invention was confirmed to show excellent rate characteristics even in a low-temperature environment.

### Example 2-1

Polyacrylic acid (PAA) was dissolved in pure water to prepare a binding agent solution. To this binding agent solution, a flake-like graphite powder was added and mixed to prepare a negative electrode mixture material in a slurry form. The composition ratio of each component (solid content) in the slurry was graphite:PAA=90:10 (mass ratio).

The slurry was applied on the surface of an electrolytic copper foil (current collector) having a thickness of 18 μm using a doctor blade to form a negative electrode active material layer on the copper foil.

The negative electrode active material layer was dried for 20 minutes at 80° C. to remove the pure water therefrom through evaporation. After the drying, the current collector and the negative electrode active material layer were attached firmly and joined by using a roll press machine. The obtained joined object was vacuum dried at 80° C. for 6 hours to obtain a negative electrode whose thickness of the negative electrode active material layer was about 30 μm.

By using the produced negative electrode described above as an evaluation electrode, a nonaqueous electrolyte secondary battery (half-cell) was produced. A metallic lithium foil (thickness of 500 μm) was used as a counter electrode.

The counter electrode and the evaluation electrode were cut respectively to have diameters of 15 mm and 11 mm, and a separator (Whatman glass fiber filter paper having a thickness of 400 μm) was interposed therebetween to form an electrode assembly battery. This electrode assembly battery was housed in a battery case (CR2032 coin cell manufactured by Hohsen Corp.). Electrolytic solution E8 was injected therein, and the battery case was sealed to obtain a nonaqueous electrolyte secondary battery of Example 2-1. Details of the nonaqueous electrolyte secondary battery of Example 2-1 and nonaqueous electrolyte secondary batteries of respective Examples in the following are shown in Table 40 provided at the end of the Examples section.

### Example 2-2

A negative electrode was produced similarly to Example 2-1, except for using, as a binding agent, a mixture of CMC and SBR (CMC:SBR=1:1 in mass ratio) instead of PAA and using a mass ratio of active material:binding agent=98:2. Other than that, a nonaqueous electrolyte secondary battery of Example 2-2 was obtained similarly to Example 2-1.

### Comparative Example 2-1

A negative electrode was produced similarly to Example 2-1 except for using, as a binding agent, PVdF instead of PAA at an amount equivalent to PAA. Other than that, a nonaqueous electrolyte secondary battery of Comparative Example 2-1 was obtained similarly to Example 2-1.

### Comparative Example 2-2

A negative electrode was produced similarly to Example 2-1 except for using, as a binding agent, PVdF instead of PAA at an amount equivalent to PAA. A nonaqueous electrolyte secondary battery was obtained similarly to Example 2-1 except for using this negative electrode as an evaluation electrode and using electrolytic solution C5 instead of electrolytic solution E8.

By using the nonaqueous electrolyte secondary batteries of Examples 2-1 and 2-2 and Comparative Examples 2-1 and 2-2, rate capacity characteristics, cycle capacity retention rates, and load characteristics were each evaluated.

### Evaluation Example 30: Rate Capacity

(1) Current is supplied in a direction that causes occlusion of lithium to negative electrode.

(2) Voltage range: From 2 V down to 0.01 V (v.s. Li/Li⁺)

(3) Rate: 0.1 C, 0.2 C, 0.5 C, 1 C, 2 C, 5 C, 10 C, and 0.1 C (stop current after reaching 0.01 V).

(4) Three measurements at each rate (a total of 24 cycles).

By using the above described conditions, current capacity at 0.1 C and current capacity at each of the C rates were measured. Then, a ratio of current capacity at 2 C rate with respect to current capacity at 0.1 C rate, and a ratio of current capacity at 5 C rate with respect to current capacity at 0.1 C rate were obtained. The results are shown in Table 30. 1 C represents a current value required for fully charging or discharging a battery in 1 hour under constant current.

### Evaluation Example 31: Cycle Capacity Retention Rate

As a cycle capacity retention rate, a ratio of current capacity at the 25-th cycle with respect to current capacity at the first cycle was calculated. The results are shown in Table 30.

TABLE 30

| | | | Cycle | | |
|---|---|---|---|---|---|
| | | | capacity | Rate | |
| | | | Retention | capacity | |
| | | | rate | characteristic | |
| | Electrolytic | Binding | 25 cyc/ | 2 C/ | 5 C/ |
| | solution | agent | 1 cyc | 0.1 C | 0.1 C |
| Example 2-1 | 4.5M LiFSA/AN | PAA | 0.998 | 0.42 | 0.10 |
| Example 2-2 | 4.5M LiFSA/AN | CMC-SBR | 0.998 | 0.45 | 0.10 |
| Comparative | 4.5M LiFSA/AN | PVdF | 0.965 | 0.42 | 0.03 |
| Example 2-1 | | | | | |
| Comparative | 1M | PVdF | 0.992 | 0.15 | 0.04 |
| Example 2-2 | LiPF₆/EC + DEC | | | | |
| | (3:7) | | | | |

From a comparison between Example 2-1 and Comparative Example 2-1, by combining the electrolytic solution of the present invention with a PAA binding agent, cycle capacity retention rate and load characteristics on a high rate side (5 C/0.1 C) were recognized as being largely improved when compared to a combination of the electrolytic solution of the present invention and a PVdF binding agent. Since the cycle capacity retention rate in Comparative Example 2-2 is high, the phenomenon regarding decrease in cycle capacity retention rate in Comparative Example 2-1 is thought to be a characteristic phenomenon resulting from the combination of the electrolytic solution of the present invention and the PVdF binding agent.

In addition, from a comparison between Example 2-2 and Comparative Example 2-1, also by combining the electrolytic solution of the present invention and a CMC-SBR binding agent, cycle capacity retention rate and load characteristics at a high rate side (5 C/0.1 C) were recognized as being largely improved when compared to a combination of the electrolytic solution of the present invention and the PVdF binding agent.

Since the cycle capacity retention rate is high in Comparative Example 2-2 regardless of the usage of the PVdF binding agent, a proper combination with a binding agent is recognized to be necessary when using the electrolytic solution of the present invention.

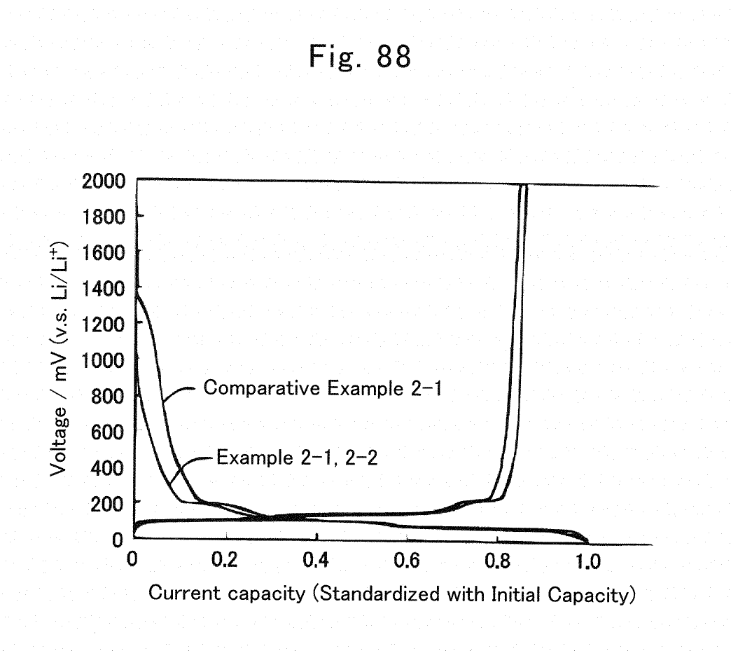

Initial charging/discharging curves of the nonaqueous electrolyte secondary batteries of Examples 2-1 and 2-2 and Comparative Example 2-1 are shown in FIG. 88.

From FIG. 88, although a side reaction is confirmed to have occurred at around 1.3 V (vs. Li) in an initial charging in Comparative Example 2-1, a side reaction is confirmed to be suppressed in Examples 2-1 and 2-2 with a proper combination of the electrolytic solution of the present invention and the binding agent. Based on this, cycle characteristics are speculated to have improved in Examples 2-1 and 2-2. Although the reason why the side reaction is suppressed is uncertain, the reason may be a protective action by the binding agent including a hydrophilic group.

When charging/discharging curves at the high rate side (5 C) were compared between Example 2-1 and Comparative Example 2-1, although a plateau range derived from cell reaction was confirmed in Example 2-1, the plateau range derived from cell reaction was not confirmed in Comparative Example 2-1, and only a small charge capacity was obtained through a mechanism of an adsorption system. Based on this, the improvement in load characteristics in Example 2-1 is speculated to be a result of not because of an increase in adsorption capacity, but because of a decrease in concentration overpotential caused by a lithium-supplying action by the PAA binding agent.

### Example 2-3

A mixture of CMC and SBR (mass ratio of CMC:SBR=1:1) was dissolved in pure water to prepare a binding agent solution. To this binding agent solution, a graphite powder was added and mixed to prepare a negative electrode mixture in a slurry form. The composition ratio of respective components (solid content) in the slurry was graphite:CMC:SBR=98:1:1 (mass ratio).

An electrolytic copper foil having a thickness of 20 μm was used as a negative electrode current collector, and the above described slurry was applied on the surface of the negative electrode current collector using a doctor blade to form a negative electrode active material layer on the current collector.

Then, the organic solvent was removed from the negative electrode active material layer through volatilization by drying the negative electrode active material layer at 80° C. for 20 minutes. After the drying, the negative electrode current collector and the negative electrode active material layer were attached firmly and joined by using a roll press machine. The obtained joined object was vacuum dried at 100° C. for 6 hours to form a negative electrode whose weight per area of the negative electrode active material layer was about 8.5 mg/cm².

The positive electrode active material layer includes a positive electrode active material, a binding agent, and a conductive additive. NCM523 was used as the positive electrode active material, PVDF was used as the binding agent, and AB was used as the conductive additive. The positive electrode current collector is formed from an aluminum foil having a thickness of 20 μm. The contained mass ratio of the positive electrode active material, the binding agent, and the conductive additive is 94:3:3 when mass of the positive electrode active material layer is defined as 100 parts by mass.

NCM523, PVDF, and AB were mixed in the above described mass ratio, and NMP was added thereto as the solvent to obtain a positive electrode mixture in a paste form. The positive electrode mixture in the paste form was applied on the surface of the positive electrode current collector using a doctor blade to form the positive electrode active material layer. The positive electrode active material layer was dried for 20 minutes at 80° C. to remove NMP through volatilization. A complex of the positive electrode active material layer and the positive electrode current collector was compressed using a roll press machine to firmly attach and join the positive electrode current collector and the positive electrode active material layer. The obtained joined object was heated in a vacuum dryer for 6 hours at 120° C. and cut in a predetermined shape to obtain the positive electrode.

By using the positive electrode, the negative electrode, and electrolytic solution E8 described above, a laminated type lithium ion secondary battery, which is one type of the nonaqueous electrolyte secondary battery, was produced. In detail, a cellulose nonwoven fabric (thickness of 20 μm) was interposed between the positive electrode and the negative electrode as a separator to form an electrode assembly. The electrode assembly was covered with a set of two sheets of a laminate film. The laminate film was formed into a bag-like shape by having three sides thereof sealed, and the electrolytic solution was injected therein. Four sides were sealed airtight by sealing the remaining one side to obtain a nonaqueous electrolyte secondary battery of Example 2-3 in which the electrode assembly and the electrolytic solution were sealed.

### Comparative Example 2-3

A negative electrode was produced similarly to Example 2-3 except for using, as a binding agent, 10 mass % of PVdF instead of CMC-SBR. Other than that, a nonaqueous electrolyte secondary battery of Comparative Example 2-3 was obtained similarly to Example 2-3.

### Comparative Example 2-4

A nonaqueous electrolyte secondary battery of Comparative Example 2-4 was obtained similarly to Example 2-3 except for using electrolytic solution C5 instead of electrolytic solution E8.

### Comparative Example 2-5

90 parts by mass of natural graphite which is a negative electrode active material and 10 parts by mass of PVdF which is a binding agent were mixed. This mixture was dispersed in a proper amount of ion exchanged water to obtain a negative electrode mixture in a slurry form. As the negative electrode current collector, a copper foil having a thickness of 20 μm was prepared. The negative electrode mixture was applied in a film form on the surface of the negative electrode current collector by using a doctor blade. A complex of the negative electrode mixture and the negative electrode current collector was dried to remove water, and then pressed to obtain a joined object. The obtained joined object was dried and heated for 6 hours at 120° C. in a vacuum dryer to obtain a negative electrode in which the negative electrode active material layer was formed on the negative electrode current collector.

A positive electrode was produced similarly to the positive electrode of the nonaqueous electrolyte secondary battery of Example 2-3. Except for using the positive electrode, the negative electrode, and electrolytic solution C5, a nonaqueous electrolyte secondary battery of Comparative Example 2-5 was obtained similarly to Example 2-3.

### Evaluation Example 32: Input-Output Characteristics

By using the nonaqueous electrolyte secondary batteries of Example 2-3 and Comparative Examples 2-3 to 2-5, input (charging) characteristics were evaluated using the following conditions.

(1) Usage voltage range: 3 V to 4.2 V

(2) Capacity: 13.5 mAh

(3) SOC: 80%

(4) Temperature: 0° C., 25° C.

(5) Number of measurements: Three times each

The used evaluation conditions were: state of charge (SOC) of 80%, 0° C. or 25° C., usage voltage range of 3 V to 4.2 V, and capacity of 13.5 mAh. SOC 80% at 0° C. is in a range in which input characteristics are unlikely to be exerted such as, for example, when used in a cold room. Evaluation of input characteristics of Example 2-3 and Comparative Examples 2-3 and 2-4 was performed three times each for 2-second input and 5-second input. Evaluation results of input characteristics are shown in Tables 31 and 32. In the tables, “2-second input” refers to an input inputted at 2 seconds after the start of charging, and “5-second input” refers to an input inputted at 5 seconds after the start of charging. In Tables 31 and 32, electrolytic solution E8 used in Example 2-3 and Comparative Example 2-3 is abbreviated as “FSA,” and electrolytic solution C5 used in Comparative Examples 2-4 and 2-5 is abbreviated as “ECPF.”

TABLE 31

| | Example | Comparative | Comparative | Comparative |
|---|---|---|---|---|
| | 2-3 | Example 2-3 | Example 2-4 | Example 2-5 |
| Binding agent | CMC-SBR | PVDF | CMC-SBR | PVDF |
| Electrolytic | FSA | FSA | ECPF | ECPF |
| solution | | | | |
| 2-second input | 1271.2 | 958.3 | 716.9 | 756.9 |
| (mW) | 1353.7 | 1255.0 | 685.5 | |
| | 1230.4 | 1127.5 | 794.2 | |
| 5-second input | 992.7 | 737.1 | 591.9 | 614.2 |
| (mW) | 1059.1 | 973.5 | 564.0 | |
| | 960.6 | 864.0 | 650.6 | |
| Battery input | 6255.0 | 3762.1 | 3563.9 | 2558.4 |
| density (W/L) | | | | |

(25° C., SOC80%)

TABLE 32

| | Example | Comparative | Comparative | Comparative |
|---|---|---|---|---|
| | 2-3 | Example 2-3 | Example 2-4 | Example 2-5 |
| Binding agent | CMC-SBR | PVDF | CMC-SBR | PVDF |
| Electrolytic | FSA | FSA | ECPF | ECPF |
| solution | | | | |
| 2-second input | 500.6 | 362.9 | 230.9 | 218.3 |
| (mW) | 530.6 | 482.6 | 209.7 | |
| | 464.3 | 424.0 | 256.3 | |
| 5-second input | 408.6 | 298.7 | 205.9 | 191.2 |
| (mW) | 433.9 | 396.4 | 188.3 | |
| | 382.7 | 350.7 | 226.0 | |

(0° C., SOC80%)

At both 0° C. and 25° C., input (charging) characteristics were improved more in Example 2-3 than in Comparative Examples 2-3 to 2-5. This is the effect of using the electrolytic solution of the present invention and the binding agent (CMC-SBR) having the hydrophilic group in combination, and, since high input (charging) characteristics were shown particularly even at 0° C., movement of lithium ions in the electrolytic solution is shown to occur smoothly even at a low temperature.

### Example 2-4

A negative electrode including a negative electrode active material layer having a weight per area of about 4 mg/cm² was formed similarly to Example 2-1, except for using, as a binding agent, a mixture of CMC and SBR (CMC:SBR=1:1 in mass ratio) instead of PAA, using a mass ratio of active material:binding agent=98:2, and setting the vacuum-drying temperature at 100° C.

NCM523 was used as the positive electrode active material, PVDF was used as the binding agent, and AB was used as the conductive additive. An aluminum foil having a thickness of 20 μm was used as the positive electrode current collector. When the positive electrode active material layer is defined as 100 parts by mass, the contained mass ratio of the positive electrode active material, the conductive additive, and the binding agent was 90:8:2. By using the positive electrode active material, the conductive additive, the binding agent, and the positive electrode current collector, a positive electrode was obtained similarly to Example 2-3.

By using the positive electrode, the negative electrode, and the electrolytic solution E11 described above, a nonaqueous electrolyte secondary battery of Example 2-4 was obtained similarly to Example 2-3.

### Comparative Example 2-6

A nonaqueous electrolyte secondary battery of Comparative Example 2-6 was obtained similarly to Example 2-4 except for using electrolytic solution C5 instead of electrolytic solution E11.

### Evaluation Example 33: Cycle Durability of Battery

By using the nonaqueous electrolyte secondary batteries of Example 2-4 and Comparative Example 2-6, a cycle involving charging to 4.1 V under a condition of CC charging of 1 C at a temperature 25° C., pausing for 1 minute, discharging to 3.0 V with CC discharging of 1 C, and pausing for 1 minute, was repeated for 500 cycles as a cycle test. The results of measuring a discharge capacity retention rate at the 500-th cycle are shown in Table 33. The discharge capacity retention rate is a percentage of a value obtained by dividing a discharge capacity at the 500-th cycle by the first discharge capacity ((Discharge capacity at 500-th cycle)/(First discharge capacity)×100).

At the 200-th cycle, after the voltage was adjusted to 3.5 V at a temperature of 25° C. with a CCCV of 0.5 C, a direct current resistance was measured based on Ohm's law from a current value and an amount of change in voltage (a difference between pre-discharge voltage and voltage obtained 10 seconds after discharging) when CC discharging was performed at 3 C for 10 seconds. The results are shown in Table 33.

TABLE 33

| | | | | Direct |
|---|---|---|---|---|
| | | | Capacity | current |
| | Electrolytic | Binding | retention rate | resistance |
| | solution | agent | (%) | (Ω) |
| Example 2-4 | E11 [LiFSA/DMC] | CMC/SBR | 92 | 3.4 |
| Comparative | C5 | CMC/SBR | 82 | 6 |
| Example 2-6 | [LiPF₆/EC + DEC] | | | |

E11: 3.9M LiFSA/DMC, C5: 1.0M LiPF₆/EC + DEC

As observed in Example 2-4, cycle life improves and a secondary battery with low resistance is obtained, by combining the binding agent formed of a polymer having a hydrophilic group and the electrolytic solution of the present invention.

### Example 2-5

A negative electrode was produced similarly to Example 2-4 except for using PAA instead of CMC-SBR such that a mass ratio of active material:binding agent=90:10 was obtained. Other than using this negative electrode, a nonaqueous electrolyte secondary battery of Example 2-5 was obtained similarly to Example 2-4.

### Evaluation Example 34: High-Temperature Storage Resistance of Battery

By using the lithium secondary batteries of Examples 2-4 and 2-5 and Comparative Example 2-6, a high-temperature storage test of storing at 60° C. for 1 week was performed. Before starting the high-temperature storage test, the charge capacity when 4.1 V was reached from 3.0 V through CC-CV was used as a standard (SOC100), and a portion of 20% with respect to this standard was CC discharged (adjust to SOC80), and then the high-temperature storage test was started. After the high-temperature storage test, 3.0 V was achieved at 1 C through CC-CV, and the storage capacity was calculated, from the following formula, based on a ratio of the obtained discharge capacity and capacity at SOC80 before storage. The results are shown in Table 34.

Storage capacity=100×(CC-CV discharge capacity after storage)/(Capacity at SOC80 before storage)

TABLE 34

| | Electrolytic | Binding | Storage capacity |
|---|---|---|---|
| | solution | agent | (%) |
| Example 2-4 | E11 [LiFSA/DMC] | CMC/SBR | 54 |
| Example 2-5 | E11 [LiFSA/DMC] | PAA | 57 |
| Comparative | C5 [LiPF₆/EC + DEC] | CMC/SBR | 20 |
| Example 2-6 | | | |

E11: 3.9M LiFSA/DMC, C5: 1.0M LiPF₆/EC + DEC

As observed in Examples 2-4 and 2-5, capacity after high temperature storage improves, by combining the binding agent formed of a polymer having a hydrophilic group and the electrolytic solution of the present invention.

### Evaluation Example 35: Cycle Durability of Battery

With respect to each of the nonaqueous electrolyte secondary batteries of Example 2-4 and Comparative Example 2-6, CC charging and discharging were repeated for 500 cycles at room temperature in a range of 3.0 V to 4.1 V (vs. Li reference), and a discharging current capacity (Ah) and a charging current capacity (Ah) at each of the cycles were measured. Based on the measured values, coulombic efficiency (%) at each of the cycles was calculated, and an average of coulombic efficiencies from the first charging and discharging (i.e., first cycle) to the 500-th cycle was calculated. In addition, discharge capacity at the first charging and discharging and discharge capacity at the 500-th cycle were measured. Furthermore, a capacity of each of the nonaqueous electrolyte secondary batteries at the first charging and discharging was defined as 100%, and capacity retention rate (%) of each of the nonaqueous electrolyte secondary batteries at the 500-th cycle was calculated. Coulombic efficiency was calculated based on ((Discharging current capacity)/(Charging current capacity))×100. The results are shown in Table 35.

TABLE 35

| | | Comparative Example |
|---|---|---|
| | Example 2-4 | 2-6 |
| Electrolytic solution | E11 | C5 [LiPF₆(EC/DEC)] |
| | [LiFSA/DMC] | |
| Binding agent | CMC-SBR | CMC-SBR |
| Capacity retention rate (%) at | 92 | 82 |
| 500^{th} cycle | | |
| Coulombic efficiency (%) | 99.93 | 99.87 |
| 500 cycle average | | |

E11: 3.9M LiFSA/DMC, C5: 1.0M LiPF₆/(EC/DEC)

As shown in Table 35, the nonaqueous electrolyte secondary battery of Example 2-4 had high coulombic efficiency and a high capacity retention rate when compared to the nonaqueous electrolyte secondary battery of Comparative Example 2-6. In other words, by combining LiFSA and CMC-SBR respectively as the metal salt and the binding agent, cycle characteristics of the nonaqueous electrolyte secondary battery is improved compared to when LiPF₆ and CMC-SBR are combined respectively as the metal salt and the binding agent. In addition, in the nonaqueous electrolyte secondary battery of the present invention using the polymer having a hydrophilic group as the binding agent, LiFSA is suitably used as the metal salt of the electrolytic solution.

Coulombic efficiency tends to increase as side reactions (i.e., reactions other than a cell reaction such as degradation of an electrolyte) at the negative electrode decrease. Side reactions at the negative electrode are mostly irreversible reactions in which Li is irreversibly captured in the negative electrode, and may cause a decrease in battery capacity. Thus, in each of the nonaqueous electrolyte secondary batteries of Example 4, the side reactions described above are speculated to be suppressed, as a result, leading to the increase in the capacity retention rate at the 500-th cycle.

As reference, the coulombic efficiency shown in Table 35 is an average of 500 cycles, i.e., a value per one cycle. Thus, if the value is accumulated over 500 cycles, the difference in coulombic efficiency between Example 2-4 and Comparative Example 2-6 becomes extremely large.

### Example 2-6

A nonaqueous electrolyte secondary battery of Example 2-6 was obtained similarly to Example 2-3 except for using a positive electrode (NCM523:AB:PVdF=90:8:2) identical to that of Example 2-4 and a negative electrode (natural graphite:PAA=90:10) identical to that of Example 2-1.

### Example 2-7

A nonaqueous electrolyte secondary battery of Example 2-7 was obtained similarly to Example 2-3 except for using a positive electrode (NCM523:AB:PVdF=90:8:2) identical to that of Example 2-4 and a negative electrode (natural graphite:CMC:SBR=98:1:1) identical to that of Example 2-2.

### Comparative Example 2-7

A nonaqueous electrolyte secondary battery of Comparative Example 2-7 was obtained with a method similar to that of Example 2-6 except for using electrolytic solution C5.

### Comparative Example 2-8

A nonaqueous electrolyte secondary battery of Comparative Example 2-8 was obtained with a method similar to that of Example 2-7 except for using electrolytic solution C5.

### Evaluation Example 36: Cycle Durability of Battery

With respect to each of the nonaqueous electrolyte secondary batteries of Examples 2-6 and 2-7, charging and discharging were repeated for 200 cycles with a method similar to that in “Evaluation Example 33: Cycle Durability of Battery” described above, and capacity retention rate (%) and coulombic efficiency (%, average of 200 cycles) of each of the nonaqueous electrolyte secondary batteries after 200 cycles were calculated. The results are shown in Table 36.

TABLE 36

| | Example 2-6 | Example 2-7 |
|---|---|---|
| Electrolytic solution | E8 [LiFSA/AN] | E8 [LiFSA/AN] |
| Binding agent | PAA | CMC-SBR |
| Capacity retention rate (%) at | 87 | 81 |
| 200^{th} cycle | | |
| Coulombic efficiency (%) | 99.83 | 99.77 |
| 200 cycle average | | |

E8: 4.5M LiFSA/AN

As shown in Table 36, the nonaqueous electrolyte secondary battery of Example 2-6 was superior in capacity retention rate and coulombic efficiency when compared to the nonaqueous electrolyte secondary battery of Example 2-7. From this result, PAA is considered more preferable as the binding agent.

### Evaluation Example 37: Cycle Durability of Battery

With respect to the each of the nonaqueous electrolyte secondary batteries of Examples 2-6 and 2-7 and Comparative Examples 2-7 and 2-8, capacity retention rate (%) of each of the nonaqueous electrolyte secondary batteries after 203 cycles was calculated in a manner approximately similar to that in “Evaluation Example 36: Cycle Durability of Battery” described above. More specifically, in this test, the third cycle was set as the start of the test, and a capacity retention rate after 200 cycles of charging and discharging was obtained. In addition, at the start of the test, i.e., at the third cycle, adjustment to a voltage of 3.5 V with CCCV at 0.5 C at a temperature of 25° C. was performed, and a direct current resistance was measured based on Ohm's law using the amount of voltage change (difference between pre-discharge voltage and voltage after 10 seconds of discharging) and current value when CC discharging was performed for 10 seconds at 3 C. The obtained direct current resistance was used as an initial direct-current resistance. The results are shown in Table 37.

TABLE 37

| | Example | Example | Comparative | Comparative |
|---|---|---|---|---|
| | 2-6 | 2-7 | Example 2-7 | Example 2-8 |
| Electrolytic | E8 | E8 | C5 | C5 |
| solution | [LiFSA/AN] | [LiFSA/AN] | [LiPF₆/ | [LiPF₆/ |
| | | | (EC/DEC)] | (EC/DEC)] |
| Binding agent | PAA | CMC-SBR | PAA | CMC-SBR |
| Capacity | 87 | 81 | 90 | 96 |
| retention rate | | | | |
| (%) at 203^{th} | | | | |
| cycle | | | | |
| Initial | 2.8 | 2.9 | 5.3 | 4.3 |
| direct-current | | | | |
| resistance (Ω) | | | | |

E8: 4.5M LiFSA/AN, C5: 1.0M LiPF₆/(EC/DEC)

As shown in Table 37, among the nonaqueous electrolyte secondary batteries of Examples 2-6 and 2-7 and Comparative Examples 2-7 and 2-8, the capacity retention rates at the 203-th cycle were approximately the same, and were all high values. PAA is considered excellent as the binding agent based on a comparison of Examples 2-6 and 2-7, and CMC-SBR is considered excellent as the binding agent based on a comparison of Comparative Examples 2-7 and 2-8. Thus, in the nonaqueous electrolyte secondary battery of the present invention using the electrolytic solution of the present invention, using PAA is more preferable than using CMC-SBR as the binding agent.

The nonaqueous electrolyte secondary batteries of Examples 2-6 and 2-7 using LiFSA as the metal salt have shown low initial direct-current resistance when compared to the nonaqueous electrolyte secondary batteries of Comparative Examples 2-6 and 2-7 using LiPF₆ as the metal salt. Thus, in order to achieve both an improvement in capacity retention rate and suppression of increase in resistance, the nonaqueous electrolyte secondary batteries of Examples 2-6 and 2-7 using the electrolytic solution of the present invention and a binding agent having a hydrophilic group as the binding agent, i.e., the nonaqueous electrolyte secondary battery of the present invention, are advantageous.

### Evaluation Example 38: High-Temperature Storage Resistance of Battery

By using the nonaqueous electrolyte secondary batteries of Examples 2-6 and 2-7 and Comparative Examples 2-7 and 2-8, a high-temperature storage test of storing at 60° C. for 1 week was performed. The charge capacity obtained when 4.1 V was achieved from 3.0 V through CC-CV before starting the high-temperature storage test was used as a standard, i.e., SOC100. The high-temperature storage test was started after adjusting each of the batteries to SOC80 by CC discharging a portion of 20% with respect to the standard. After the high-temperature storage test, 3.0 V was achieved at 1 C through CC-CV, and the remaining capacity was calculated from the following formula based on a ratio of the obtained discharge capacity with respect to the capacity at SOC80 before storage.

Remaining capacity=100×(CC-CV discharge capacity after storage)/(Capacity at SOC80 before storage)

Storage capacity was calculated. The results are shown in Table 38.

TABLE 38

| | Example | Example | Comparative | Comparative |
|---|---|---|---|---|
| | 2-6 | 2-7 | Example 2-7 | Example 2-8 |
| Electrolytic | E8 | E8 | C5 | C5 |
| solution | [LiFSA/AN] | [LiFSA/AN] | [LiPF₆/ | [LiPF₆/ |
| | | (EC/DEC)] | (EC/DEC)] | |
| Binding agent | PAA | CMC-SBR | PAA | CMC-SBR |
| Remaining | 42 | 36 | 33 | 20 |
| capacity (%) | | | | |

E8: 4.5M LiFSA/AN, C5: 1.0M LiPF₆/(EC/DEC)

As shown in Table 38, the nonaqueous electrolyte secondary battery of Example 2-6 had a large remaining capacity when compared to the nonaqueous electrolyte secondary battery of Example 2-7. Thus, the nonaqueous electrolyte secondary battery of Example 2-6 in which LiFSA/AN was combined with PAA was superior in high-temperature storage characteristics when compared to the nonaqueous electrolyte secondary battery of Example 2-7 in which LiFSA/AN was combined with CMC-SBR. Based on this result, the nonaqueous electrolyte secondary battery of the present invention in which the electrolytic solution of the present invention was combined with the binding agent formed of a polymer having a hydrophilic group is understood as to have a high-temperature storage resistance comparable to or better than a conventional nonaqueous electrolyte secondary battery in which a general electrolytic solution is combined with the binding agent formed of a polymer having a hydrophilic group.

(Other Mode II)

The following specific electrolytic solutions are provided as the electrolytic solution of the present invention. The following electrolytic solutions also include those previously stated.

(Electrolytic Solution A)

The electrolytic solution of the present invention was produced in the following manner.

Approximately 5 mL of 1,2-dimethoxyethane, which is an organic solvent, was placed in a flask including a stirring bar and a thermometer. Under a stirring condition, with respect to 1,2-dimethoxyethane in the flask, (CF₃SO₂)₂NLi, which is a lithium salt, was gradually added so as to maintain a solution temperature equal to or lower than 40° C. to be dissolved. Since dissolving of (CF₃SO₂)₂NLi momentarily stagnated at a time point when approximately 13 g of (CF₃SO₂)₂NLi was added, the flask was heated by placing the flask in a temperature controlled bath such that the solution temperature in the flask reaches 50° C. to dissolve (CF₃SO₂)₂NLi. Since dissolving of (CF₃SO₂)₂NLi stagnated again at a time point when approximately 15 g of (CF₃SO₂)₂NLi was added, a single drop of 1,2-dimethoxyethane was added thereto using a pipette to dissolve (CF₃SO₂)₂NLi. Furthermore, (CF₃SO₂)₂NLi was gradually added to accomplish adding an entire predetermined amount of (CF₃SO₂)₂NLi. The obtained electrolytic solution was transferred to a 20-mL measuring flask, and 1,2-dimethoxyethane was added thereto until a volume of 20 mL was obtained. The volume of the obtained electrolytic solution was 20 mL, and 18.38 g of (CF₃SO₂)₂NLi was contained in the electrolytic solution. This was used as electrolytic solution A. In electrolytic solution A, the concentration of (CF₃SO₂)₂NLi was 3.2 mol/L and the density was 1.39 g/cm³. The density was measured at 20° C.

The production was performed within a glovebox under an inert gas atmosphere.

(Electrolytic Solution B)

With a method similar to that of electrolytic solution A, electrolytic solution B whose concentration of (CF₃SO₂)₂NLi was 2.8 mol/L and whose density was 1.36 g/cm³ was produced.

(Electrolytic Solution C)

Approximately 5 mL of acetonitrile, which is an organic solvent, was placed in a flask including a stirring bar. Under a stirring condition, with respect to acetonitrile in the flask, (CF₃SO₂)₂NLi, which is a lithium salt, was gradually added to be dissolved. A predetermined amount of (CF₃SO₂)₂NLi was added to the flask, and stirring was performed overnight in the flask. The obtained electrolytic solution was transferred to a 20-mL measuring flask, and acetonitrile was added thereto until a volume of 20 mL was obtained. This was used as electrolytic solution C. The production was performed within a glovebox under an inert gas atmosphere.

Electrolytic solution C contained (CF₃SO₂)₂NLi at a concentration of 4.2 mol/L, and had a density of 1.52 g/cm³.

(Electrolytic Solution D)

With a method similar to that of electrolytic solution C, electrolytic solution D whose concentration of (CF₃SO₂)₂NLi was 3.0 mol/L and whose density was 1.31 g/cm³ was produced.

(Electrolytic Solution E)

With a method similar to that of electrolytic solution C except for using sulfolane as the organic solvent, electrolytic solution E whose concentration of (CF₃SO₂)₂NLi was 3.0 mol/L and whose density was 1.57 g/cm³ was produced.

(Electrolytic Solution F)

With a method similar to that of electrolytic solution C except for using dimethyl sulfoxide as the organic solvent, electrolytic solution F whose concentration of (CF₃SO₂)₂NLi was 3.2 mol/L and whose density was 1.49 g/cm³ was produced.

(Electrolytic Solution G)

With a method similar to that of electrolytic solution C except for using (FSO₂)₂NLi as the lithium salt and using 1,2-dimethoxyethane as the organic solvent, electrolytic solution G whose concentration of (FSO₂)₂NLi was 4.0 mol/L and whose density was 1.33 g/cm³ was produced.

(Electrolytic Solution H)

With a method similar to that of electrolytic solution G, electrolytic solution H whose concentration of (FSO₂)₂NLi was 3.6 mol/L and whose density was 1.29 g/cm³ was produced.

(Electrolytic Solution I)

With a method similar to that of electrolytic solution G, electrolytic solution I whose concentration of (FSO₂)₂NLi was 2.4 mol/L and whose density was 1.18 g/cm³ was produced.

(Electrolytic Solution J)

With a method similar to that of electrolytic solution G except for using acetonitrile as the organic solvent, electrolytic solution J whose concentration of (FSO₂)₂NLi was 5.0 mol/L and whose density was 1.40 g/cm³ was produced.

(Electrolytic Solution K)

With a method similar to that of electrolytic solution J, electrolytic solution K whose concentration of (FSO₂)₂NLi was 4.5 mol/L and whose density was 1.34 g/cm³ was produced.

(Electrolytic Solution L)

Approximately 5 mL of dimethyl carbonate, which is an organic solvent, was placed in a flask including a stirring bar. Under a stirring condition, with respect to dimethyl carbonate in the flask, (FSO₂)₂NLi, which is a lithium salt, was gradually added to be dissolved. A total amount of 14.64 g of (FSO₂)₂NLi was added to the flask, and stirring was performed overnight in the flask. The obtained electrolytic solution was transferred to a 20-mL measuring flask, and dimethyl carbonate was added thereto until a volume of 20 mL was obtained. This was used as electrolytic solution L. The production was performed within a glovebox under an inert gas atmosphere.

The concentration of (FSO₂)₂NLi in electrolytic solution L was 3.9 mol/L, and the density of electrolytic solution L was 1.44 g/cm³.

(Electrolytic Solution M)

With a method similar to that of electrolytic solution L, electrolytic solution M whose concentration of (FSO₂)₂NLi was 2.9 mol/L and whose density was 1.36 g/cm³ was produced.

(Electrolytic Solution N)

Approximately 5 mL of ethyl methyl carbonate, which is an organic solvent, was placed in a flask including a stirring bar. Under a stirring condition, with respect to ethyl methyl carbonate in the flask, (FSO₂)₂NLi, which is a lithium salt, was gradually added to be dissolved. A total amount of 12.81 g of (FSO₂)₂NLi was added to the flask, and stirring was performed overnight in the flask. The obtained electrolytic solution was transferred to a 20-mL measuring flask, and ethyl methyl carbonate was added thereto until a volume of 20 mL was obtained. This was used as electrolytic solution N. The production was performed within a glovebox under an inert gas atmosphere.

The concentration of (FSO₂)₂NLi in electrolytic solution N was 3.4 mol/L, and the density of electrolytic solution N was 1.35 g/cm³.

(Electrolytic Solution O)

Approximately 5 mL of diethyl carbonate, which is an organic solvent, was placed in a flask including a stirring bar. Under a stirring condition, with respect to diethyl carbonate in the flask, (FSO₂)₂NLi, which is a lithium salt, was gradually added to be dissolved. A total amount of 11.37 g of (FSO₂)₂NLi was added to the flask, and stirring was performed overnight in the flask. The obtained electrolytic solution was transferred to a 20-mL measuring flask, and diethyl carbonate was added thereto until a volume of 20 mL was obtained. This was used as electrolytic solution O. The production was performed within a glovebox under an inert gas atmosphere.

The concentration of (FSO₂)₂NLi in electrolytic solution O was 3.0 mol/L, and the density of electrolytic solution O was 1.29 g/cm³.

Table 39 shows a list of the electrolytic solutions described above.

TABLE 39

| | Lithium salt | Organic solvent | Density d (g/cm³) |
|---|---|---|---|
| Electrolytic solution A | LiTFSA | DME | 1.39 |
| Electrolytic solution B | LiTFSA | DME | 1.36 |
| Electrolytic solution C | LiTFSA | AN | 1.52 |
| Electrolytic solution D | LiTFSA | AN | 1.31 |
| Electrolytic solution E | LiTFSA | SL | 1.57 |
| Electrolytic solution F | LiTFSA | DMSO | 1.49 |
| Electrolytic solution G | LiFSA | DME | 1.33 |
| Electrolytic solution H | LiFSA | DME | 1.29 |
| Electrolytic solution I | LiFSA | DME | 1.18 |
| Electrolytic solution J | LiFSA | AN | 1.40 |
| Electrolytic solution K | LiFSA | AN | 1.34 |
| Electrolytic solution L | LiFSA | DMC | 1.44 |
| Electrolytic solution M | LiFSA | DMC | 1.36 |
| Electrolytic solution N | LiFSA | EMC | 1.35 |
| Electrolytic solution O | LiFSA | DEC | 1.29 |

LiTFSA: (CF₃SO₂)₂NLi,
LiFSA: (FSO₂)₂NLi,
AN: acetonitrile,
DME: 1,2-dimethoxyethane,
DMSO: dimethyl sulfoxide,
SL: sulfolane,
DMC: dimethyl carbonate,
EMC: ethyl methyl carbonate,
DEC: diethyl carbonate

TABLE 40

| | | | | | | | Positive |
|---|---|---|---|---|---|---|---|
| | Positive | Negative electrode | | | | | electrode |
| | electrode | Natural | Natural | Natural | Electrolytic | | current |
| | NCM523:AB:PVdF | graphite:SBR:CMC | graphite:PAA | graphite:PVdF | solution | Separator | collector |
| Example 2-1 | Li | | 90:10 | | E8 | Whatman | Absent |
| | | | | | | glass fiber | |
| | | | | | | filter paper | |
| Example 2-2 | Li | 98:1:1 | | | E8 | Whatman | Absent |
| | | | | | | glass fiber | |
| | | | | | | filter paper | |
| Example 2-3 | 94:3:3 | 98:1:1 | | | E8 | 20 μm- | Al |
| | | | | | | cellulose | current |
| | | | | | | nonwoven | collector |
| | | | | | | fabric | |
| Example 2-4 | 90:8:2 | 98:1:1 | | | E11 | 20 μm- | Al |
| | | | | | | cellulose | current |
| | | | | | | nonwoven | collector |
| | | | | | | fabric | |
| Example 2-5 | 90:8:2 | | 90:10 | | E11 | 20 μm- | Al |
| | | | | | | cellulose | current |
| | | | | | | nonwoven | collector |
| | | | | | | fabric | |
| Example 2-6 | 90:8:2 | | 90:10 | | E8 | 20 μm- | Al |
| | | | | | | cellulose | current |
| | | | | | | nonwoven | collector |
| | | | | | | fabric | |
| Example 2-7 | 90:8:2 | 98:1:1 | | | E8 | 20 μm- | Al |
| | | | | | | cellulose | current |
| | | | | | | nonwoven | collector |
| | | | | | | fabric | |
| Comparative | Li | | | 90:10 | E8 | Whatman | None |
| Example 2-1 | | | | | | glass fiber | |
| | | | | | | filter paper | |
| Comparative | Li | | | 90:10 | C5 | Whatman | None |
| Example 2-2 | | | | | | glass fiber | |
| | | | | | | filter paper | |
| Comparative | 94:3:3 | | | 90:10 | E8 | 20 μm- | Al |
| Example 2-3 | | | | | | cellulose | current |
| | | | | | | nonwoven | collector |
| | | | | | | fabric | |
| Comparative | 94:3:3 | 98:1:1 | | | C5 | 20 μm- | Al |
| Example 2-4 | | | | | | cellulose | current |
| | | | | | | nonwoven | collector |
| | | | | | | fabric | |
| Comparative | 94:3:3 | | | 90:10 | C5 | 20 μm- | Al |
| Example 2-5 | | | | | | cellulose | current |
| | | | | | | nonwoven | collector |
| | | | | | | fabric | |
| Comparative | 90:8:2 | 98:1:1 | | | C5 | 20 μm- | Al |
| Example 2-6 | | | | | | cellulose | current |
| | | | | | | nonwoven | collector |
| | | | | | | fabric | |
| Comparative | 90:8:2 | | 90:10 | | C5 | 20 μm- | Al |
| Example 2-7 | | | | | | cellulose | current |
| | | | | | | nonwoven | collector |
| | | | | | | fabric | |
| Comparative | 90:8:2 | 98:1:1 | | | C5 | 20 μm- | Al |
| Example 2-8 | | | | | | cellulose | current |
| | | | | | | nonwoven | collector |
| | | | | | | fabric | |

1. A nonaqueous electrolyte secondary battery, comprising: a negative electrode, an electrolytic solution, and a positive electrode, wherein
one of the following Condition A or Condition B is satisfied:
Condition A: regarding an intensity of a peak derived from the organic solvent in a vibrational spectroscopy spectrum of the electrolytic solution, Is>Io is satisfied when an intensity of an original peak of the organic solvent is represented as Io and an intensity of a peak resulting from shifting of the original peak is represented as Is, or
Condition B: d/c obtained by dividing a density d (g/cm³) of the electrolytic solution by a salt concentration c (mol/L) of the electrolytic solution is within a range of 0.15≤d/c≤0.71,
the electrolytic solution contains a salt whose cation is an alkali metal, an alkaline earth metal, or aluminum, and an organic solvent having a heteroelement,
the negative electrode includes a binding agent formed of a polymer having a hydrophilic group,
the salt of the electrolytic solution consists of the salt whose cation is an alkali metal or an alkaline earth metal, and
the organic solvent of the electrolytic solution is selected from the group consisting of nitriles, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, crown ethers, carbonates, amides, isocyanates, esters, epoxies, oxazoles, ketones, acid anhydrides, sulfones, sulfoxides, nitros, furans, cyclic esters, aromatic heterocycles, non-aromatic heterocycles, and phosphoric acid esters.

2. The nonaqueous electrolyte secondary battery according to claim 1, wherein
the polymer having the hydrophilic group includes multiple carboxyl groups and/or sulfo groups in a single molecule thereof.

3. The nonaqueous electrolyte secondary battery according to claim 1, wherein
the polymer having the hydrophilic group is a water-soluble polymer.

4. The nonaqueous electrolyte secondary battery according to claim 1, wherein
the polymer having the hydrophilic group is a water-soluble polymer, and
the water-soluble polymer includes multiple carboxyl groups and/or sulfo groups in a single molecule thereof.

5. The nonaqueous electrolyte secondary battery according to claim 1, wherein
a chemical structure of the anion of the salt in the electrolytic solution includes at least one element selected from a halogen, boron, nitrogen, oxygen, sulfur, or carbon.

6. The nonaqueous electrolyte secondary battery according to claim 1, wherein
the chemical structure of the anion of the salt in the electrolytic solution is represented by formula (1), (2), or (3) below:
(R¹X¹)(R²X²)N Formula (1),
wherein, in the formula (1), R¹ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN,
R² is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN,
R¹ and R² optionally bind with each other to form a ring,
X¹ is selected from SO₂, C═O, C═S, R^{a}P═O, R^{b}P═S, S═O, or Si═O,
X² is selected from SO₂, C═O, C═S, R^{c}P═O, R^{d}P═S, S═O, or Si═O,
R^{a}, R^{b}, R^{c}, and R^{d} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN, and
R^{a}, R^{b}, R^{c}, and R^{d} each optionally bind with R¹ or R² to form a ring;
R³X³Y Formula (2),
wherein, in the formula (2), R³ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN,
X³ is selected from SO₂, C═O, C═S, R^{e}P═O, R^{f}P═S, S═O, or Si═O,
R^{e} and R^{f} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN,
R^{e} and R^{f} each optionally bind with R3 to form a ring, and
Y is selected from O or S; and
(R⁴X⁴)(R⁵X⁵)(R⁶X⁶)C Formula (3),
wherein, in the formula (3), R⁴ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN.
R⁵ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN,
R⁶ is selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; CN; SCN; or OCN,
any two or three of R⁴, R⁵, and R⁶ optionally bind with each other to form a ring,
X⁴ is selected from SO₂, C═O, C═S, R^{g}P═O, R^{h}P═S, S═O, or Si═O,
X⁵ is selected from SO₂, C═O, C═S, RⁱP═O, R^{j}P═S, S═O, or Si═O,
X⁶ is selected from SO₂, C═O, C═S, R^{k}P═O, R^{l}P═S, S═O, or Si═O,
R^{g}, R^{h}, Rⁱ, R^{j}, R^{k}, and R^{l} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN,
R^{g}, R^{h}, Rⁱ, R^{j}, R^{k}, and R^{l} each optionally bind with R⁴, R⁵, or R⁶ to form a ring.

7. The nonaqueous electrolyte secondary battery according to claim 1, wherein the chemical structure of the anion in the salt in the electrolytic solution is represented by general formula (4), (5), or (6) below:
(R⁷X⁷)(R⁸X⁸)N Formula (4),
wherein, in the formula (4), R⁷ and R⁸ are each independently CₙHₐF_{b}Cl_{c}Br_{d}Iₑ(CN)_{f}(SCN)_{g}(OCN)ₕ,
“n,” “a,” “b,” “c,” “d,” “e,” “f,” “g,” and “h” are each independently an integer not smaller than 0, and satisfy 2n+1=a+b+c+d+e+f+g+h,
R⁷ and R⁸ optionally bind with each other to form a ring, and, in that case, satisfy 2n=a+b+c+d+e+f+g+h,
X⁷ is selected from SO₂, C═O, C═S, R^{m}P═O, RⁿP═S, S═O, or Si═O,
X⁸ is selected from SO₂, C═O, C═S, R^{o}P═O, R^{p}P═S, S═O, or Si═O,
R^{m}, Rⁿ, R^{o}, and R^{p} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN, and
R^{m},Rⁿ,R^{o}, and R^{p} each optionally bind with R⁷ or R⁸ to form a ring;
R⁹X⁹Y Formula (5),
wherein, in formula (5), R⁹ is CₙHₐF_{b}Cl_{c}Br_{d}Iₑ(CN)_{f}(SCN)_{g}(OCN)ₕ.
“n,” “a,” “b,” “c,” “d,” “e,” “f,” “g,” and “h” are each independently an integer not smaller than 0, and satisfy 2n+1=a+b+c+d+e+f+g+h.
X⁹ is selected from SO₂, C═O, C═S, R^{q}P═O, R^{r}P═S, S═O, or Si═O,
R^{q} and R^{r} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN,
R^{q} and R^{r} each optionally bind with R⁹ to form a ring,
Y is selected from O or S; and
(R¹⁰x¹⁰)(R¹¹X¹¹)(R¹²X¹²)C Formula (6),
wherein, in the formula (6), R¹⁰, R¹¹, and R¹² are each independently CₙHₐF_{b}Cl_{c}Br_{d}Iₑ(CN)_{f}(SCN)_{g}(OCN)ₕ. “n,” “a,” “b,” “c,” “d,” “e,” “f,” “g,” and “h” are each independently an integer not smaller than 0, and satisfy 2n+1=a+b+c+d+e+f+g+h,
any two of R¹⁰, R¹¹, and R¹² optionally bind with each other to form a ring, and in that case, groups forming the ring satisfy 2n=a+b+c+d+e+f+g+h,
three of R¹⁰, R¹¹, and R¹² optionally bind with each other to form a ring, and, in that case, two groups satisfy 2n=a+b+c+d+e+f+g+h and one group satisfies 2n−1=a+b+c+d+e+f+g+h,
X¹⁰ is selected from SO₂, C═O, C═S, R^{s}P═O, R^{t}P═S, S═O, or Si═O,
X¹¹ is selected from SO₂, C═O, C═S, R^{u}P═O, R^{v}P═S, S═O, or Si═O,
X¹² is selected from SO₂, C═O, C═S, R^{w}P═O, R^{x}P═S, S═O, or Si═O,
R^{s}, R^{t}, R^{u}, R^{v}, R^{w}, and R^{x} are each independently selected from: hydrogen; a halogen; an alkyl group optionally substituted with a substituent group; a cycloalkyl group optionally substituted with a substituent group; an unsaturated alkyl group optionally substituted with a substituent group; an unsaturated cycloalkyl group optionally substituted with a substituent group; an aromatic group optionally substituted with a substituent group; a heterocyclic group optionally substituted with a substituent group; an alkoxy group optionally substituted with a substituent group; an unsaturated alkoxy group optionally substituted with a substituent group; a thioalkoxy group optionally substituted with a substituent group; an unsaturated thioalkoxy group optionally substituted with a substituent group; OH; SH; CN; SCN; or OCN, and
R^{s}, R^{t}, R^{u}, R^{v}, R^{w}, and R^{x} each optionally bind with R¹⁰, R¹¹ or R¹² to form a ring.

8. The nonaqueous electrolyte secondary battery according to claim 1, wherein the cation of the salt is lithium.

9. The nonaqueous electrolyte secondary battery according to claim 1, wherein the chemical structure of the anion of the salt is represented by general formula (7), (8), or (9) below:
(R¹³SO₂)(R¹⁴SO₂)N Formula (7),
wherein, in the formula (7), R¹³ and R¹⁴ are each independently CₙHₐF_{b}Cl_{c}Br_{d}Iₑ,
“n,” “a,” “b,” “c,” “d,” and “e” are each independently an integer not smaller than 0, and satisfy 2n+1=a+b+c+d+e, and
R¹³ and R¹⁴ optionally bind with each other to form a ring, and, in that case, satisfy 2n=a+b+c+d+e;
R¹⁵SO₃ Formula (8),
wherein, in the formula (8), R¹⁵ is CₙHₐF_{b}Cl_{c}Br_{d}Iₑ, and
“n,” “a,” “b,” “c,” “d,” and “e” are each independently an integer not smaller than 0, and satisfy 2n+1=a+b+c+d+e; and
(R¹⁶SO₂)(R¹⁷SO₂)(R¹⁸SO₂)C Formula (9),
wherein, in the formula (9), R¹⁶, R¹⁷, and R¹⁸ are each independently CₙHₐF_{b}Cl_{c}Br_{d}Iₑ,
“n,” “a,” “b,” “c,” “d,” and “e” are each independently an integer not smaller than 0, and satisfy 2n+1=a+b+c+d+e,
any two of R¹⁶, R¹⁷, and R¹⁸ optionally bind with each other to form a ring, and, in that case, groups forming the ring satisfy 2n=a+b+c+d+e, and
three of R¹⁶, R¹⁷, and R¹⁸ optionally bind with each other to form a ring, and, in that case, among the three, two groups satisfy 2n=a+b+c+d+e and one group satisfies 2n−1=a+b+c+d+e.

10. The nonaqueous electrolyte secondary battery according to claim 1, wherein
the salt is (CF₃SO₂)2NLi, (FSO₂)2NLi, (C₂F₅SO₂)2NLi, FSO₂(CF₃SO₂)NLi, (SO₂CF₂CF₂SO₂)NLi, (SO₂CF₂CF₂CF₂SO₂)NLi, FSO₂(CH₃SO₂)NLi, FSO₂(C₂F₅SO₂)NLi, or FSO₂(C₂H₅SO₂)NLi.

11. The nonaqueous electrolyte secondary battery according to claim 1, wherein
the organic solvent is selected from acetonitrile or dimethyl carbonate.

12. The nonaqueous electrolyte secondary battery according to claim 1, wherein
a relationship between the Io and the Is is Is>2×Io.

13. The nonaqueous electrolyte secondary battery according to claim 1, wherein
the cation of the salt is lithium, and
a chemical structure of an anion of the salt is represented by formula (7) below:
(R¹³SO₂)(R¹⁴SO₂)N Formula (7),
wherein, in the formula (7), R¹³ and R¹⁴ are each independently CₙHₐF_{b}Cl_{c}Br_{d}Iₑ,
“n,” “a,” “b,” “c,” “d,” and “e” are each independently an integer not smaller than 0, and satisfy 2n+1=a+b+c+d+e,
R¹³ and R¹⁴ optionally bind with each other to form a ring, and, in that case, satisfy 2n=a+b+c+d+e, and
“n” is an integer from 0 to 6, with the proviso that when R¹³ and R¹⁴ bind with each other to form a ring, “n” is an integer from 1 to 8.

14. The nonaqueous electrolyte secondary battery according to claim 1, wherein
the salt is selected from (CF₃SO₂)2NLi, (FSO₂)2NLi, (C₂F₅SO₂)2NLi, FSO₂(CF₃SO₂)NLi, (SO₂CF₂CF₂SO₂)NLi, (SO₂CF₂CF₂CF₂SO₂)NLi, FSO₂(CH₃SO₂)NLi, FSO₂(C₂F₅SO₂)NLi, or FSO₂(C₂H₅SO₂)NLi, and
the organic solvent is selected from acetonitrile, propionitrile, acrylonitrile, tetrahydrofuran, 1,3-dioxane, 1,4-dioxane, 2-methyltetrahydrofuran, ethylene carbonate, propylene carbonate, formamide, N,N-dimethylformamide, N,N-dimethylacetamide, N-methylpyrrolidone, isopropyl isocyanate, n-propylisocyanate, methyl acetate, ethyl acetate, propyl acetate, methyl propionate, methyl formate, ethyl formate, vinyl acetate, methyl acrylate, methyl methacrylate, oxazole, acetone, methyl ethyl ketone, methyl isobutyl ketone, acetic anhydride, propionic anhydride, sulfolane, dimethyl sulfoxide, 1-nitropropane, 2-nitropropane, furan, furfural, γ-butyrolactone, γ-valerolactone, δ-valerolactone, thiophene, pyridine, 1-methylpyrrolidine, N-methylmorpholine, trimethyl phosphate, triethyl phosphate, or a linear carbonate represented by formula (10) below:
R¹⁹OCOOR²⁰ Formula (10),
wherein, in the formula (10), R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl,
“n” is an integer from 1 to 6,
“m” is an integer from 3 to 8, and
“a,” “b,” “c,” “d,” “e,” “f,” “g,” “h,” “i,” and “j” are each independently an integer not smaller than 0, and satisfy 2n+1=a+b+c+d+e and 2m=f+g+h+i+j.

15. The nonaqueous electrolyte secondary battery according to claim 1, wherein
the organic solvent is selected from a linear carbonate represented by formula (10) below:
R¹⁹OCOOR²⁰ Formula (10),
wherein, in the formula (10), R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl, and
“n,” “a,” “b,” “c,” “d,” “e,” “m,” “f,” “g,” “h,” “i,” and “j” are each independently an integer not smaller than 0, and satisfy 2n+1=a+b+c+d+e and 2m−1=f+g+h+i+j.

16. The nonaqueous electrolyte secondary battery according to claim 1, wherein
the organic solvent is selected from dimethyl carbonate, ethyl methyl carbonate, or diethyl carbonate.

17. The nonaqueous electrolyte secondary battery according to claim 1, wherein
the organic solvent is selected from acetonitrile, propionitrile, acrylonitrile, malononitrile, tetrahydrofuran, 1,2-dioxane, 1,3-dioxane, 1,4-dioxane, 2,2-dimethyl-1,3-dioxolane, 2-methyltetrahydropyran, 2-methyltetrahydrofuran, crown ethers, ethylene carbonate, propylene carbonate, dimethyl carbonate, diethyl carbonate, ethyl methyl carbonate, formamide, N,N-dimethylformamide, N,N-dimethylacetamide, N-methylpyrrolidone, isopropyl isocyanate, n-propylisocyanate, chloromethyl isocyanate, methyl acetate, ethyl acetate, propyl acetate, methyl propionate, methyl formate, ethyl formate, vinyl acetate, methyl acrylate, methyl methacrylate, glycidyl methyl ether, epoxy butane, 2-ethyloxirane, oxazole, 2-ethyloxazole, oxazoline, 2-methyl-2-oxazoline, acetone, methyl ethyl ketone, methyl isobutyl ketone, acetic anhydride, propionic anhydride, dimethyl sulfone, sulfolane, dimethyl sulfoxide, 1-nitropropane, 2-nitropropane, furan, furfural, γ-butyrolactone, γ-valerolactone, δ-valerolactone, thiophene, pyridine, tetrahydro-4-pyrone, 1-methylpyrrolidine, N-methylmorpholine, trimethyl phosphate, and triethyl phosphate, or a linear carbonate represented by formula (10) below:
R¹⁹OCOOR²⁰ Formula (10),
wherein, in the formula (10), R¹⁹ and R²⁰ are each independently selected from CₙHₐF_{b}Cl_{c}Br_{d}Iₑ that is a linear alkyl, or CₘH_{f}F_{g}ClₕBrᵢIⱼ whose chemical structure includes a cyclic alkyl,
“n” is an integer from 1 to 6,
“m” is an integer from 3 to 8, and
“a,” “b,” “c,” “d,” “e,” “f,” “g,” “h,” “i,” and “j” are each independently an integer not smaller than 0, and satisfy 2n+1=a+b+c+d+e and 2m−1=f+g+h+H.

18. The nonaqueous electrolyte secondary battery according to claim 1, wherein
a chemical structure of an anion of the salt is represented by formula (7) below:
(R¹³SO₂)(R¹⁴SO₂)N Formula (7),
wherein, in the formula (7), R¹³ is F and R¹⁴ is CₙHₐF_{b}Cl_{c}Br_{d}Iₑ, and
“n,” “a,” “b,” “c,” “d,” and “e” are each independently an integer not smaller than 0, and satisfy 2n+1=a+b+c+d+e.

19. The nonaqueous electrolyte secondary battery according to claim 1, wherein
the chemical structure of the anion of the salt is selected from (FSO₂)₂N, FSO₂(CF₃SO₂)N, FSO₂(CH₃SO₂)N, FSO₂(C₂F₅SO₂)N, or FSO₂(C₂H₅SO₂)N.

20. The nonaqueous electrolyte secondary battery according to claim 18, wherein
the salt is selected from (FSO₂)₂NLi, FSO₂(CF₃SO₂)NLi, FSO₂(CH₃SO₂)NLi, FSO₂(C₂F₅SO₂)NLi, or FSO₂(C₂H₅SO₂)NLi.

21. The nonaqueous electrolyte secondary battery according to claim 1, wherein
the binding agent is polyacrylic acid.
